(19) United States
(12) Patent Application Publication
(10) Pub. No.: US 2026/0184923 A1
(43) Pub. Date: Jul. 2, 2026

(54) PROTEIN POLYURETHANE ALLOYS AND LAYERED MATERIALS INCLUDING THE SAME

(71) Applicant: Modern Meadow, Inc., Nutley, NJ (US)

(72) Inventors: Samuel BROADBENT, Hazlet, NJ (US); Dale L. HANDLIN, JR., Chapel Hill, NC (US); Shaobo CAI, Oradell, NJ (US); Zhe TAN, Secaucus, NJ (US); Casey CROWNHART, Hoboken, NJ (US); Nicholas YARAGHI, Hoboken, NJ (US); David WILLIAMSON, Towaco, NJ (US); Alexander Iain NORMAN, Somerville, NJ (US); Lixin DAI, Livingston, NJ (US)

(21) Appl. No.: 19/565,741

(22) Filed: Mar. 13, 2026

Related U.S. Application Data
(62) Division of application No. 17/819,544, filed on Aug. 12, 2022, now Pat. No. 12,600,862.
Application No. 17/819,544 is a continuation of application No. 17/246,044, filed on Apr. 30, 2021.
(60) Provisional application No. 63/018,891, filed on May 1, 2020.
(60) Provisional application No. 63/110,760, filed on Nov. 6, 2020.

(51) Int. Cl. C08L 89/06; C08L 75/04

(52) U.S. Cl. CPC C08L 89/06; C08L 75/04; C08L 2201/10

(57) ABSTRACT

Protein polyurethane alloys including one or more proteins dissolved within one or more polyurethanes. The protein polyurethane alloy may have one or more mechanical properties that are superior to the polyurethane in the absence of protein. The protein polyurethane alloys may be incorporated into a layered material including one or more protein polyurethane alloy layers.

### REFERENCE TO SEQUENCE LISTING SUBMITTED ELECTRONICALLY

The content of the electronically submitted sequence listing in ASCII text file (Name: 4431_0680004_Seqlisting_ST26.xml; Size: 2,930 bytes; and Date of Creation: Aug. 10, 2022) filed with the application is herein incorporated by reference in its entirety.

### FIELD

This disclosure relates to protein polyurethane alloys comprising one or more proteins dissolved in a polyurethane. In particular embodiments, this disclosure relates to protein polyurethane alloys including one or more proteins dissolved only in the hard phase of a polyurethane. In some embodiments, the protein polymer alloys can have the look, feel, and aesthetic and/or mechanical properties similar to natural leather, and can be used to make goods and articles previously prepared from natural leather.

### BACKGROUND

Leather is a versatile product used across many industries, including the furniture industry, where leather is regularly used as upholstery, the clothing industry, where leather is used to manufacture pants and jackets, the shoe industry, where leather is used to prepare casual and dress shoes, the luggage industry, the handbag and accessory industry, and in the automotive industry. The global trade value for leather is high, and there is a continuing and increasing demand for leather products. However, there are variety of costs, constraints, and social concerns associated with producing natural leather. Foremost, natural leathers are produced from animal skins, and as such, requires raising and slaughtering livestock. Raising livestock requires enormous amounts of feed, pastureland, water, and fossil fuels and contributes to air and waterway pollution, through, for example, greenhouse gases like methane. Leather production also raises social concerns related to the treatment of animals. In recent years, there has also been a fairly well documented decrease in the availability of traditional high quality hides. For at least these reasons, alternative means to meet the demand for leather are desirable.

### BRIEF SUMMARY

The present disclosure provides protein polyurethane alloys suitable for use in a variety of applications, including as a replacement for natural leather.

A first embodiment (1) of the present disclosure is directed to a protein polyurethane alloy comprising a protein dissolved within a polyurethane, where the protein is a protein other than a soy protein.

In a second embodiment (2), the protein polyurethane alloy of the first embodiment (1) has a Dynamic Mechanical Analysis (DMA) tan (δ) peak at a temperature ranging from about −60° C. to about 30° C., and a second DMA modulus transition onset temperature ranging from about 120° C. to about 200° C.

In a third embodiment (3), the protein polyurethane alloy of the first embodiment (1) or the second embodiment (2) is transparent.

In a fourth embodiment (4), the polyurethane of the protein polyurethane alloy of any one of embodiments (1)-(3) has a Young's modulus in the absence of protein, and the protein polyurethane alloy has a Young's modulus ranging from about 10% to about 600% greater than the Young's modulus of the polyurethane in the absence of protein.

In a fifth embodiment (5), the polyurethane of the protein polyurethane alloy of any one of embodiments (1)-(3) has a Young's modulus in the absence of protein, and the protein polyurethane alloy has a Young's modulus ranging from about 40% to about 600% greater than the Young's modulus of the polyurethane in the absence of protein.

In a sixth embodiment (6), the polyurethane of the protein polyurethane alloy of any one of embodiments (1)-(5) has a Young's modulus in the absence of protein, and the protein polyurethane alloy has a Young's modulus ranging from about 10 MPa to about 350 MPa greater than the Young's modulus of the polyurethane in the absence of protein.

In a seventh embodiment (7), the polyurethane of the protein polyurethane alloy of any one of embodiments (1)-(5) has a Young's modulus in the absence of protein, and the protein polyurethane alloy has a Young's modulus ranging from about 25 MPa to about 350 MPa greater than the Young's modulus of the polyurethane in the absence of protein.

In an eighth embodiment (8), the polyurethane of the protein polyurethane alloy of any one of embodiments (1)-(5) has a Young's modulus in the absence of protein, and the protein polyurethane alloy has a Young's modulus ranging from about 100 MPa to about 350 MPa greater than the Young's modulus of the polyurethane in the absence of protein.

In a ninth embodiment (9), the protein polyurethane alloy of any one of embodiments (1)-(8) has a Young's modulus ranging from about 50 MPa to about 450 MPa.

In a tenth embodiment (10), the protein polyurethane alloy of any one of embodiments (1)-(8) has a Young's modulus ranging from about 75 MPa to about 450 MPa.

In an eleventh embodiment (11), the polyurethane of the protein polyurethane alloy of any one of embodiments (1)-(10) has a second DMA modulus transition onset temperature in the absence of protein, and the protein polyurethane alloy has a second DMA modulus transition onset temperature in degrees Celsius ranging from about 5% to about 70% greater than the second DMA modulus transition onset temperature of the polyurethane in the absence of protein.

In a twelfth embodiment (12), the polyurethane of the protein polyurethane alloy of any one of embodiments (1)-(10) has a second DMA modulus transition onset temperature in the absence of protein, and the protein polyurethane alloy has a second DMA modulus transition onset temperature in degrees Celsius ranging from about 15% to about 70% greater than the second DMA modulus transition onset temperature of the polyurethane in the absence of protein.

In a thirteenth embodiment (13), the polyurethane of the protein polyurethane alloy of any one of embodiments (1)-(12) has a second DMA modulus transition onset temperature in the absence of protein, and the protein polyurethane alloy has a second DMA modulus transition onset temperature ranging from about 5° C. to about 100° C. greater than the second DMA modulus transition onset temperature of the polyurethane in the absence of protein.

In a fourteenth embodiment (14), the polyurethane of the protein polyurethane alloy of any one of embodiments (1)-(12) has a second DMA modulus transition onset temperature in the absence of protein, and the protein polyurethane alloy has a second DMA modulus transition onset temperature ranging from about 20° C. to about 80° C. greater than the second DMA modulus transition onset temperature of the polyurethane in the absence of protein.

In a fifteenth embodiment (15), the polyurethane of the protein polyurethane alloy of any one of embodiments (1)-(12) has a second DMA modulus transition onset temperature in the absence of protein, and the protein polyurethane alloy has a second DMA modulus transition onset temperature ranging from about 40° C. to about 80° C. greater than the second DMA modulus transition onset temperature of the polyurethane in the absence of protein.

In a sixteenth embodiment (16), the protein polyurethane alloy of any one of embodiments (1)-(15) has a second DMA modulus transition onset temperature ranging from about 130° C. to about 200° C.

In a seventeenth embodiment (17), the protein polyurethane alloy of any one of embodiments (1)-(15) has a second DMA modulus transition onset temperature ranging from about 165° C. to about 200° C.

In an eighteenth embodiment (18), the protein of the protein polyurethane alloy of any one of embodiments (1)-(17) has an isoelectric point ranging from about 4 to about 5 and a lysine weight percent ranging from about 1 wt % to about 100 wt %.

In a nineteenth embodiment (19), the polyurethane of the protein polyurethane alloy of any one of embodiments (1)-(18) has a tensile strength in the absence of protein, and the protein polyurethane alloy has a tensile strength ranging from about 5% to about 55% greater than the tensile strength of the polyurethane in the absence of protein.

In a twentieth embodiment (20), the polyurethane of the protein polyurethane alloy of any one of embodiments (1)-(18) has a tensile strength in the absence of protein, and the protein polyurethane alloy has a tensile strength ranging from about 15% to about 55% greater than the tensile strength of the polyurethane in the absence of protein.

In a twenty-first embodiment (21), the polyurethane of the protein polyurethane alloy of any one of embodiments (1)-(20) has a tensile strength in the absence of protein, and the protein polyurethane alloy has a tensile strength ranging from about 2 MPa to about 8 MPa greater than the tensile strength of the polyurethane in the absence of protein.

In a twenty-second embodiment (22), the polyurethane of the protein polyurethane alloy of any one of embodiments (1)-(20) has a tensile strength in the absence of protein, and the protein polyurethane alloy has a tensile strength ranging from about 5 MPa to about 8 MPa greater than the tensile strength of the polyurethane in the absence of protein.

In a twenty-third embodiment (23), the protein polyurethane alloy of any one of embodiments (1)-(22) has a tensile strength ranging from about 7 MPa to about 21 MPa.

In a twenty-fourth embodiment (24), the protein polyurethane alloy of any one of embodiments (1)-(23) comprises about 10 wt % to about 50 wt % of the protein and about 50 wt % to about 90 wt % of the polyurethane.

In a twenty-fifth embodiment (25), the protein polyurethane alloy of any one of embodiments (1)-(23) comprises about 20 wt % to about 35 wt % of the protein and about 65 wt % to about 80 wt % of the polyurethane.

In a twenty-sixth embodiment (26), the protein of the protein polyurethane alloy of any one of embodiments (1)-(25) is a protein other than collagen.

In a twenty-seventh embodiment (27), the polyurethane of the protein polyurethane alloy of any one of embodiments (1)-(26) has a moisture vapor transmission rate in the absence of protein, and the protein polyurethane alloy has a moisture vapor transmission rate ranging from about 20% to about 600% greater than the moisture vapor transmission rate of the polyurethane in the absence of protein.

In a twenty-eighth embodiment (28), the polyurethane of the protein polyurethane alloy of any one of embodiments (1)-(27) has a moisture vapor transmission rate in the absence of protein, and the protein polyurethane alloy has a moisture vapor transmission rate ranging from about 30 g/m²/24 hr to about 500 g/m²/24 hr greater than the moisture vapor transmission rate of the polyurethane in the absence of protein.

In a twenty-ninth embodiment (29), the protein polyurethane alloy of any one of embodiments (1)-(28) has a moisture vapor transmission rate ranging from about 30 g/m²/24 hr to about 1000 g/m²/24 hr.

A thirtieth embodiment (30) is directed to a soy protein polyurethane alloy comprising a soy protein dissolved within a polyurethane, where the soy protein polyurethane alloy has a Dynamic Mechanical Analysis (DMA) tan (δ) peak at a temperature ranging from about −60° C. to about 30° C. and a second DMA modulus transition onset temperature ranging from about 130° C. to about 200° C.

In a thirty-first embodiment (31), the soy protein polyurethane alloy of the thirtieth embodiment (30) is transparent.

In a thirty-second embodiment (32), the polyurethane of the soy protein polyurethane alloy of the thirtieth embodiment (30) or the thirty-first embodiment (31) has a Young's modulus in the absence of soy protein, and the soy protein polyurethane alloy has a Young's modulus ranging from about 60% to about 570% greater than the Young's modulus of the polyurethane in the absence of soy protein.

In a thirty-third embodiment (33), the polyurethane of the soy protein polyurethane alloy of any one of embodiments (30)-(32) has a Young's modulus in the absence of soy protein, and the soy protein polyurethane alloy has a Young's modulus ranging from about 35 MPa to about 340 MPa greater than the Young's modulus of the polyurethane in the absence of soy protein.

In a thirty-fourth embodiment (34), the soy protein polyurethane alloy of any one of embodiments (30)-(33) has a Young's modulus ranging from about 90 MPa to about 400 MPa.

In a thirty-fifth embodiment (35), the polyurethane of the soy protein polyurethane alloy of any one of embodiments (30)-(34) has a second DMA modulus transition onset temperature in the absence of soy protein, and the second DMA modulus transition onset temperature of the soy protein polyurethane alloy ranges from about 15° C. to about 100° C. greater than the second DMA modulus transition onset temperature of the polyurethane in the absence of soy protein.

In a thirty-sixth embodiment (36), the polyurethane of the soy protein polyurethane alloy of any one of embodiments (30)-(35) has a tensile strength in the absence of soy protein, and the soy protein polyurethane alloy has a tensile strength ranging from about 10% to about 45% greater than the tensile strength of the polyurethane in the absence of soy protein.

In a thirty-seventh embodiment (37), the polyurethane of the soy protein polyurethane alloy of any one of embodiments (30)-(36) has a tensile strength in the absence of soy protein, and the soy protein polyurethane alloy has a tensile strength ranging from about 1.5 MPa to about 5.5 MPa greater than the tensile strength of the polyurethane in the absence of soy protein.

In thirty-eight embodiment (38), the soy protein polyurethane alloy of any one of embodiments (30)-(37) has a tensile strength ranging from about 14 MPa to about 19 MPa.

In a thirty-ninth embodiment (39), the soy protein polyurethane alloy of any one of embodiments (30)-(38) comprises about 10 wt % to about 50 wt % of the soy protein and about 50 wt % to about 90 wt % of the polyurethane.

In a fortieth embodiment (40), the soy protein polyurethane alloy of any one of embodiments (30)-(38) comprises about 20 wt % to about 35 wt % of the soy protein and about 65 wt % to about 80 wt % of the polyurethane.

In a forty-first embodiment (41), the polyurethane of the soy protein polyurethane alloy of any one of embodiments (30)-(40) has a moisture vapor transmission rate in the absence of protein, and the soy protein polyurethane alloy has a moisture vapor transmission rate ranging from about 20% to about 600% greater than the moisture vapor transmission rate of the polyurethane in the absence of protein.

In a forty-second embodiment (42), the polyurethane of the soy protein polyurethane alloy of any one of embodiments (30)-(41) has a moisture vapor transmission rate in the absence of protein, and the soy protein polyurethane alloy has a moisture vapor transmission rate ranging from about 30 g/m²/24 hr to about 500 g/m²/24 hr greater than the moisture vapor transmission rate of the polyurethane in the absence of protein.

In a forty-third embodiment (43), the soy protein polyurethane alloy of any one of embodiments (30)-(42) has a moisture vapor transmission rate ranging from about 30 g/m²/24 hr to about 1000 g/m²/24 hr.

In a forty-fourth embodiment (44), the protein of the soy protein polyurethane alloy of any one of embodiments (30)-(43) is soy protein isolate.

In a fourty-fifth embodiment (45), the protein of the soy protein polyurethane alloy of any one of embodiments (40)-(43) is a chemically modified soy protein isolate.

### BRIEF DESCRIPTION OF THE FIGURES

The accompanying FIGURES, which are incorporated herein, form part of the specification and illustrate embodiments of the present disclosure. Together with the description, the FIGURES further serve to explain the principles of and to enable a person skilled in the relevant art(s) to make and use the disclosed embodiments. These FIGURES are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 is a dynamic mechanical analysis (DMA) graph of storage modulus versus temperature for various materials.

FIG. 2 is a graph showing the relationship between maximum tensile stress and gelatin weight percent for gelatin polyurethane alloys according to some embodiments.

FIG. 3 is a graph showing the relationship between Young's modulus and gelatin weight percent for gelatin polyurethane alloys according to some embodiments.

FIG. 4 is a DMA graph of storage modulus versus temperature for various materials.

FIG. 5 is a graph showing the relationship between maximum tensile stress and soy protein isolate (SPI) weight percent for SPI polyurethane alloys according to some embodiments.

FIG. 6 is a graph showing the relationship between Young's modulus and SPI weight percent for SPI polyurethane alloys according to some embodiments.

FIG. 7 is a DMA graph of storage modulus versus temperature for various materials.

FIG. 8A is a graph comparing the maximum tensile stress of various protein polyurethane alloys according to some embodiments.

FIG. 8B is a graph comparing the Young's modulus of various protein polyurethane alloys according to some embodiments.

FIG. 9 is a DMA thermogram comparing L3360 and a gelatin L3360 alloy according to some embodiments.

FIG. 10 is a DMA thermogram comparing Hauthane HD-2001 polyurethane and a gelatin Hauthane HD-2001 polyurethane alloy according to some embodiments.

FIG. 11 is a DMA thermogram comparing SANCURE™ 20025F polyurethane and a gelatin SANCURE™ 20025F polyurethane alloy according to some embodiments.

FIG. 12 is a DMA thermogram comparing IMPRANIL® DLS polyurethane and a gelatin IMPRANIL® DLS polyurethane alloy according to some embodiments.

FIG. 13 is a DMA thermogram comparing BONDTHANE™ UD-108 polyurethane and a gelatin BONDTHANE™ UD-108 polyurethane alloy according to some embodiments.

FIG. 14 is a DMA thermogram comparing BONDTHANE™ UD-303 polyurethane and a gelatin BONDTHANE™ UD-303 polyurethane alloy according to some embodiments.

FIG. 15 is a DMA thermogram comparing BONDTHANE™ UD-250 polyurethane and a gelatin BONDTHANE™ UD-250 polyurethane alloy according to some embodiments.

FIG. 16 is a representative DMA graph illustrating the methodology of measuring first and second DMA modulus transition onset temperatures.

FIG. 17 illustrates a layered material according to some embodiments.

FIG. 18 illustrates a layered material according to some embodiments.

FIG. 19 is a block diagram illustrating a method for making a layered material according to some embodiments.

FIGS. 20A-20F illustrate a method of making a layered material according to some embodiments.

FIG. 21 illustrates a spacer fabric according to some embodiments.

FIG. 22 is a DMA thermogram comparing IMPRAPERM® DL 5249 polyurethane and a soy protein isolate IMPRAPERM® DL 5249 alloy according to some embodiments.

FIG. 23 is a graph measuring the weight of water transported through the construction as weight change versus time for a multi-layer protein polyurethane alloy according to some embodiments.

### DETAILED DESCRIPTION

The indefinite articles “a,” “an,” and “the” include plural referents unless clearly contradicted or the context clearly dictates otherwise.

The term “comprising” is an open-ended transitional phrase. A list of elements following the transitional phrase “comprising” is a non-exclusive list, such that elements in addition to those specifically recited in the list can also be present. The phrase “consisting essentially of” limits the composition of a component to the specified materials and those that do not materially affect the basic and novel characteristic(s) of the component. The phrase “consisting of” limits the composition of a component to the specified materials and excludes any material not specified.

Where a range of numerical values comprising upper and lower values is recited herein, unless otherwise stated in specific circumstances, the range is intended to include the endpoints thereof, and all integers and fractions within the range. It is not intended that the disclosure or claims be limited to the specific values recited when defining a range. Further, when an amount, concentration, or other value or parameter is given as a range, one or more ranges, or as list of upper values and lower values, this is to be understood as specifically disclosing all ranges formed from any pair of any upper range limit or value and any lower range limit or value, regardless of whether such pairs are separately disclosed. Finally, when the term “about” is used in describing a value or an end-point of a range, the disclosure should be understood to include the specific value or end-point referred to. Whether or not a numerical value or end-point of a range recites “about,” the numerical value or end-point of a range is intended to include two embodiments: one modified by “about,” and one not modified by “about.”

As used herein, the term “about” refers to a value that is within +10% of the value stated. For example, about 3 MPa can include any number between 2.7 MPa and 3.3 MPa.

As used herein, a first layer described as “attached to” a second layer means that the layers are attached to each other either by direct contact and attachment between the two layers or via one or more intermediate adhesive layers. An intermediate adhesive layer can be any layer that serves to attach a first layer to a second layer.

As used herein, the phrase “disposed on” means that a first component (e.g., layer) is in direct contact with a second component. A first component “disposed on” a second component can be deposited, formed, placed, or otherwise applied directly onto the second component. In other words, if a first component is disposed on a second component, there are no components between the first component and the second component.

As used herein, the phrase “disposed over” means other components (e.g., layers or substrates) may or may not be present between a first component and a second component.

As used herein, a “bio-based polyurethane” is a polyurethane where the building blocks of polyols, such as diols and diacids like succinic acid, are derived from a biological material such as corn starch.

As used herein, the term “substantially free of” means that a component is present in a detectable amount not exceeding about 0.1 wt %.

As used herein, the term “free of” means that a component is not present in a blend or material (e.g., a protein polyurethane alloy), even in trace amounts.

As used herein “collagen” refers to the family of at least 28 distinct naturally occurring collagen types including, but not limited to collagen types I, II, III, IV, V, VI, VII, VIII, IX, X, XI, XII, XIII, XIV, XV, XVI, XVII, XVIII, XIX, and XX. The term collagen as used herein also refers to collagen prepared using recombinant techniques. The term collagen includes collagen, collagen fragments, collagen-like proteins, triple helical collagen, alpha chains, monomers, gelatin, trimers and combinations thereof. Recombinant expression of collagen and collagen-like proteins is known in the art (see, e.g., Bell, EP 1232182B1, Bovine collagen and method for producing recombinant gelatin; Olsen, et al., U.S. Pat. No. 6,428,978 and VanHeerde, et al., U.S. Pat. No. 8,188,230, incorporated by reference herein in their entireties) Unless otherwise specified, collagen of any type, whether naturally occurring or prepared using recombinant techniques, can be used in any of the embodiments described herein. That said, in some embodiments, the collagen described herein can be prepared using bovine Type I collagen. Collagens are characterized by a repeating triplet of amino acids, -(Gly-X-Y)n-, so that approximately one-third of the amino acid residues in collagen are glycine. X is often proline and Y is often hydroxyproline. Thus, the structure of collagen may consist of three intertwined peptide chains of differing lengths. Different animals may produce different amino acid compositions of the collagen, which may result in different properties (and differences in the resulting leather).

In some embodiments, the collagen can be chemically modified to promote solubility in water.

Any type of collagen, truncated collagen, unmodified or post-translationally modified, or amino acid sequence-modified collagen can be used as part of the protein polyurethane alloy.

In some embodiments, the collagen can be plant-based collagen. For example, the collagen can be a plant-based collagen made by CollPlant.

In some embodiments, a collagen solution can be fibrillated into collagen fibrils. As used herein, collagen fibrils refer to nanofibers composed of tropocollagen or tropocollagen-like structures (which have a triple helical structure). In some embodiments, triple helical collagen can be fibrillated to form nanofibrils of collagen.

In some embodiments, a recombinant collagen can comprise a collagen fragment of the amino acid sequence of a native collagen molecule capable of forming tropocollagen (trimeric collagen). A recombinant collagen can also comprise a modified collagen or truncated collagen having an amino acid sequence at least 70, 80, 90, 95, 96, 97, 98, or 99% identical or similar to a native collagen amino acid sequence (or to a fibril forming region thereof or to a segment substantially comprising [Gly-X-Y]n). In some embodiments, the collagen fragment can be a 50 kDa portion of a native collagen. Native collagen sequences include the amino acid sequences of CollA1, CollA2, and Col3 Al, described by Accession Nos. NP_001029211.1, NP_776945.1 and NP_001070299.1, which are incorporated by reference. In some embodiments, the collagen fragment can be a portion of human collagen alpha-1(III) (Col3A1; Uniprot #P02461, Entrez Gene ID #1281). In some embodiments, the collagen fragment can comprise the amino acid sequence listed as SEQ ID NO: 1.

Methods of producing recombinant collagen and recombinant collagen fragments are known in the art. For example, U.S. Pub. Nos. 2019/0002893, 2019/0040400, 2019/0093116, and 2019/0092838 provide methods for producing collagen and collagen fragments that can be used to produce the recombinant collagen and recombinant collagen fragments disclosed herein. The contents of these four publications are incorporated by reference in their entirety.

Protein polyurethane alloys described herein can comprise a protein that is miscible with only one of a plurality of phases of a polyurethane, or a plurality of polyurethanes, with which it is blended. For example, in some embodiments, the protein polyurethane alloy can include a protein that is miscible with only the hard phase of the polyurethane, or the plurality of polyurethanes, having both a hard phase and a soft phase. Protein polyurethane alloys described herein can be free of or substantially free of protein in form of particles dispersed in a polyurethane. For example, in some embodiments, the protein polyurethane alloys can be free of or substantially free of protein particles having an average diameter of greater than 1 micron (μm).

In some embodiments, the protein polyurethane alloys can be free of or substantially free of soy protein particles having an average diameter of greater than 1 micron (μm). In some embodiments, the protein polyurethane alloys can be free of or substantially free of collagen particles having an average diameter of greater than 1 micron (μm). In some embodiments, the protein polyurethane alloys can be free of or substantially free of gelatin particles having an average diameter of greater than 1 micron (μm). In some embodiments, the protein polyurethane alloys can be free of or substantially free of bovine serum albumin particles having an average diameter of greater than 1 micron (μm). In some embodiments, the protein polyurethane alloys can be free of or substantially free of pea protein particles having an average diameter of greater than 1 micron (μm). In some embodiments, the protein polyurethane alloys can be free of or substantially free of egg white albumin particles having an average diameter of greater than 1 micron (μm). In some embodiments, the protein polyurethane alloys can be free of or substantially free of casein protein particles having an average diameter of greater than 1 micron (μm). In some embodiments, the protein polyurethane alloys can be free of or substantially free of peanut protein particles having an average diameter of greater than 1 micron (μm). In some embodiments, the protein polyurethane alloys can be free of or substantially free of edestin protein particles having an average diameter of greater than 1 micron (μm). In some embodiments, the protein polyurethane alloys can be free of or substantially free of whey protein particles having an average diameter of greater than 1 micron (μm) In some embodiments, the protein polyurethane alloys can be free of or substantially free of karanja protein particles having an average diameter of greater than 1 micron (μm). In some embodiments, the protein polyurethane alloys can be free of, or substantially free of, cellulase particles having an average diameter of greater than 1 micron (μm). In some embodiments, the protein polyurethane alloys can be free of, or substantially free of, recombinant collagen fragment particles having an average diameter of greater than 1 micron (μm).

In particular embodiments, the present disclosure provides a unique combination of a protein and a polyurethane in which the protein is dissolved in only the hard phase of the polyurethane. The present disclosure also provides methods of making the protein polyurethane alloys described herein. The present disclosure also provides layered materials including one or more of the protein polyurethane alloy layers and methods of making the layered materials. The protein polyurethane alloys and the protein polyurethane alloy layers can include one or more types of protein and one or more polyurethanes.

Proteins suitable for use in the alloys disclosed herein can be un-modified or chemically modified. In some embodiments, the protein can be modified to facilitate miscibility of the protein with the hard phase of the polyurethane. In some embodiments, the protein can be chemically modified to promote solubility in water. In such embodiments, the chemical modification to promote solubility in water can facilitate miscibility of the protein with the hard phase of the polyurethane. In some embodiments, the chemically modified protein can be a partially hydrolyzed protein. In some embodiments, the chemically modified protein can be a protein modified by covalent attachment of hydrophilic polymer chains, such as polyethylene glycol (PEG) chains, to the protein.

Suitable polyurethanes for use in the protein polyurethane alloys described herein include those that comprise at least two phases including a “soft phase” and a “hard phase.” The soft phase is formed from polyol segments within the polyurethane that separate from the urethane-containing phase due to differences in polarity. The urethane-containing phase is referred to as the hard phase. This phase separation is well known in the art and is the basis of the many of the properties of polyurethanes.

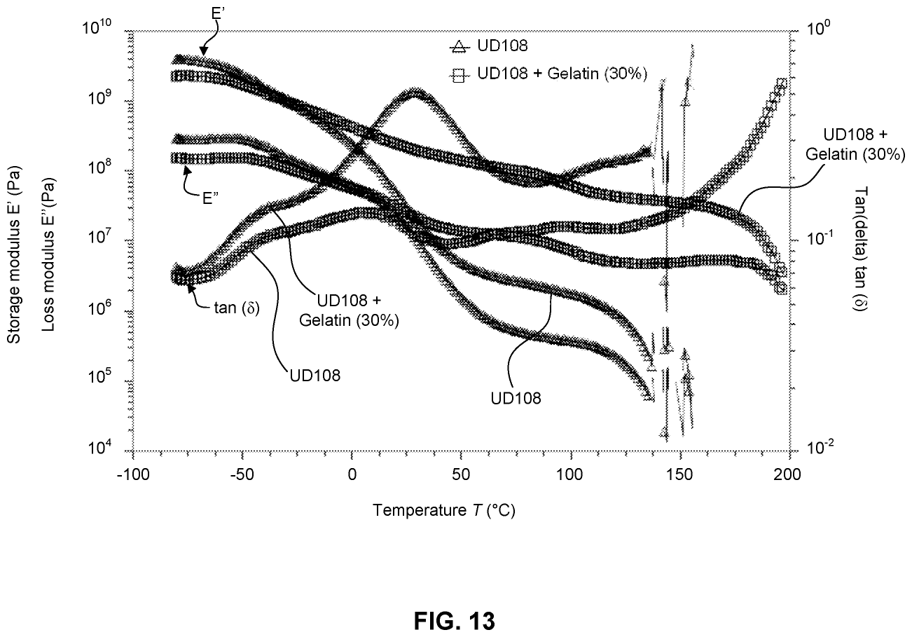

The soft phase is typically elastomeric at room temperature, and typically has a softening point or glass transition temperature (Tg) below room temperature. The Tg can be measured by Dynamic Mechanical Analysis (DMA) and quantified by either the peak of tan (δ) or the onset of the drop in storage modulus. Alternately, Tg can be measured by Differential Scanning calorimetry (DSC). In some cases, there can be crystallinity in the soft phase, which can be seen as a melting point, typically between 0° C. and about 60° C. For example, the peak in the tan (δ) curve at about 35° C. for UD-108 polyurethane in FIG. 13 indicates crystallinity in the soft phase of the polyurethane.

The hard phase typically has a Tg or melting point above room temperature, more typically above about 80° C. The softening of the hard phase can be measured by measuring the onset of the drop in storage modulus (sometimes referred to as stiffness) as measured by DMA.

The “soft phase” for the polyurethane or the protein polyurethane alloy including the polyurethane comprises the polyol component of the polyurethane. Its function is to be soft and flexible at temperatures above its Tg to lend toughness, elongation, and flexibility to the polyurethane. Typical soft segments can comprise polyether polyols, polyester polyols, polycarbonate polyols, and mixtures thereof. They typically range in molecular weight from about 250 daltons to greater than about 5 kiloDaltons. The “hard phase” for the polyurethane or the protein polyurethane alloy including the polyurethane comprises the urethane segments of the polymer that are imparted by the isocyanate(s) used to connect the polyols along with short chain diols such as butane diol, propane diol, and the like. Typical isocyanates useful for the present polyurethanes include, but are not limited to, hexamethylene diisocyanate, isophorone diisocyanate, methylene diisocyanate, phenyl diisocyanate, and the like. These molecules are more polar and stiffer than the polyols used to make the soft segment. Therefore, the hard segment is stiffer and has a higher softening point compared to the soft segment. The function of the hard phase is to provide, among other properties, strength, temperature resistance, and abrasion resistance to the polyurethane.

In some embodiments described herein, the protein can be miscible with only the hard phase, leaving soft phase transitions substantially unaltered. Without wishing to be bound particular theory, it is believed that when the protein is dissolved in the hard phase, it significantly increases the temperature at which the hard phase begins to soften, thus increasing the temperature resistance of the alloy described herein. Protein polyurethane alloys described herein can also have increased stiffness and increased strength relative to the base polyurethane (i.e., the polyurethane by itself, in the absence of protein).

Protein polyurethane alloys and layers described herein can be formed by blending one or more proteins with one or more water-borne polyurethane dispersions in a liquid state and drying the blend. In some embodiments, the protein polyurethane alloys and layers described herein can be formed by blending one or more proteins dissolved or dispersed in an aqueous solution with one or more water-borne polyurethane dispersions in a liquid state and drying the blend. In some embodiments, the polyurethane dispersion can be ionic, and either anionic or cationic. In some embodiments, the polyurethane dispersion can be nonionic. In some embodiments, the blended protein and polyurethane can be formed into a sheet and can, in certain embodiments, be attached to a substrate layer using a suitable attachment process, such as direct coating, a lamination process or a thermo-molding process. In certain embodiments, the lamination process can include attaching the sheet to the substrate layer using an adhesive layer. In some embodiments, the blended protein and polyurethane can be coated or otherwise deposited over a substrate layer to attach the blended protein and polyurethane to the substrate layer. In some embodiments, attaching the blended protein and polyurethane to the substrate layer can result in a portion of the blended protein and polyurethane being integrated into a portion of the substrate layer.

In a protein polyurethane alloy including one or more miscible proteins and polyurethanes, the one or more proteins can be dissolved within the hard phase of the one or more polyurethanes. The protein polyurethane alloy can include at least one protein miscible with the hard phase of one or more polyurethanes in the alloy. In some embodiments, the protein polyurethane alloy can include a plurality of proteins and/or a plurality of polyurethane hard phases that are miscible with each other. In all of these embodiments, and without wishing to be bound by a particular theory, the protein, or plurality of proteins, is believed to be dissolved in the hard phase of the polyurethane, or plurality of polyurethanes.

One or more proteins dissolved within the hard phase of one or more polyurethanes can form a homogenous mixture when blended. In some embodiments, the protein polyurethane alloy can include a plurality of proteins dissolved within or more polyurethanes such that the proteins and the polyurethane(s) form a homogenous mixture when blended and dried. Typically, the protein polyurethane alloy including a homogenous mixture of protein and polyurethane does not include a substantial amount of protein not dissolved in the polyurethane. That said, and in some embodiments, the protein polyurethane alloy can include a fraction of protein dispersed within the polyurethane.

In embodiments described herein, the miscibility of the protein with the hard phase of the polyurethane can increase the DMA modulus transition softening onset temperature of the hard phase in a protein polyurethane alloy without significantly changing one or more other thermo-mechanical properties of the alloy relative to the thermo-mechanical properties of the polyurethane by itself. For example, the miscibility of the protein with the hard phase of the polyurethane can increase the DMA modulus transition onset temperature of the hard phase in the protein polyurethane alloy without significantly changing the DMA transition temperature of the soft phase in the alloy relative to the DMA transition temperature of the soft phase of the polyurethane by itself.

The DMA transition temperature of the soft phase can be referred to as the glass transition temperature (Tg) of a polyurethane or the protein polyurethane alloy. The DMA transition temperature of the soft phase, or Tg, can be quantified as (i) the DMA storage modulus transition onset temperature of the soft phase (referred to herein as the “first DMA modulus transition onset temperature”) or (ii) the DMA tan (δ) peak temperature corresponding to the soft phase. The DMA transition temperature of the hard phase can be measured by the onset of the drop in the storage modulus of the polyurethane or the polyurethane protein alloy and can be quantified as the DMA modulus transition onset temperature of the hard phase (referred to herein as the “second DMA modulus transition onset temperature”). In some embodiments, the second DMA modulus transition onset temperature of the protein polyurethane alloy can be above about 80° C. or above about 130° C.

Although many types of proteins are contemplated for use in the protein polyurethane alloys described herein including, for example, collagen and soy proteins, it is understood that for all of the embodiments disclosed herein, the protein can be a protein other than collagen and/or a protein other than a soy protein. Thus, in some embodiments, the protein dissolved in the protein polyurethane alloy can be a protein other than collagen. In other embodiments, the protein dissolved in the protein polyurethane alloy can be a protein other than a soy protein. In some embodiments, the protein dissolved in the protein polyurethane alloy can be a protein other than collagen and a protein other than a soy protein. In some embodiments, the protein polyurethane alloy can be free of or substantially free of collagen. In some embodiments, the protein polyurethane alloy can be free of or substantially free of soy protein. In some embodiments, the protein polyurethane alloy can be free of or substantially free of soy protein and collagen.

As previously discussed, the soft phase and the hard phase of the polyurethane can be measured using Dynamic Mechanical Analysis (DMA). Accordingly, the one or more polyurethanes included in the protein polyurethane alloys described herein can have at least two DMA transition temperatures, one corresponding to the soft phase and one corresponding to the hard phase. The DMA transition temperature of the soft phase can be quantified as a “first DMA modulus transition onset temperature” or DMA tan (δ) peak temperature corresponding to the soft phase. The DMA transition temperature of the hard phase can be quantified by a “second DMA modulus transition onset temperature.” The first DMA modulus transition onset temperature or a DMA tan (δ) peak temperature is a lower DMA transition temperature and the second DMA modulus transition onset temperature is a higher DMA transition temperature.

Similarly, the protein polyurethane alloys described herein can have at least two phases. The at least two phases can include the soft phase and the hard phase. Different phases of the alloys can be measured and quantified in the same manner as described above for the polyurethanes.

The polyurethane or the protein polyurethane alloy having first and second DMA transition temperatures means that it has a first DMA transition temperature that occurs at a lower temperature than the second DMA transition temperature. However, the first and second transition temperatures need not be sequential transition temperatures. Other DMA transition temperatures could occur between the first and second transitions.

In some embodiments, the first DMA modulus transition onset temperature for a polyurethane can be below 30° C. In some embodiments, the first DMA modulus transition onset temperature for a polyurethane can range from about −65° C. to about 30° C., including subranges. For example, in some embodiments, the first DMA modulus transition onset temperature for a polyurethane can be about −65° C., about −60° C., about −55° C., about −50° C., about −45° C., about −40° C., about −35° C., about −30° C., about −25° C., about −20° C., about −15° C., about −10° C., about −5° C., about −1° C., 0° C., about 1° C., about 5° C., about 10° C., about 15° C., about 20° C., about 25° C., or about 30° C., or within a range having any two of these values as endpoints, inclusive of the endpoints. In some embodiments, the first DMA modulus transition onset temperature of a polyurethane can be about −65° C. to about 30° C., about −65° C. to about 25° C., about −65° C. to about 20° C., about −65° C. to about 15° C., about −65° C. to about 10° C., about −65° C. to about 5° C., about −65° C. to about 1° C., about −65° C. to 0° C., about −65° C. to about −1° C., about −65° C. to about −5° C., about −65° C. to about −10° C., about −65° C. to about −15° C., about −65° C. to about −20° C., about −65° C. to about −25° C., about −65° C. to about −30° C., about −65° C. to about −35° C., about −65° C. to about −35° C., about −65° C. to about −40° C., or about −65° C. to about −45° C.

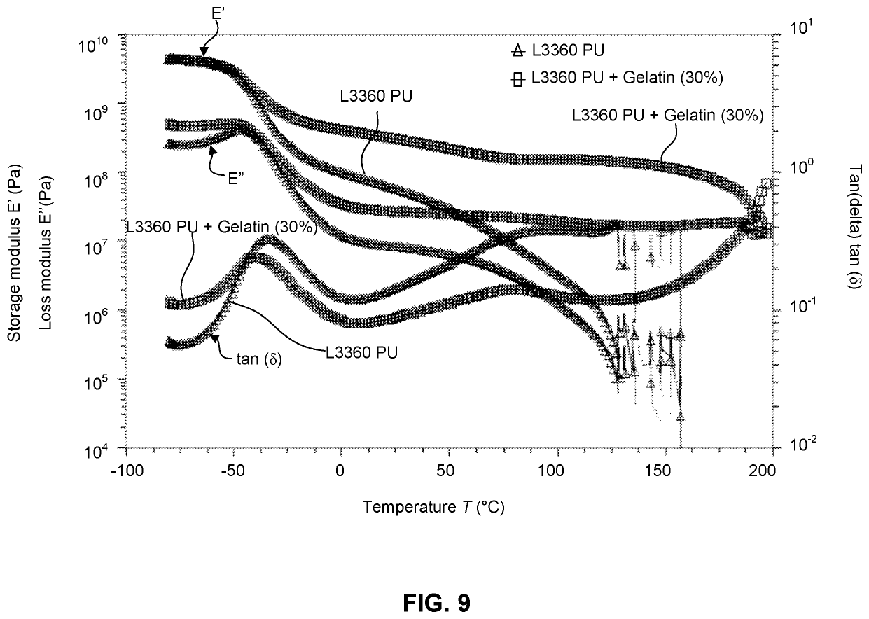

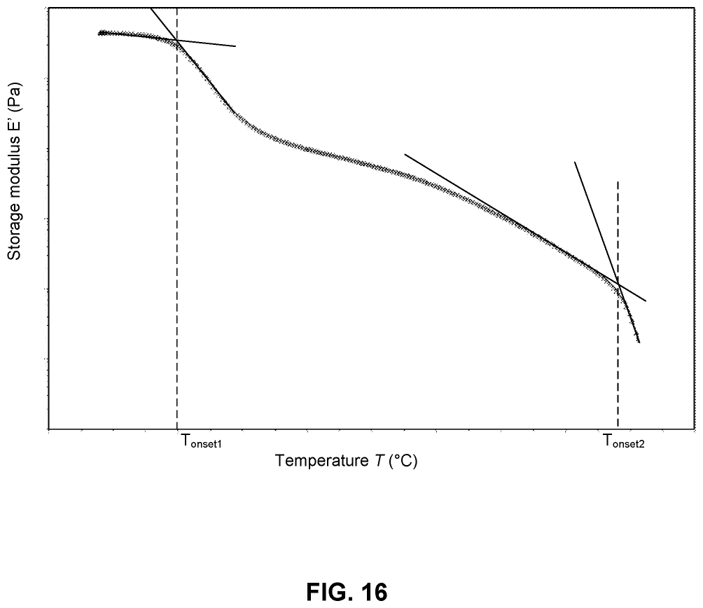

FIGS. 9-15 show DMA thermograms for various exemplary polyurethanes. The first DMA modulus transition onset temperature (Tₒₙₛₑₜ₁) for each exemplary polyurethane is the temperature at which the slope of the storage modulus (E′) curve begins to decrease significantly for a first time. The methodology of measuring this value is exemplified in FIG. 16. DMA equipment, such a DMA-850 from TA Instruments, can be programed to calculate this temperature automatically. Table 4 lists the first DMA modulus transition onset temperatures automatically calculated from the DMA graphs in FIGS. 9-15 (see Example Nos. 1-7).

In some embodiments, the DMA tan (δ) peak temperature corresponding to the soft phase of a polyurethane can be below 30° C. In some embodiments, the DMA tan (δ) peak temperature corresponding to the soft phase of a polyurethane can range from about −60° C. to about 30° C., including subranges. For example, in some embodiments, the DMA tan (δ) peak temperature corresponding to the soft phase of a polyurethane can be about −60° C., about −55° C., about −50° C., about −45° C., about −40° C., about −35° C., about −30° C., about −25° C., about −20° C., about −15° C., about −10° C., about −5° C., about −1° C., 0° C., about 1° C., about 5° C., about 10° C., about 15° C., about 20° C., about 25° C., or about 30° C., or within a range having any two of these values as endpoints, inclusive of the endpoints. In some embodiments, the DMA tan (δ) peak temperature corresponding to the soft phase of a polyurethane can be about −60° C. to about 30° C., about −60° C. to about 25° C., about −60° C. to about 20° C., about −60° C. to about 15° C., about −60° C. to about 10° C., about −60° C. to about 5° C., about −60° C. to about 1° C. about −60° C. to 0° C., about −60° C. to about −1° C., about −60° C. to about −5° C., about −60° C. to about −10° C., about −60° C. to about −15° C., about −60° C. to about −20° C., about −60° C. to about −25° C., about −60° C. to about −30° C., about −60° C. to about −35° C., or about −60° C. to about −40° C.

The DMA thermograms in FIGS. 9-15 show the DMA tan (δ) peak temperature corresponding to the soft phase for various exemplary polyurethanes. Like DMA modulus transition onset temperatures, DMA equipment, such a DMA-850 from TA Instruments, can be programed to calculate this temperature automatically. Table 4 lists the DMA tan (δ) peak temperature automatically calculated from the DMA graphs in FIGS. 9-15 (see Example Nos. 1-7).

In some embodiments, the second DMA modulus transition onset temperature for a polyurethane can be above 30° C. In some embodiments, the second DMA modulus transition onset temperature for a polyurethane can range from about 45° C. to about 165° C. For example, in some embodiments, the second DMA modulus transition onset temperature for a polyurethane can be about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., about 140° C., about 145° C., about 150° C., about 155° C., about 160° C., or about 165° C., or within any range having any two of these values as endpoints, inclusive of the endpoints. In some embodiments, the second DMA modulus transition onset temperature for a polyurethane can be about 45° C. to about 165° C., about 50° C. to about 160° C., about 55° C. to about 155° C., about 60° C. to about 150° C., about 65° C. to about 145° C., about 70° C. to about 140° C., about 75° C. to about 135° C., about 80° C. to about 130° C., about 85° C. to about 125° C., about 90° C. to about 120° C., about 95° C. to about 115° C., or about 100° C. to about 110° C.

The DMA thermograms in FIGS. 9-15 show the second DMA modulus transition onset temperatures for various exemplary polyurethanes. The second DMA modulus transition onset temperature (Tₒₙₛₑₜ₂) for each exemplary polyurethane is the temperature at which the slope of the storage modulus (E′) curve begins decrease significantly for a second time. The methodology of measuring this value is exemplified in FIG. 16. DMA equipment, such a DMA-850 from TA Instruments, can be programed to calculate this temperature automatically. Table 3 lists the second DMA modulus transition onset temperatures automatically calculated from the DMA graphs in FIGS. 9-15 (see Example Nos. 1-7).

In some embodiments, the polyurethane can exhibit crystallinity in the soft phase. This is common in polyether soft segments containing polytetramethylene glycol and some polyester polyols. In such embodiments, the polyurethane can exhibit at least three transitions: the Tg of the soft phase, the melting point of the soft phase, and the modulus transition of the hard phase. Such melting in the soft phase typically occurs between 0° C. and about 60° C., when present. In embodiments exhibiting crystallinity in the soft phase, the protein polyurethane alloy will typically still exhibit the melting in the soft phase because the protein is miscible with the hard phase, leaving the mechanical properties of the soft phase substantially unchanged.

In typical embodiments described herein, the protein polyurethane alloy can have a second DMA modulus transition onset temperature higher than the second DMA modulus transition temperature of the polyurethane in absence of protein (i.e., the polyurethane by itself). It is believed that this increase in the second DMA modulus transition onset temperature in the alloy is due to the miscibility of the protein and the hard phase of the polyurethane. This selective miscibility of the protein is indicated by an increase in the second DMA modulus transition onset temperature without a similar increase in DMA transition temperature of the soft phase (quantified by a first DMA modulus transition onset temperature or the DMA tan (δ) peak temperature corresponding to the soft phase). This selective miscibility can be utilized to control properties of the protein polyurethane alloy, for example mechanical and thermal properties.

In some embodiments, the protein polyurethane alloys and/or the layered materials described herein can have a look and feel, as well as mechanical properties, similar to natural leather. For example, the protein polyurethane alloy layer or the layered material including the protein polyurethane alloy layer can have, among other things, haptic properties, aesthetic properties, mechanical/performance properties, manufacturability properties, and/or thermal properties similar to natural leather. Mechanical/performance properties that can be similar to natural leather include, but are not limited to, tensile strength, tear strength, elongation at break, resistance to abrasion, internal cohesion, water resistance, breathability (quantified in some embodiments by a moisture vapor transmission rate measurement), and the ability to be dyed with reactive dyes and to retain color when rubbed (color fastness). Haptic properties that can be similar to natural leather include, but are not limited to, softness, rigidity, coefficient of friction, and compression modulus. Aesthetic properties that can be similar to natural leather include, but are not limited to, dyeability, embossability, aging, color, color depth, and color patterns. Manufacturing properties that can be similar to natural leather include, but are not limited to, the ability to be stitched, cut, skived, and split. Thermal properties that can be similar to natural leather include, but are not limited to, heat resistance and resistance to stiffening or softening over a significantly wide temperature range, for example 25° C. to 100° C.

Desirable properties for the protein polyurethane alloy described herein, include but are not limited to, optical properties, haptic properties, aesthetic properties, thermal properties, mechanical properties, and/or breathability properties. Exemplary thermal properties include heat resistance and resistance to melting, and can be quantified by, for example, measuring the second modulus transition onset temperature (Tₒₙₛₑₜ₂) of a material. Exemplary mechanical properties include abrasion resistance, maximum tensile stress (also referred to as “tensile strength”), and Young's modulus. Unless otherwise specified, maximum tensile stress values and Young's modulus values disclosed herein are measured according the methods provided by ASTM D638. Exemplary breathability properties include moisture vapor transmission rate (MVTR) measured in g/m²/24 hr (grams per meters squared per 24 hours). Unless otherwise specified, moisture vapor transmission rates disclosed herein are measured according to the methods provided by ASTM E96-Method B.

In some embodiments, the protein polyurethane alloy can be transparent. In some embodiments, a transparent protein polyurethane alloy can indicate that the protein is miscible with the hard phase of the polyurethane in the alloy. As used herein, a “transparent” material means material having an opacity of about 50% or less. Opacity is measured by placing a sample of material over a white background to measure the Y tristimulus value (“Over white Y”) in reflectance with a spectrometer using the D65 10 degree illuminant. The same sample is then placed over a black background and the measurement is repeated, yielding “Over black Y”. Percent opacity is calculated as “Over black Y” divided by “Over white Y” times 100. 100% opacity is defined as lowest transparency and 0% opacity is defined as the highest transparency.

In some embodiments, the protein polyurethane alloy can be transparent and can have an opacity ranging from 0% to about 50%, including subranges. For example, the transparent protein polyurethane alloy, can have an opacity ranging from 0% to about 40%, 0% to about 30%, 0% to about 20%, 0% to about 10%, or 0% to about 5%. The transparency of the protein polyurethane alloy is evaluated before dying or otherwise coloring the protein polyurethane alloy.

A transparent protein polyurethane alloy can be created by selecting and blending the appropriate combination of one or more proteins and one or more polyurethanes. While not all combinations of protein and polyurethane will result in a transparent protein polyurethane alloy, it is within the skill of the ordinarily skilled artisan to identify whether a given blend results in a transparent protein polyurethane alloy in view of this disclosure. In embodiments directed to a layered material including a transparent protein polyurethane alloy layer described herein, the transparent protein polyurethane alloy layer can provide unique characteristics for the layered material. For example, compared to a non-transparent layer, the transparent protein polyurethane alloy layer can provide unique depth of color when dyed. Likewise, the transparent protein polyurethane alloy layer can provide its mechanical properties to the layered material without significantly influencing the aesthetic properties of the material.

In some embodiments, the protein polyurethane alloy can include one or more coloring agents. In some embodiments, the coloring agent can be a dye, for example a fiber reactive dye, a direct dye, or a natural dye. Exemplary dyes, include but are not limited to, Azo structure acid dyes, metal complex structure acid dyes, anthraquinone structure acid dyes, and azo/diazo direct dyes. In some embodiments, the coloring agent can be pigment, for example a lake pigment.

Suitable polyurethanes for blending with one or more proteins according to embodiments described herein include, but are not limited to, aliphatic polyurethanes, aromatic polyurethanes, bio-based polyurethanes, or acrylic acid modified polyurethanes. Suitable polyurethanes are commercially available from manufacturers including Lubrizol, Hauthaway, Stahl, and the like. In some embodiments, a polyurethane for a protein polyurethane alloy can be bio-polyurethane. In some embodiments, the polyurethane is a water-dispersible polyurethane. In some embodiments, the polyurethane can be a polyester polyurethane. In some embodiments, the polyurethane can be a polyether polyurethane. In some embodiments, the polyurethane can be a polycarbonate-based polyurethane. In some embodiments, the polyurethane can be an aliphatic polyester polyurethane. In some embodiments, the polyurethane can be an aliphatic polyether polyurethane. In some embodiments, the polyurethane can be an aliphatic polycarbonate polyurethane. In some embodiments, the polyurethane can be an aromatic polyester polyurethane. In some embodiments, the polyurethane can be an aromatic polyether polyurethane. In some embodiments, the polyurethane can be an aromatic polycarbonate polyurethane.

In some embodiments, the polyurethane can have a soft segment selected from the group consisting of: polyether polyols, polyester polyols, polycarbonate polyols, and mixtures thereof. In some embodiments, the polyurethane can have a hard segment comprising diisocyanates and optionally short chain diols. Suitable diisocyanates can be selected from the group consisting of: aliphatic diisocyanates such as hexamethylene diisocyanate, isophorone diisocyanate; aromatic diisocyanates such as 4,4′ diphenyl methylene diisocyanate, toluene diisocyanate, phenyl diisocyanate, and mixtures thereof. Suitable short chain diols include ethylene glycol, propane diol, butane diol, 2,2 methyl 1,3 propane diol, pentane diol, hexane diol and mixtures thereof. In some embodiments crosslinkers such as multifunctional alcohols, for example, trimethylol propane triol, or diamines such as ethylene diamine or 4,4′ diamino, diphenyl diamine.

Exemplary commercial polyurethanes, include but are not limited to L3360 and Hauthane HD-2001 available from C. L. Hauthaway & Sons Corporation, SANCURE™ polyurethanes available from Lubrizol Corporation, BONDTHANE™ polyurethanes, for example UD-108, UD-250, and UD-303 available from Bond Polymers International, and EPOTAL® ECO 3702 and EPOTAL® P100 ECO from BASF. L3360 is a aliphatic polyester polyurethane polymer aqueous dispersion having a 35% solids content, a viscosity of 50 to 500 cps (centipoise), and a density of about 8.5 lb/gal (pounds per gallon). HD-2001 is an aliphatic polyester polyurethane polymer aqueous dispersion having a 40% solids content, a viscosity of 50 to 500 cps, and a density of about 8.9 lb/gal. BONDTHANE™ UD-108 is an aliphatic polyether polyurethane polymer aqueous dispersion having a 33% solids content, a viscosity of 300 cps, and a density of 8.7 lb/gal. BONDTHANE™ UD-250 is an aliphatic polyester polyurethane polymer aqueous dispersion having a 35% solids content, a viscosity of 200 cps, and a density of 8.8 lb/gal. BONDTHANE™ UD-303 is an aliphatic polyether polyurethane polymer aqueous dispersion having a 35% solids content, a viscosity of less than 500 cps, and a density of 8.7 lb/gal. EPTOAL® P100 ECO is a polyester polyurethane elastomer aqueous dispersion having approximately 40% solids and a viscosity of about 40 mPas.

Exemplary bio-based polyurethanes include, but are not limited to, L3360 available from C. L. Hauthaway & Sons Corporation, IMPRANIL® Eco DLS, IMPRANIL® Eco DL 519, IMPRANIL® Eco DLP-R, and IMPRAPERM® DL 5249 available from Covestro. IMPRANIL® Eco DLS is an anionic, aliphatic polyester polyurethane polymer aqueous dispersion having approximately 50% solids content, a viscosity of less than 1,200 MPa·s, and a density of about 1.1 g/cc. IMPRANIL® Eco DL 519 is an anionic, aliphatic polyester polyurethane polymer aqueous dispersion. IMPRANIL® Eco DLP-R is an anionic, aliphatic polyester polyurethane polymer aqueous dispersion. IMPRAPERM® DL 5249 is an anionic aliphatic polyester-polyurethane polymer aqueous dispersion.

In some embodiments, the polyurethane can include reactive groups that can be crosslinked with a protein. Exemplary reactive groups include, but are not limited to, a sulfonate, an aldehyde, a carboxylic acid or ester, a blocked isocyanate, or the like, and combinations thereof. In such embodiments, the polyurethane can be crosslinked to the protein in the protein polyurethane alloy through the reaction of a reactive group on the protein with the reactive group present in the polyurethane.

Suitable proteins for blending with one or more polyurethanes according to embodiments described herein include, but are not limited to, collagen, gelatin, bovine serum albumin (BSA), soy proteins, pea protein, egg white albumin, casein, peanut protein, edestin protein, whey protein, karanja protein, and cellulase. Suitable collagens include, but are not limited to, recombinant collagen (r-Collagen), a recombinant collagen fragment, and extracted collagens. Suitable soy proteins include, but are not limited to, soy protein isolate (SPI), soymeal protein, and soy protein derivatives. In some embodiments, the soy protein isolate can be partially hydrolyzed soy protein isolate. Suitable pea proteins include, but are not limited to, pea protein isolate, and pea protein derivatives. In some embodiments, the pea protein isolate can be partially hydrolyzed pea protein isolate.

Table 1 below lists some exemplary proteins and properties of the proteins. The gelatin is gelatin from porcine skin, Type A (Sigma Aldrich G2500). The collagen is extracted bovine collagen purchased from Wuxi BIOT Biology-technology Company. The bovine serum albumin Sigma Aldrich 5470 bovine serum albumin. The r-Collagen is recombinant collagen from Modern Meadow. The soy protein isolate is soy protein isolate purchased from MP Medicals (IC90545625). The pea protein is pea protein powder purchased from Bobs Red Mills (MTX5232). The egg white albumin protein is albumin from chicken egg white (Sigma Aldrich A5253). The casein protein is casein from bovine milk (Sigma Aldrich C7078). The peanut protein is peanut protein powder purchased from Tru-Nut. The whey protein is whey from bovine milk (Sigma Aldrich W1500). Other suitable soy protein isolates include, but are not limited to, soy protein isolate purchased from AMD (Clarisoy 100, 110, 150, 170, 180), or DuPont (SUPRO® XT 55, SUPRO® XT 221D, and SOBIND® Balance). Other suitable pea protein powders include, but are not limited to, pea protein powder purchased from Puris (870 and 870H).

Karanja protein is a protein found in Karanja seeds harvested from Pongamia pinnata trees (also known as Pongamia glabra trees). See Rahman, M M., and Netravali, “Green Resin from Forestry Waste Residue ‘Karanja (Pongamia pinnata) Seed Cake’ for Biobased Composite Structures,” ACS Sustainable Chem. Eng., 2:2318-2328 (2014); see also Mandal et al., “Nutritional Evaluation of Proteins from three Non-traditional Seeds with or without Amino Acids Supplementation in Albino Rats,” Proc. Indian natn. Sci. Acad., B50, No. 1, 48-56 (1984). The protein can be extracted from Karanja seeds using a solvent extraction process. Id. In some embodiments, the karanja protein can be karanja protein isolate. In such embodiments, karanja protein isolate can be obtained by alkaline extraction and acid precipitation of defatted karanja seed cake. See Rahman, M M., and Netravali, “Green Resin from Forestry Waste Residue ‘Karanja (Pongamia pinnata) Seed Cake’ for Biobased Composite Structures,” ACS Sustainable Chem. Eng., 2:2318-2328 (2014).

Suitable cellulase proteins are listed below in Table 1. The “Cellulase-RG” protein is Native Trichoderma sp. Cellulase available from CREATIVE ENZYMES®. The “Cellulase-IG” protein is laboratory grade cellulase available from Carolina Biological Supply Company.

The 50 KDa recombinant collagen fragment (50 KDa r-Collagen fragment) in Table 1 is a collagen fragment comprising the amino acid sequence listed as SEQ ID NO: 1.

The “dissolution method” listed in Table 1 is an exemplary aqueous solvent in which the protein can be dissolved in a solution that is miscible with the hard phase of the polyurethane as described herein. Proteins that can be at least partly dissolved in an aqueous solution are suitable for forming protein polyurethane alloys with polyurethane dispersions.

TABLE 1
Example Proteins

| | | | | | | Amino Acid | |
|---|---|---|---|---|---|---|---|
| | | | | | | Comp.: | Protein |
| Protein | Protein | Dissolution | Molecular | | Isoelectric | Lysine | Thermostability |
| Name | Source | Method | Weight | | Point | (g/100 g) | up to 200° C. |
| Gelatin | Porcine | Water | ~100 | KDa | ~4.8 | 2.6 | Yes |
| Collagen | Bovine | Water | ~120 | KDa | — | 2.2 | — |
| BSA | Bovine | Water | ~66 | KDa | ~4.7 | 11.98 | — |
| (Bovine | | | | | | | |
| Serum | | | | | | | |
| Albumin) | | | | | | | |
| r-Collagen | Yeast | Water | ~100 | KDa | — | 3.6 | — |
| Soy protein | Soy | Water + | ~30 to 60 | KDa | ~4.0 to 5.0 | 5.6 | Yes |
| isolate | | NaOH | | | | | |
| Pea Protein | Pea | Water + | ~60 to 80 | KDa | ~4.5 | 7.6 | Yes |
| | | NaOH | | | | | |
| Egg White | Chicken Egg | Water | ~40 | KDa | ~4.8 | 5.7 | Yes |
| Albumin | | | | | | | |
| Casein | Bovine Milk | Water + | ~24 | KDa | ~4.6 | 7.4 | — |
| | | NaOH | | | | | |
| Peanut | Peanut | Water + | ~60 | KDa | ~4.5 | 2.5 | Yes |
| Protein | | NaOH | | | | | |
| Whey | Bovine Milk | Water | ~18 | KDa | ~4.5 to 5.2 | 9.7 | No |
| Karanja | Karanja Seed | Water | — | | — | 14.6 | — |
| protein | | | | | | | |
| isolate | | | | | | | |
| 50 KDa r- | Yeast | Water | ~50 | KDa | ~9.3 | 3.9 | — |
| Collagen | | | | | | | |
| fragment | | | | | | | |
| Cellulase- | Trichoderma | Water | ~20 to 90 | KDa | ~4.6 to 6.9 | — | — |
| RG | reesei | | | | | | |

| | | | | | | |
|---|---|---|---|---|---|---|
| Cellulase-IG | Trichoderma | Water | — | — | — | — |
| | reesei | | | | | |

In some embodiments, the protein can have one or more of the following properties: (i) a molecular weight within a range described herein (ii) an isoelectric point within a range described below, (iii) an amino acid composition measured in grams of lysine per 100 grams of protein in a range described below, and (iv) protein thermo-stability up to 200° C.

### Protein Molecular Weight

In some embodiments, the protein can have a molecular weight ranging from about 1 KDa (kilodaltons) to about 700 KDa, including subranges. For example, the protein can have a molecular weight ranging from about 1 KDa to about 700 KDa, about 10 KDa to about 700 KDa, about 20 KDa to about 700 KDa, about 50 KDa to about 700 KDa, about 100 KDa to about 700 KDa, about 200 KDa to about 700 KDa, about 300 KDa to about 700 KDa, about 400 KDa to about 700 KDa, about 500 KDa to about 700 KDa, about 600 KDa to about 700 KDa, about 1 KDa to about 600 KDa, about 1 KDa to about 500 KDa, about 1 KDa to about 400 KDa, about 1 KDa to about 300 KDa, about 1 KDA to about 200 KDa, about 1 KDa to about 100 KDa, about 1 KDa to about 50 KDa, about 1 KDa to about 20 KDa, or about 1 KDa to about 10 KDa, or within a range having any two of these values as endpoints, inclusive of the endpoints.

### Protein Isoelectric Point

In some embodiments, the protein can have an isoelectric point ranging from about 4 to about 10, including subranges. For example, the protein can have an isoelectric point ranging from about 4 to about 10, about 4.5 to about 9.5, about 5 to about 9, about 5.5 to about 8.5, about 6 to about 8, about 6.5 to about 7.5, or about 6.5 to about 7, or within a range having any two of these values as endpoints, inclusive of the endpoints. In some embodiments, the protein can have an isoelectric point ranging from about 4 to about 5.

### Protein Amino Acid Composition

In some embodiments, the protein can have an amino acid composition measured in grams of lysine per 100 grams of protein (as referred to as a “lysine weight percent”) ranging from about 0.5 wt % to about 100 wt %, including subranges. For example, the protein can have a lysine weight percent ranging from about 0.5 wt % to about 100 wt %, about 1 wt % to about 100 wt %, about 5 wt % to about 100 wt %, about 10 wt % to about 100 wt %, about 20 wt % to about 100 wt %, about 30 wt % to about 100 wt %, about 40 wt % to about 100 wt %, about 50 wt % to about 100 wt %, about 60 wt % to about 100 wt %, about 70 wt % to about 100 wt %, about 80 wt % to about 100 wt %, or about 90 wt % to about 100 wt %, or within a range having any two of these values as endpoints, inclusive of the endpoints. In some embodiments, the protein can be a polylysine.

In some embodiments, the protein can have a lysine weight percent ranging from about 0.5 wt % to about 20 wt %, including subranges. For example, the protein can have a lysine weight percent ranging from about 0.5 wt % to about 20 wt %, about 1 wt % to about 19 wt %, about 2 wt % to about 18 wt %, about 3 wt % to about 17 wt %, about 4 wt % to about 16 wt %, about 5 wt % to about 15 wt %, about 6 wt % to about 14 wt %, about 7 wt % to about 13 wt %, about 8 wt % to about 12 wt %, about 9 wt % to about 11 wt %, or about 9 wt % to about 10 wt %, or within a range having any two of these values as endpoints, inclusive of the endpoints. In some embodiments, the protein can have a lysine weight percent ranging from about 1 wt % to about 20 wt %. In some embodiments, the protein can have a lysine weight percent ranging from about 5 wt % to about 20 wt %. In some embodiments, the protein can have a lysine weight percent ranging from about 1 wt % to about 12 wt %. In some embodiments, the protein can have a lysine weight percent ranging from about 5 wt % to about 12 wt %. In some embodiments, the protein can have a lysine weight percent ranging from about 1 wt % to about 15 wt %. In some embodiments, the protein can have a lysine weight percent ranging from about 5 wt % to about 15 wt %.

In some embodiments, the protein can be thermo-stable. In some embodiments, the protein can be non-thermo-stable. As described herein, protein thermo-stability is determined by a differential scanning calorimetry (DSC), where a pre-dried protein powder (with moisture less than 3%) is scanned from 0° C. to 200° C. In the protein's DSC curves, an endothermic peak larger than 10 mW/mg is determined to be a “denaturation peak”, and the temperature corresponding to the endothermic “denaturation peak” is defined as the “denaturation temperature” of the protein. A protein that is “thermo-stable” means that the protein has denaturation temperature of 200° C. or more. For purposes of the present disclosure, a protein with a denaturation temperature below 200° C. is considered “non-thermo-stable.” For example, it was found that the whey from bovine milk listed in Table 1 has a denaturation temperature at 158° C. according to DSC, and therefore the whey is considered non-thermo-stable.

### Protein Dissolution

In some embodiments, before blending with one or more polyurethanes, one or more proteins can be dissolved in an aqueous solution to form an aqueous protein mixture. In some embodiments, dissolving the protein in an aqueous solution before blending the protein with one or more polyurethanes can facilitate miscibility of the protein with the hard phase of the one or more polyurethanes. For example, dissolving the protein in an aqueous solution before blending the protein with one or more polyurethanes can facilitate miscibility of the protein with the hard phase of the polyurethane(s). Not all proteins are naturally miscible with any phase of a polyurethane. For example, and as exemplified in Examples 33 and 34, casein is not necessarily miscible with a polyurethane. As shown in these two examples, casein is immiscible with L3360 if casein, water, and L3360 are mixed. The obtained film had an opaque look with numerous optically visible granules in the film. However, casein is miscible with L3360's hard phase if casein is dissolved in a sodium hydroxide solution before mixing with L3360. The film obtained by blending these components had a transparent and uniform look with no optically visible granules in the film.

Suitable aqueous solutions include, but are not limited to, water, an aqueous alkali solution, an aqueous acid solution, an aqueous solution including an organic solvent, a urea solution, and mixtures thereof. In some embodiments, the aqueous alkali solution can be a basic solution such as a sodium hydroxide, ammonia or ammonium hydroxide solution. In some embodiments, examples of an acidic aqueous solution can be an acetic acid or hydrochloric acid (HCl) solutions. Suitable organic solvents include, but are not limited to, ethanol, isopropanol, acetone, ethyl acetate, isopropyl acetate, glycerol, and the like. In some embodiments, the protein concentration in the aqueous protein mixture can range from about 10 g/L to about 300 g/L, including subranges. For example, the protein concentration in the aqueous protein mixture can be about 10 g/L, about 20 g/L, about 30 g/L, about 40 g/L, about 50 g/L, about 60 g/L, about 70 g/L, about 80 g/L, about 90 g/L, about 100 g/L, about 150 g/L, about 200 g/L, about 250 g/L, or about 300 g/L, or within a range having any two of these values as endpoints, inclusive of the endpoints. In some embodiments, the protein concentration in the aqueous protein mixture can range from about 10 g/L to about 300 g/L, about 20 g/L to about 250 g/L, about 30 g/L to about 200 g/L, about 40 g/L to about 150 g/L, about 50 g/L to about 100 g/L, about 60 g/L to about 90 g/L, or about 70 g/L to about 80 g/L.

In some embodiments, the protein can be pretreated and/or purified to improve solubility in water. Suitable pretreatments include, but are not limited to, an acid treatment, an alkaline treatment, enzyme hydrolysis, and a salt treatment. An exemplary acid treatment is acid hydrolysis with suitable acid such as acetic acid or HCl. An exemplary alkaline treatment is alkaline hydrolysis with suitable base such as ammonium hydroxide, NaOH, KOH, or a mixture thereof. Exemplary enzymes for hydrolysis include, but are not limited to, papain, bromelain, trypsin, alkaline proteases, and the like. Suitable purification treatments include, but are not limited to, removal of phytate with calcium salt, diafiltration, ultrafiltration, centrifugation, and the like.

In some embodiments, adding lysine or other hydrophilic amino acids to the protein before blending with one or more polyurethanes can facilitate miscibility of the protein with the hard phase of the one or more polyurethanes.

### Protein Hydrolysis

In some embodiments, the protein can be partially-hydrolyzed. Partial hydrolysis of the protein can promote dissolution of the protein in water and/or facilitate miscibility of the protein with the hard phase of the polyurethane. Partial-hydrolysis of the protein can be accomplished using enzymes or strong to moderate base. Hydrolysis can be followed by a reduction in viscosity and/or reduction in protein molecular weight. Characterization methods for determining a reduction in protein molecular weight, and thus a level of protein hydrolysis, include but are not limited to, light scattering, gel electrophoresis, size exclusion chromatography, solution viscosity measurement, terminal amino group detection with trinitrobenzene sulfonic acid or ninhydrin, or particle size measurement with laser diffraction. Example 21 describes partially-hydrolyzed soy protein prepared using sodium hydroxide according to some embodiments.

### PEG-Modification of Proteins

In some embodiments, the protein can be chemically modified by covalent attachment of PEG polyethylene glycol (PEG) to the protein. PEG-modification of the protein can promote dissolution of the protein in water and/or facilitate miscibility with the protein with the hard phase of the polyurethane. PEG-modification of a protein can be accomplished using a method that covalently attaches hydrophilic polyethylene glycol (PEG) chains to the protein.

In some embodiments, the amount of protein in the protein polyurethane alloy can range from about 10 wt % to about 50 wt % of protein, including subranges. For example, in some embodiments, the amount of protein in the protein polyurethane alloy range from about 10 wt % to about 50 wt %, about 15 wt % to about 50 wt %, about 20 wt % to about 50 wt %, about 25 wt % to about 50 wt %, about 30 wt % to about 50 wt %, about 35 wt % to about 50 wt %, about 40 wt % to about 50 wt %, about 45 wt % to about 50 wt %, about 10 wt % to about 45 wt %, about 10 wt % to about 40 wt %, about 10 wt % to about 35 wt %, about 10 wt % to about 30 wt %, about 10 wt % to about 25 wt %, about 10 wt % to about 20, or about 10 wt % to about 15%, or within a range having any two of these values as endpoints, inclusive of the endpoints. In some embodiments, the amount of protein in the protein polyurethane alloy can range from about 20 wt % to about 35 wt %.

In some embodiments, the amount of polyurethane in the protein polyurethane alloy can range from about 50 wt % to about 90 wt %, including subranges. For example, in some embodiments, the amount of polyurethane in the protein polyurethane alloy can range from about 50 wt % to about 90 wt %, about 55 wt % to about 90 wt %, about 60 wt % to about 90 wt %, about 65 wt % to about 90 wt %, about 70 wt % to about 90 wt %, about 75 wt % to about 90 wt %, about 80 wt % to about 90 wt %, about 85 wt % to about 90 wt %, about 50 wt % to about 85 wt %, about 50 wt % to about 80 wt %, about 50 wt % to about 75 wt %, about 50 wt % to about 70 wt %, about 50 wt % to about 65 wt %, about 50 wt % to about 60 wt %, or about 50 wt % to about 55 wt %, or within a range having any two of these values as endpoints, inclusive of the endpoints. In some embodiments, the amount of polyurethane in the protein polyurethane alloy can range from about 65 wt % to about 80 wt %.

In some embodiments, the above-listed weight percent values and ranges can be based on the total weight of the protein polyurethane alloy or protein polyurethane alloy layer. In some embodiments, the above-listed weight percent values and ranges can be based on the total weight of only protein and polyurethane in a protein polyurethane alloy or protein polyurethane alloy layer. Unless otherwise specified, a weight percent value or range for the polyurethane and the protein is based on the total weight of only protein and polyurethane in a protein polyurethane alloy or protein polyurethane alloy layer.

In some embodiments, the sum of the amount of protein plus the amount of polyurethane in the protein polyurethane alloy can be about 80 wt % or more. For example, in some embodiments, the sum of the amount of protein plus the amount of polyurethane in the protein polyurethane alloy can range from about 80 wt % to 100 wt %, about 82 wt % to 100 wt %, about 84 wt % to 100 wt %, about 86 wt % to 100 wt %, about 88 wt % to 100 wt %, about 90 wt % to 100 wt %, about 92 wt % to 100 wt %, about 94 wt % to 100 wt %, about 96 wt % to 100 wt %, or about 98 wt % to 100 wt %.

In some embodiments, the protein polyurethane alloy can include water making up a portion of the total weight percent of the material. In some embodiments, the amount of water in the protein polyurethane alloy can range from about 1 wt % to about 10 wt %, including subranges. For example, in some embodiments, the amount of water in the protein polyurethane alloy can range from about 1 wt % to about 10 wt %, about 2 wt % to about 10 wt %, about 3 wt % to about 10 wt %, about 4 wt % to about 10 wt %, about 5 wt % to about 10 wt %, about 6 wt % to about 10 wt %, about 7 wt % to about 10 wt %, about 8 wt % to about 10 wt %, about 1 wt % to about 9 wt %, about 1 wt % to about 8 wt %, about 1 wt % to about 7 wt %, about 1 wt % to about 6 wt %, about 1 wt % to about 5 wt %, about 1 wt % to about 4 wt %, or about 1 wt % to about 3 wt %, or within a range having any two of these values as endpoints, inclusive of the endpoints.

A protein polyurethane alloy described herein can have one or more of (i) a second Dynamic Mechanical Analysis (DMA) modulus transition onset temperature greater than the second DMA modulus transition onset temperature of the unalloyed polyurethane (ii) a first Dynamic Mechanical Analysis (DMA) modulus transition onset temperature substantially the same as the first DMA modulus transition onset temperature of the unalloyed polyurethane, (iii) a DMA tan (δ) peak at a temperature substantially the same as the temperature of the DMA tan (δ) peak corresponding to the soft phase of the unalloyed polyurethane, (iv) a Young's modulus greater than the Young's modulus of the unalloyed polyurethane, (v) a tensile strength greater than the tensile strength of the unalloyed polyurethane, or (vi) a moisture vapor transmission rate (MVTR) greater than the MVTR of the unalloyed polyurethane.

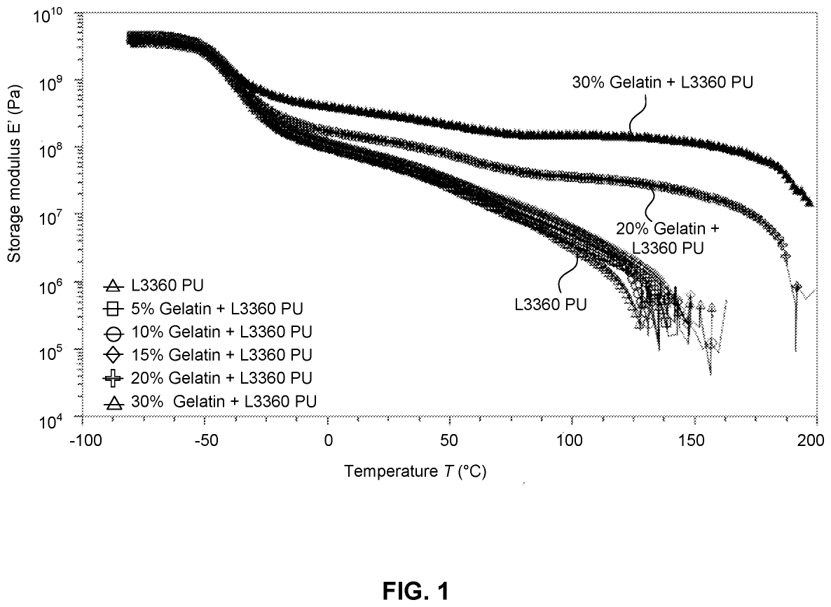

FIGS. 1-15 illustrate the effects of dissolving various amounts of different proteins in different polyurethanes to form polyurethane alloys according to some embodiments. Tables 3-6 list thermal and mechanical properties for various protein polyurethane alloys according to some embodiments, as well as thermal and mechanical properties for various polyurethanes. The samples tested were prepared by blending the listed protein with an aqueous dispersion of the listed polyurethane, casting the mixture as a flat film, drying in oven at 45° C. overnight (16 to 24 hours), and conditioning at standard reference atmosphere (23° C., 50% humidity) for 24 hours before testing. The weight percent values in the FIGURES and Tables 3-6 are the relative weight percent of solids added to the blend used to create the samples. For example, 0.825 grams of gelatin and 5.5 g of L3360 (35 wt % solids) were blended to create the sample for Example No. 9 having 30 wt % gelatin and 70 wt % L3360. The weight percentages in the FIGURES and Tables 3-6 can closely approximate the weight percentages of protein and polyurethane in the dried samples of Example Nos. 1-44, based on the total weight of the dried samples. The dried samples included water making up a small portion (for example, about 5% to about 10 wt %) of the total weight percent of the sample.

Table 7 lists moisture vapor transmission rates for various protein polyurethane alloys according to some embodiments. The samples tested were prepared as described in Example Nos. 45-56. The weight percent values in Table 7 are the relative weight percent of solids added to the blend used to create the samples. These weight percentages can closely approximate the weight percentages of protein and polyurethane in the dried samples of Example Nos. 45-56, based on the total weight of the dried samples. The dried samples included water making up a small portion (for example, about 5% to about 10 wt %) of the total weight percent of the sample.

The DMA temperatures in Tables 3 and 4 were measured using a DMA-850 from TA Instruments. For testing, a 1 cm×2.5 cm strip was cut from a sample film using a metal die. The cut film samples were loaded into the film and fiber tension clamp for testing. During testing, a pre-load of 0.01 newtons (N) was applied to the cut film samples. The instrument was cooled to −80° C., held for 1 minute, then the temperature was ramped at 4° C./minute to 200° C., or until the sample was too weak to be held in tension. During the temperature ramp, the sample was oscillated 0.1% strain at a frequency of 1 Hz. The resulting storage modulus, loss modulus, and tan (δ) values were plotted with temperature for each test. Unless otherwise specified, all DMA test data reported herein was measured using this test methodology. The tensile strength values and Young's modulus values in Tables 5 and 6 were measured according the method provided by ASTM D638. The tensile strength values and Young's modulus values are an average of at least three sample specimens tested.

The DMA graph shown in FIG. 1 shows the measured storage modulus (E′) for 100% L3360 (Example No. 1) and gelatin dissolved within L3360 at various weight percentages, namely 5 wt %, 10 wt %, 15 wt %, 20%, and 30 wt % (Example Nos. 9 and 25-28). This graph illustrates that blending gelatin with L3360 can create an alloy with a second DMA modulus transition onset temperature greater than the second DMA modulus transition onset temperature of 100% L3360. Without wishing to be bound by a particular theory, it is believed that as the hard phase comprising gelatin and the hard segment of the polyurethane become continuous at higher gelatin content, the increase in the second DMA modulus transition onset temperature becomes more apparent in this test. This trend indicates that the gelatin is miscible with the hard phase of L3360.

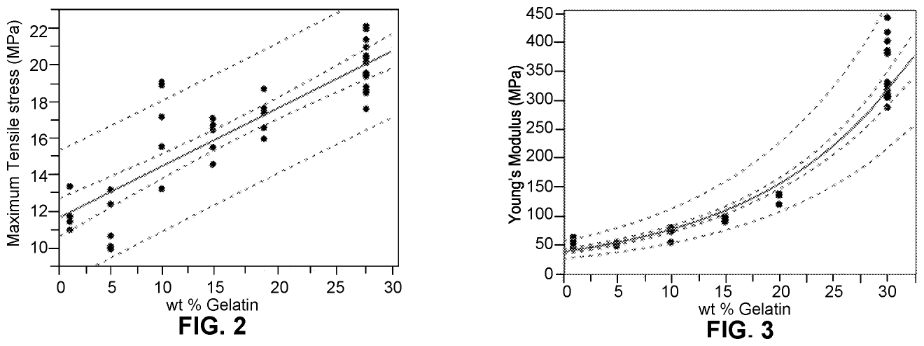

This miscibility of gelatin with the hard phase L3360 is further exemplified in the mechanical property graphs of FIG. 2 and FIG. 3, which compare two different mechanical properties of Example No. 1 and Example Nos. 9 and 25-28. As shown in FIG. 2, the maximum tensile stress (“tensile strength”) of the protein polyurethane alloys tested is greater than the maximum tensile stress of 100% L3360. This increase in maximum tensile stress is particularly significant at gelatin weight percentages of 10 wt % or more. As shown in FIG. 3, the Young's modulus of the protein polyurethane alloys tested is greater than the Young's modulus of 100% L3360. This increase in Young's modulus is particularly significant at gelatin weight percentages of 15 wt % or more.

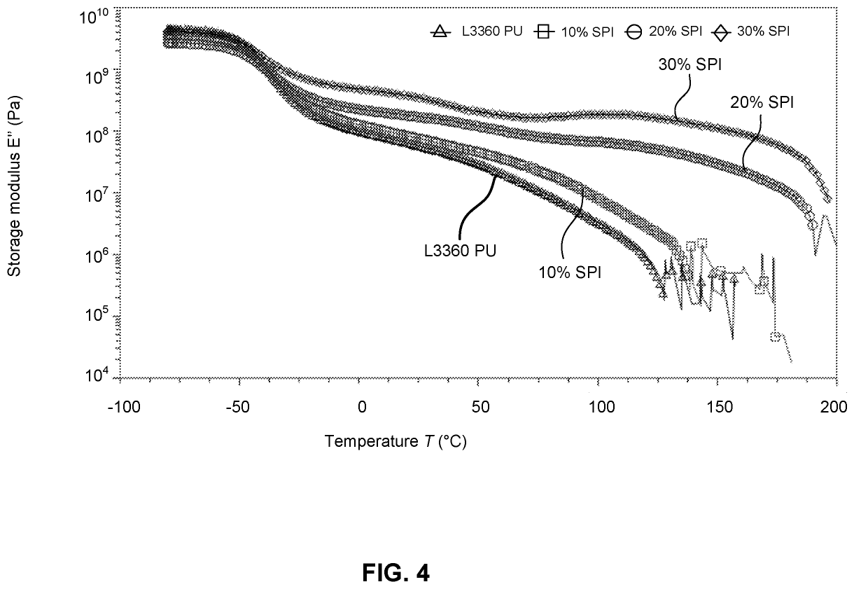

The DMA graph shown in FIG. 4 shows the measured storage modulus (E′) for 100% L3360 (Example No. 1) and SPI dissolved within L3360 at various weight percentages, namely 10 wt %, 20%, and 30 wt % (Example Nos. 21, 30, and 31). This thermogram illustrates that blending SPI with L3360 can create a protein polyurethane alloy with a second DMA modulus transition onset temperature greater than the second DMA modulus transition onset temperature of 100% L3360. As more SPI is added, the increase in the second DMA modulus transition onset temperature increases. This trend indicates that the SPI in miscible with the hard phase of L3360.

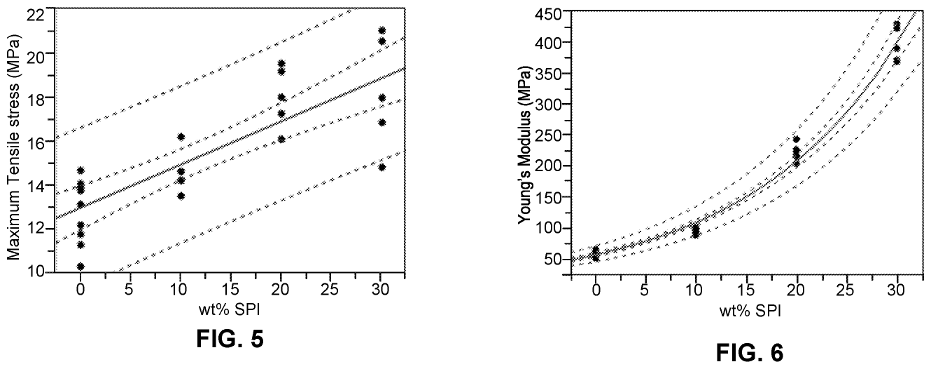

This miscibility of SPI with the hard phase L3360 is further exemplified in the mechanical property graphs of FIG. 5 and FIG. 6, which compare two different mechanical properties of Example No. 1 and Example Nos. 21, 30, and 31. As shown in FIG. 5, the maximum tensile stress (“tensile strength”) of the protein polyurethane alloys tested is greater than the maximum tensile stress of 100% L3360. This increase in maximum tensile stress is particularly significant at SPI weight percentages of 10 wt % or more. As shown in FIG. 6, the Young's modulus of the protein polyurethane alloys tested is greater than the Young's modulus of 100% L3360. This increase in Young's modulus is particularly significant at SPI weight percentages of 15 wt % or more.

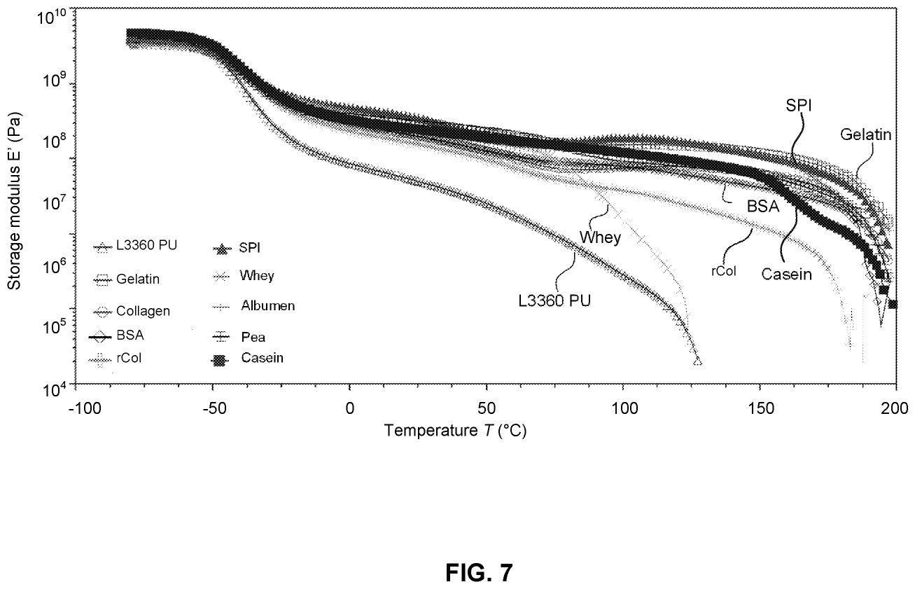

The DMA graph shown in FIG. 7 shows the measured storage modulus (E′) for 100% L3360 (Example No. 1) and various proteins dissolved within L3360 at 30 wt % (Example Nos. 9 and 17-23). This graph illustrates that gelatin, SPI, and other proteins can be blended with L3360 to create a protein polyurethane alloy with a second DMA modulus transition onset temperature greater than the second DMA modulus transition onset temperature of 100% L3360. All the proteins, except Whey, produced protein polyurethane alloys with a second DMA modulus transition onset temperature greater than that of 100% L3360. It is believed Whey is miscible with L3360's hard phase due to its ability to improve mechanical properties of a protein polyurethane alloy relative to 100% L3360. But it is believed that Whey did not increase the second DMA modulus transition onset temperature because Whey has a low denaturation temperature as determined by DSC.

Further, the graph of FIG. 7 shows that dissolving the various proteins within L3360 did not result in a protein polyurethane alloy having a DMA transition temperature of the soft phase significantly different from the DMA transition temperature of the soft phase for 100% L3360. As shown in Table 4, the Delta 1^{st} Modulus Transition Onset for all of Example Nos. 9 and 17-23 was less than 10° C. Relatedly, the Delta Tan (δ) Peak Temperature for all of Example Nos. 9 and 17-23 was less than 10° C. These results indicate the proteins were not miscible with L3360's soft phase.

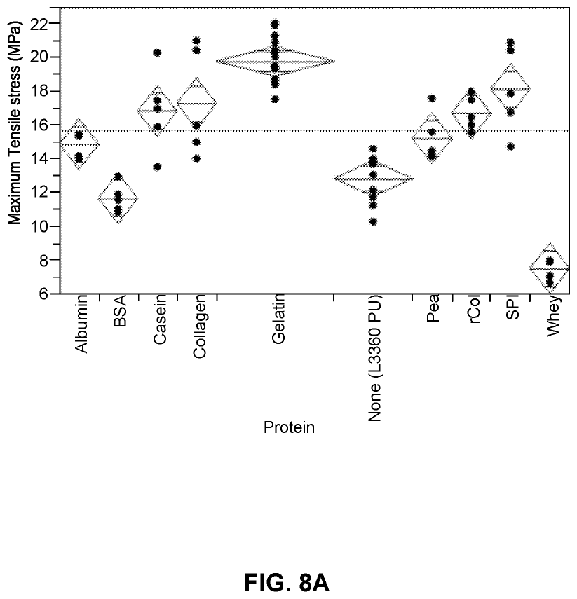

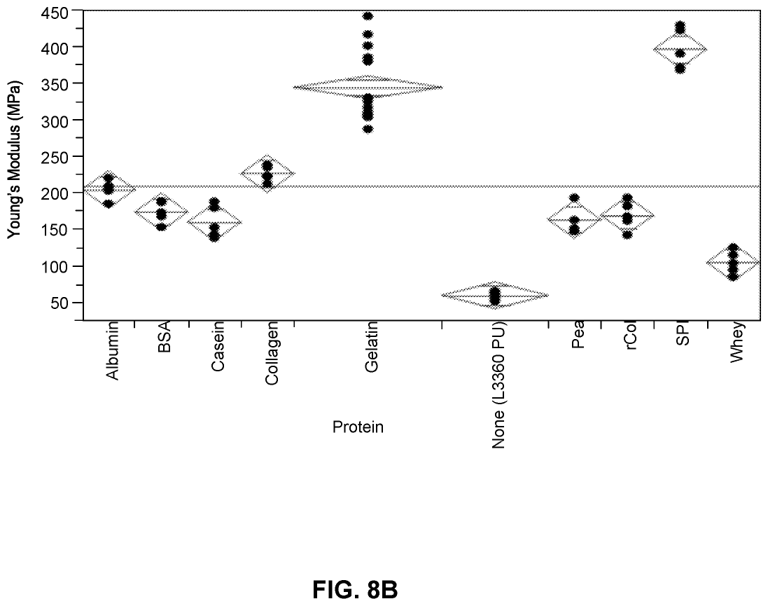

This selective miscibility of the proteins with the hard phase L3360 is further exemplified in the mechanical property test results plotted in the graphs of FIG. 8A and FIG. 8B, and reported in Tables 5 and 6. The graphs of FIG. 8A and FIG. 8B compare the tensile strength and Young's modulus of Example No. 1 and Example Nos. 9 and 17-23. An increase in tensile strength and/or an increase in Young's modulus can indicate that a protein is miscible with the hard phase of L3360. Tables 5 and 6 report the tensile strength and Young's modulus of the materials.

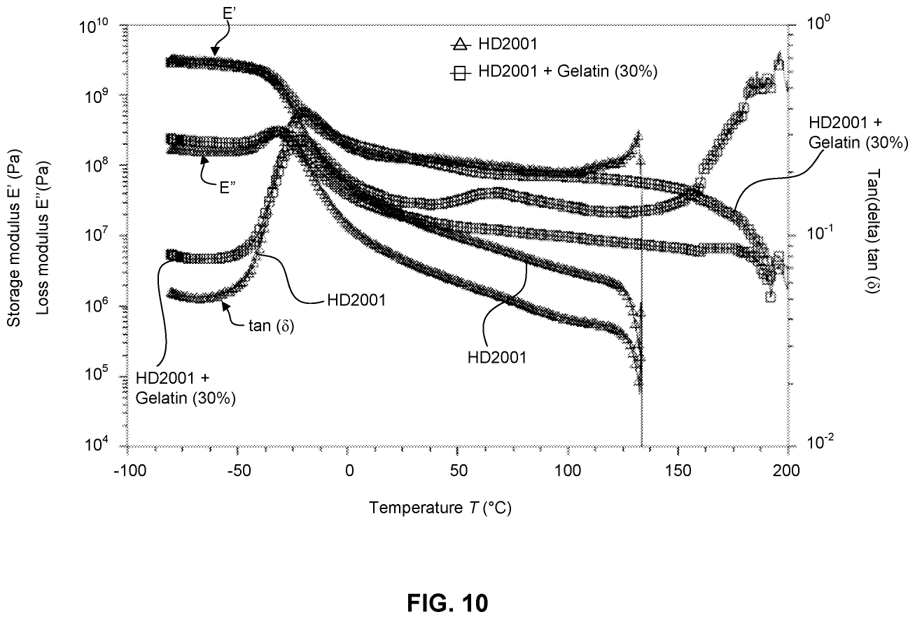

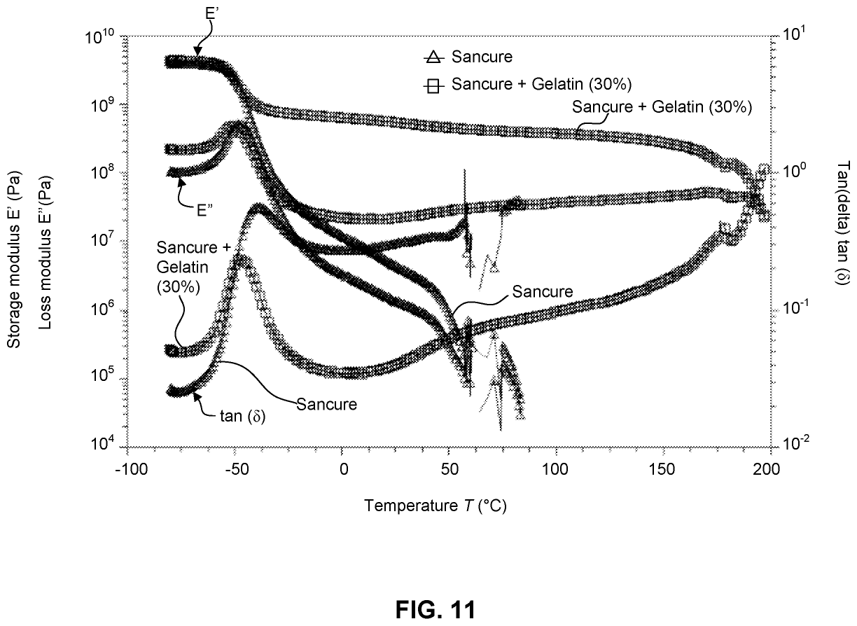

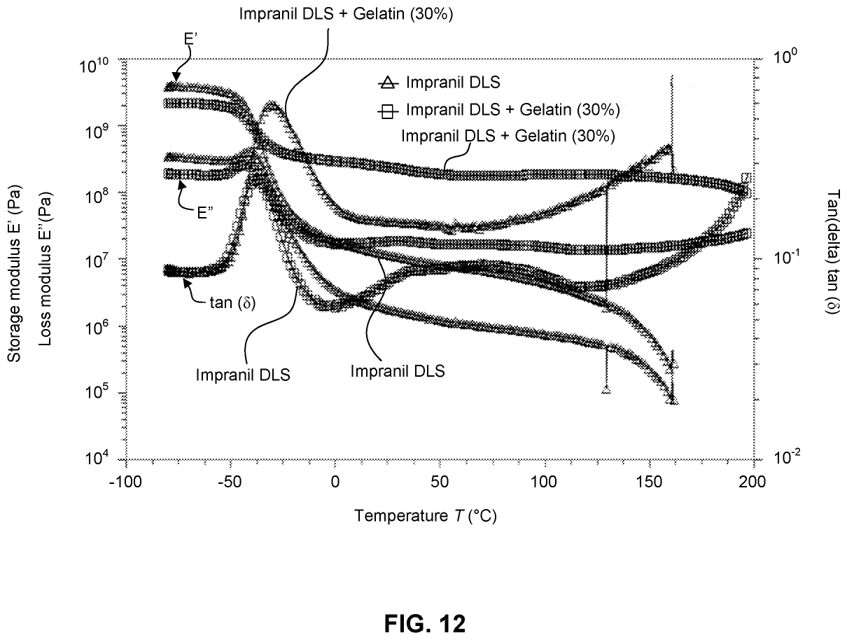

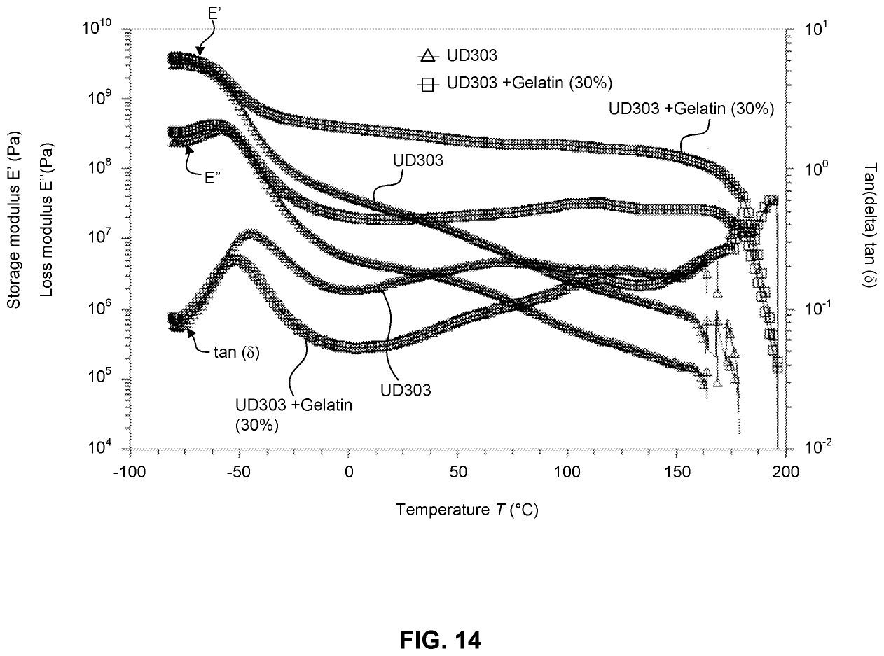

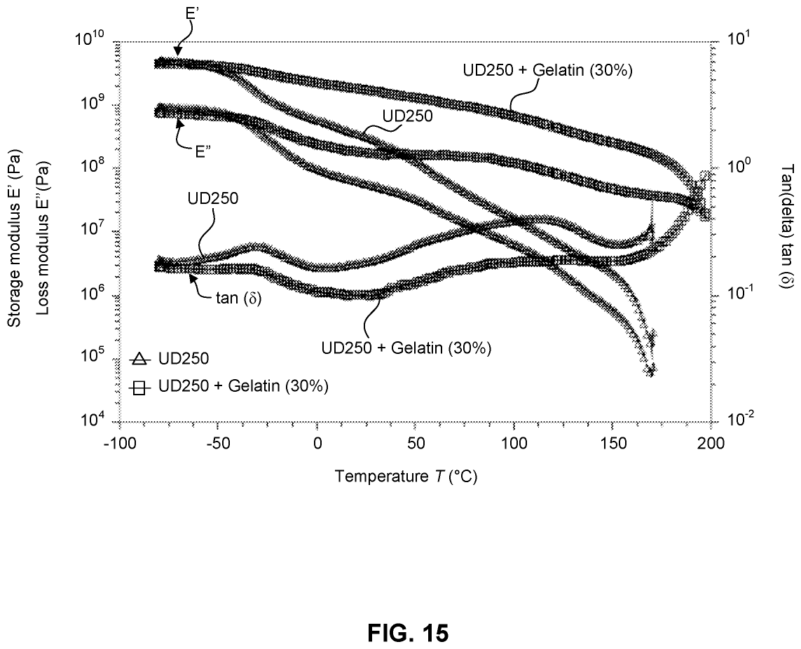

To further illustrate the selective miscibility of proteins with the hard phase of a polyurethane having both a soft phase and a hard phase, gelatin was blended with various exemplary polyurethanes. FIGS. 9-15 show DMA thermograms for these exemplary blends as well as thermograms for the polyurethanes in the absence of gelatin. FIG. 9 compares the DMA data for a protein polyurethane alloy made of 30 wt % gelatin and 70 wt % L3360 (Example No. 9) and 100% L3360 (Example No. 1). FIG. 10 compares the DMA data for a protein polyurethane alloy made of 30 wt % gelatin and 70 wt % HD-2001 (Example No. 15) and 100% HD-2001 (Example No. 7). FIG. 11 compares the DMA data for a protein polyurethane alloy made of 30 wt % gelatin and 70 wt % Sancure (Example No. 14) and 100% Sancure (Example No. 6). FIG. 12 compares the DMA data for a protein polyurethane alloy made of 30 wt % gelatin and 70 wt % Impranil DLS (Example No. 12) and 100% Impranil DLS (Example No. 5). FIG. 13 compares the DMA data for a protein polyurethane alloy made of 30 wt % gelatin and 70 wt % UD-108 (Example No. 10) and 100% UD-108 (Example No. 2). FIG. 14 compares the DMA data for a protein polyurethane alloy made of 30 wt % gelatin and 70 wt % UD-303 (Example No. 13) and 100% UD-303 (Example No. 4). FIG. 15 compares the DMA data for a protein polyurethane alloy made of 30 wt % gelatin and 70 wt % UD-250 (Example No. 11) and 100% UD-250 (Example No. 3).

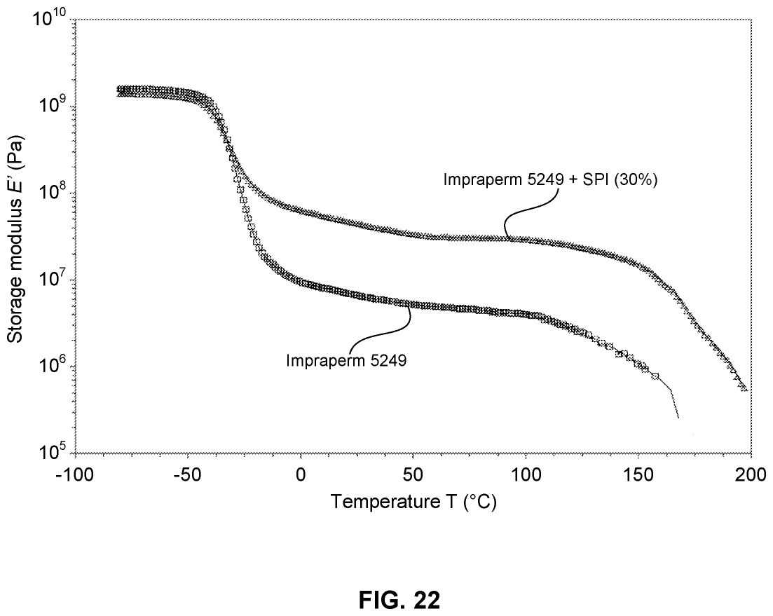

FIG. 22 compares the DMA data for a protein polyurethane alloy made of 30 wt % soy protein isolate (SPI) and 70 wt % IMPRAPERM® DL 5249 and a 100% IMPRAPERM® DL 5249 polyurethane sample. Three samples of the 30 wt % soy protein isolate (SPI) and 70 wt % IMPRAPERM® DL 5249 alloy of FIG. 22 having a mean thickness of 0.44 mm had an average Young's modulus of 65.80 MPa. Three samples of the 100% IMPRAPERM® DL 5249 polyurethane of FIG. 22 having a mean thickness of 0.7 mm had an average Young's modulus of 10.13 MPa. The DMA data shown in FIG. 22 and the results of this mechanical testing for the protein polyurethane alloy illustrate the selective miscibility of the SPI with the hard phase of IMPRAPERM® DL 5249.

Tables 3 and 4 report DMA data for the various exemplary polyurethanes and those same polyurethanes blended with 30 wt % gelatin. Tables 5 and 6 report the tensile strength and Young's modulus data for the various exemplary polyurethanes and those same polyurethanes blended with 30 wt % gelatin. The results indicate selective miscibility of proteins tested with the hard phase of polyurethanes tested.

In some embodiments, the protein polyurethane alloy can comprise a polyurethane having a second DMA modulus transition onset temperature in the absence of protein. That same protein polyurethane alloy can have a second DMA modulus transition onset temperature ranging from about 5° C. to about 100° C. greater than the second DMA modulus transition onset temperature of the polyurethane in the absence of protein. This relative increase in the second DMA modulus transition onset temperature can be referred to as “Delta 2^{nd} Modulus Transition Onset.” In some embodiments, the Delta 2^{nd} Modulus Transition Onset can be about 5° C. or more. In some embodiments, the Delta 2^{nd} Modulus Transition Onset can range from about 5° C. to about 100° C., about 5° C. to about 95° C., about 5° C. to about 90° C., about 5° C. to about 85° C., about 5° C. to about 80° C., about 5° C. to about 75° C., about 5° C. to about 70° C., about 5° C. to about 65° C., about 5° C. to about 60° C., about 5° C. to about 55° C., about 5° C. to about 50° C., about 5° C. to about 45° C., about 5° C. to about 40° C., about 5° C. to about 35° C., about 5° C. to about 30° C., about 5° C. to about 25° C., about 5° C. to about 20° C., about 5° C. to about 15° C., about 5° C. to about 10° C., about 10° C. to about 100° C., about 15° C. to about 100° C., about 20° C. to about 100° C., about 25° C. to about 100° C., about 30° C. to about 100° C., about 35° C. to about 100° C., about 40° C. to about 100° C., about 45° C. to about 100° C., about 50° C. to about 100° C., about 55° C. to about 100, about 60° C. to about 100° C., about 65° C. to about 100° C., about 70° C. to about 100° C., about 75° C. to about 100° C., about 80° C. to about 100° C., about 85° C. to about 100° C., about 90° C. to about 100° C., or about 95° C. to about 100° C., or within an range having any two of these values as endpoints, inclusive of the endpoints.

In some embodiments, the Delta 2^{nd} Modulus Transition Onset can range from about 5° C. to about 80° C. In some embodiments, the Delta 2^{nd} Modulus Transition Onset can range from about 20° C. to about 80° C. In some embodiments, the Delta 2^{nd} Modulus Transition Onset can range from about 40° C. to about 80° C. In some embodiments, the Delta 2^{nd} Modulus Transition Onset can be greater than about 100° C. For example, the Delta 2nd Modulus Transition Onset can range from about 100° C. to about 150° C.

In some embodiments, a soy protein polyurethane alloy can comprise a polyurethane having a second DMA modulus transition onset temperature in the absence of soy protein. That same soy protein polyurethane alloy can have a second DMA modulus transition onset temperature ranging from about 15° C. to about 100° C. greater than the second DMA modulus transition onset temperature of the polyurethane in the absence of soy protein. In some embodiments, the Delta 2^{nd} Modulus Transition Onset for the soy protein polyurethane alloy can be about 15° C. or more. In some embodiments, the Delta 2^{nd} Modulus Transition Onset for a soy protein polyurethane alloy can range from about 15° C. to about 100° C., about 15° C. to about 95° C., about 15° C. to about 90° C., about 15° C. to about 85° C., about 15° C. to about 80° C., about 15° C. to about 75° C., about 15° C. to about 70° C., about 15° C. to about 65° C., about 15° C. to about 60° C., about 15° C. to about 55° C., about 15° C. to about 50° C., about 15° C. to about 45° C., about 15° C. to about 40° C., about 15° C. to about 35° C., about 15° C. to about 30° C., about 15° C. to about 25° C., about 15° C. to about 20° C., about 20° C. to about 100° C., about 25° C. to about 100° C., about 30° C. to about 100° C., about 35° C. to about 100° C., about 40° C. to about 100° C., about 45° C. to about 100° C., about 50° C. to about 100° C., about 55° C. to about 100, about 60° C. to about 100° C., about 65° C. to about 100° C., about 70° C. to about 100° C., about 75° C. to about 100° C., about 80° C. to about 100° C., about 85° C. to about 100° C., about 90° C. to about 100° C., or about 95° C. to about 100° C., or within an range having any two of these values as endpoints, inclusive of the endpoints.

In some embodiments, the protein polyurethane alloy can have a second DMA modulus transition onset temperature ranging from about 100° C. to about 200° C., including subranges. For example, in some embodiments, the protein polyurethane alloy can have a second DMA modulus transition onset temperature ranging from about 100° C. to about 200° C., about 100° C. to about 195° C., about 100° C. to about 190° C., about 100° C. to about 185° C., about 100° C. to about 180° C., about 100° C. to about 175° C., about 100° C. to about 170° C., about 100° C. to about 165° C., about 100° C. to about 160° C., about 100° C. to about 155° C., about 100° C. to about 150° C., about 100° C. to about 145° C., about 100° C. to about 140° C., about 100° C. to about 135° C., about 100° C. to about 130° C., about 100° C. to about 125° C., or about 100 to about 120° C., about 105° C. to about 200° C., about 110° C. to about 200° C., about 115° C. to about 200° C., about 120° C. to about 200° C., about 125° C. to about 200° C., about 130° C. to about 200° C., about 135° C. to about 200° C., about 140° C. to about 200° C., about 145° C. to about 200° C., about 150° C. to about 200° C., about 155° C. to about 200° C., about 160° C. to about 200° C., about 165° C. to about 200° C., about 170° C. to about 200° C., about 175° C. to about 200° C., or about 180° C. to about 200° C., or within a range having any two of these values as endpoints, inclusive of the endpoints. In some embodiments, the protein polyurethane alloy can have a second DMA modulus transition onset temperature ranging from about 120° C. to about 200° C. In some embodiments, the protein polyurethane alloy can have a second DMA modulus transition onset temperature ranging from about 130° C. to about 200° C. In some embodiments, the protein polyurethane alloy can have a second DMA modulus transition onset temperature ranging from about 165° C. to about 200° C.

In some embodiments, the soy protein polyurethane alloy can have a second DMA modulus transition onset temperature ranging from about 130° C. to about 200° C., including subranges. For example, in some embodiments, the soy protein polyurethane alloy can have a second DMA modulus transition onset temperature ranging from about 130° C. to about 200° C., about 130° C. to about 195° C., about 130° C. to about 190° C., about 130° C. to about 185° C., about 130° C. to about 180° C., about 130° C. to about 175° C., about 130° C. to about 170° C., about 130° C. to about 165° C., about 130° C. to about 160° C., about 130° C. to about 155° C., about 130° C. to about 150° C., about 130° C. to about 145° C., about 130° C. to about 140° C., about 135° C. to about 200° C., about 140° C. to about 200° C., about 145° C. to about 200° C., about 150° C. to about 200° C., about 155° C. to about 200° C., about 160° C. to about 200° C., about 165° C. to about 200° C., about 170° C. to about 200° C., about 175° C. to about 200° C., about 180° C. to about 200° C., about 185° C. to about 200° C., or about 190° C. to about 200° C., or within a range having any two of these values as endpoints, inclusive of the endpoints.

In some embodiments, the protein polyurethane alloy can have a first DMA modulus transition temperature below 30° C. In some embodiments, the protein polyurethane alloy can have a first DMA modulus transition onset temperature ranging from about −65° C. to about 30° C., including subranges. For example, in some embodiments, the first DMA modulus transition onset temperature for the protein polyurethane alloy can range from about −65° C. to about 30° C., about −65° C. to about 25° C., about −65° C. to about 20° C., about −65° C. to about 15° C., about −65° C. to about 10° C., about −65° C. to about 5° C., about −65° C. to about 1° C., about −65° C. to 0° C., about −65° C. to about 1° C., about −65° C. to about −5° C., about −65° C. to about −10° C., about −65° C. to about −15° C., about −65° C. to about −20° C., about −65° C. to about −25° C., about −65° C. to about −30° C., about −65° C. to about −35° C., about −65° C. to about −35° C., about −65° C. to about −40° C., or about −65° C. to about −45° C., or within a range having any two of these values as endpoints, inclusive of the end points.

In some embodiments, the protein polyurethane alloy can comprise a polyurethane having a first DMA modulus transition onset temperature in the absence of protein. That same protein polyurethane alloy can have a first DMA modulus transition onset temperature that is +/−X° C. the first DMA modulus transition onset temperature of the polyurethane in the absence of protein. This relative increase or decrease in the first DMA modulus transition onset temperature can be referred to as “Delta 1^{st} Modulus Transition Onset.” In some embodiments, X can be 1, 2, 3, 4, 5, 6, 7, 8, 9, or 10.

In some embodiments, the protein polyurethane alloy can have a DMA tan (δ) peak temperature below 30° C. In some embodiments, the protein polyurethane alloy can have a DMA tan (δ) peak temperature ranging from about −60° C. to about 30° C., including subranges. For example, in some embodiments, the DMA tan (δ) peak temperature for the protein polyurethane alloy can range from about −60° C. to about 30° C., about −60° C. to about 25° C., about −60° C. to about 20° C., about −60° C. to about 15° C., about −60° C. to about 10° C., about −60° C. to about 5° C., about −60° C. to about 1° C., about −60° C. to 0° C., about −60° C. to about 1° C., about −60° C. to about −5° C., about −60° C. to about −10° C., about −60° C. to about −15° C., about −60° C. to about −20° C., about −60° C. to about −25° C., about −60° C. to about −30° C., about −60° C. to about −35° C., or about −60° C. to about −40° C., or within a range having any two of these values as endpoints.

In some embodiments, the protein polyurethane alloy can include a polyurethane having a DMA tan (δ) peak temperature corresponding to the soft phase of the polyurethane in the absence of protein. That same the protein polyurethane alloy can have a DMA tan (δ) peak temperature that is +/−Y° C. the DMA tan (δ) peak temperature corresponding to the soft phase of the polyurethane in the absence of protein. This relative increase or decrease in the DMA tan (δ) peak temperature can be referred to as “Delta Tan (δ) Peak Temperature.” In some embodiments, Y can be 1, 2, 3, 4, 5, 6, 7, 8, 9, or 10.

In some embodiments, the protein polyurethane alloy can comprise a polyurethane having a tensile strength in the absence of protein. That same protein polyurethane alloy can have a tensile strength about 5% to about 55% greater than the tensile strength of the polyurethane in the absence of protein. This relative percent increase in tensile strength can be referred to as “% Delta Tensile Strength.” In some embodiments, % Delta Tensile Strength can be 5% or more. In some embodiments, % Delta Tensile Strength can range from about 5% to about 55%, about 10% to about 55%, about 15% to about 55%, about 20% to about 55%, about 25% to about 55%, about 30% to about 55%, about 35% to about 55%, about 40% to about 55%, about 45% to about 55%, about 50% to about 55%, about 5% to about 50%, about 5% to about 45%, about 5% to about 40%, about 5% to about 35%, about 5% to about 30%, about 5% to about 25%, about 5% to about 20%, about 5% to about 15%, or about 5% to about 10%, or within a range having any two of these values as endpoints, inclusive of the endpoints. In some embodiments, % Delta Tensile Strength can range from about 15% to about 55%. In some embodiments, % Delta Tensile Strength can be greater than about 55%. For example, % Delta Tensile Strength can range from about 55% to about 1000%.

In some embodiments, the soy protein polyurethane alloy can comprise a polyurethane having a tensile strength in the absence of soy protein. That same soy protein polyurethane alloy can have a tensile strength about 10% to about 45% greater than the tensile strength of the polyurethane in the absence of soy protein. In some embodiments, % Delta Tensile Strength for the soy protein polyurethane alloy can be 10% or more. In some embodiments, % Delta Tensile Strength for the soy protein polyurethane alloy can range from about 10% to about 45%, about 15% to about 45%, about 20% to about 45%, about 25% to about 45%, about 30% to about 45%, about 35% to about 45%, about 40% to about 45%, about 10% to about 40%, about 10% to about 35%, about 10% to about 30%, about 10% to about 25%, about 10% to about 20%, or about 10% to about 15%, or within a range having any two of these values as endpoints, inclusive of the endpoints.

In some embodiments, the protein polyurethane alloy can comprise a polyurethane having a tensile strength in the absence of protein. That same protein polyurethane alloy can have a tensile strength ranging from about 2 MPa (megapascals) to about 8 MPa greater than the tensile strength of the polyurethane in the absence of protein. This relative increase in tensile strength can be referred to as “Delta Tensile Strength.” In some embodiments, Delta Tensile Strength can be 2 MPa or more. In some embodiments, Delta Tensile Strength can range from about 2 MPa to about 8 MPa, about 3 MPa to about 8 MPa, about 4 MPa to about 8 MPa, about 5 MPa to about 8 MPa, about 6 MPa to about MPa, about 7 MPa to about 8 MPa, about 2 MPa to about 7 MPa, about 2 MPa to about 6 MPa, about 2 MPa to about 5 MPa, about 2 MPa to about 4 MPa, or about 2 MPa to about 3 MPa, or within a range having any two of these values as endpoints, inclusive of the endpoints. In some embodiments, Delta Tensile Strength can range from about 5 MPa to about 8 MPa. In some embodiments, Delta Tensile Strength can be greater than about 8 MPa. For example, Delta Tensile Strength can range from about 8 MPa to about 15 MPa.

In some embodiments, the soy protein polyurethane alloy can comprise a polyurethane having a tensile strength in the absence of soy protein. That same soy protein polyurethane alloy can have a tensile strength ranging from about 1.5 MPa to about 5.5 MPa greater than the tensile strength of the polyurethane in the absence of soy protein. In some embodiments, Delta Tensile Strength for the soy protein polyurethane alloy can be 1.5 MPa or more. In some embodiments, Delta Tensile Strength for the soy protein polyurethane alloy can range from about 1.5 MPa to about 5.5 MPa, about 2 MPa to about 5.5 MPa, about 3 MPa to about 5.5 MPa, about 4 MPa to about 5.5 MPa, about 1.5 MPa to about 5 MPa, about 1.5 MPa to about 4 MPa, or about 1.5 MPa to about 3 MPa, or within a range having any two of these values as endpoints, inclusive of the endpoints.

In some embodiments, the protein polyurethane alloy can have a tensile strength ranging from about 7 MPa to about 21 MPa, including subranges. For example, in some embodiments, the protein polyurethane alloy can have a tensile strength ranging from about 7 MPa to about 21 MPa, about 10 MPa to about 21 MPa, about 15 MPa to about 21 MPa, about 7 MPa to about 15 MPa, or about 7 MPa to about 10 MPa, or within a range having any of these values as endpoints, inclusive of the endpoints. In some embodiments, the protein polyurethane alloy can have a tensile strength greater than about 21 MPa. For example, the protein polyurethane alloy can have a tensile strength ranging from about 21 MPa to about 25 MPa.

In some embodiments, the soy protein polyurethane alloy can have a tensile strength ranging from about 14 MPa to about 19 MPa or about 16 MPa to about 19 MPa.

In some embodiments, the polyurethane in the absence of protein can have a tensile strength of about 2 MPa or more. In some embodiments, the polyurethane in the absence of protein can have a tensile strength ranging from about 2 MPa to about 35 MPa, including subranges. For example, in some embodiments, the polyurethane in the absence of protein can have a tensile strength ranging from about 2 MPa to about 35 MPa, about 5 MPa to about 30 MPa, about 10 MPa to about 25 MPa, or about 15 MPa to about 20 MPa, or within a range having any two of these values as endpoints, inclusive of the endpoints. In some embodiments, the polyurethane in the absence of protein can have a tensile strength ranging from about 10 MPa to about 15 MPa. In some embodiments, the polyurethane in the absence of protein can have a tensile strength ranging from about 1 MPa to about 35 MPa.

In some embodiments, the protein polyurethane alloy can comprise a polyurethane having a Young's modulus in the absence of protein. That same protein polyurethane alloy can have a Young's modulus ranging from about 10% to about 600% greater than the Young's modulus of the polyurethane in the absence of protein. This relative percent increase in Young's modulus can be referred to as “% Delta Young's Modulus.” In some embodiments, the % Delta Young's Modulus can be about 10% or more. In some embodiments, the % Delta Young's Modulus can range from about 10% to about 600%, about 20% to about 600%, about 30% to about 600%, about 40% to about 600%, about 50% to about 600%, about 60% to about 600%, about 70% to about 600%, about 80% to about 600%, about 90% to about 600%, about 100% to about 600%, about 200% to about 600%, about 300% to about 600%, about 400% to about 600%, or about 500% to about 600%, or within a range having any two of these values as endpoints, inclusive of the end points. In some embodiments, the % Delta Young's Modulus can range from about 40% to about 600%. In some embodiments, the % Delta Young's Modulus can greater than about 600%. For example, the % Delta Young's Modulus can range from about 600% to about 2400%.

In some embodiments, the soy protein polyurethane alloy can comprise a polyurethane having a Young's modulus in the absence of soy protein. That same soy protein polyurethane alloy can have a Young's modulus ranging from about 60% to about 570% greater than the Young's modulus of the polyurethane in the absence of soy protein. In some embodiments, the % Delta Young's Modulus for the soy protein polyurethane alloy can be about 60% or more. In some embodiments, the % Delta Young's Modulus for the soy protein polyurethane alloy can range from about 60% to about 570%, about 100% to about 570%, about 200% to about 570%, about 300% to about 570%, about 400% to about 570%, or about 500% to about 570%, or within a range having any two of these values as endpoints, inclusive of the end points.

In some embodiments, the protein polyurethane alloy can comprise a polyurethane having a Young's modulus in the absence of protein. That same protein polyurethane alloy can have a Young's modulus ranging from about 10 MPa to about 350 MPa greater than the Young's modulus of the polyurethane in the absence of protein. This relative increase in Young's modulus can be referred to as “Delta Young's Modulus.” In some embodiments, the Delta Young's Modulus can be greater than 10 MPa. In some embodiments, the Delta Young's Modulus can range from about 10 MPa to about 350 MPa, about 25 MPa to about 350 MPa, about 50 MPa to about 350 MPa, about 100 MPa to about 350 MPa, about 150 MPa to about 350 MPa, about 200 MPa to about 350 MPa, about 250 MPa to about 350 MPa, about 300 MPa to about 350 MPa, about 10 MPa to about 300 MPa, about 10 MPa to about 250 MPa, about 10 MPa to about 200 MPa, about 10 MPa to about 150 MPa, about 10 MPa to about 100 MPa, about 10 MPa to about 50 MPa, or about 10 MPa to about 25 MPa, or within a range having any two of these values as endpoints, inclusive of the endpoints. In some embodiments, the Delta Young's Modulus can range from about 25 MPa to about 350 MPa. In some embodiments, the Delta Young's Modulus can range from about 100 MPa to about 350 MPa.

In some embodiments, the soy protein polyurethane alloy can comprise a polyurethane having a Young's modulus in the absence of soy protein. That same soy protein polyurethane alloy can have a Young's modulus ranging from about 35 MPa to about 340 MPa greater than the Young's modulus of the polyurethane in the absence of soy protein. In some embodiments, the Delta Young's Modulus for the soy protein polyurethane alloy can be greater than 35 MPa. In some embodiments, the Delta Young's Modulus for the soy protein polyurethane alloy can range from about 35 MPa to about 340 MPa, about 50 MPa to about 340 MPa, about 100 MPa to about 340 MPa, about 150 MPa to about 340 MPa, about 200 MPa to about 340 MPa, about 250 MPa to about 340 MPa, about 300 MPa to about 340 MPa, about 35 MPa to about 300 MPa, about 35 MPa to about 250 MPa, about 35 MPa to about 200 MPa, about 35 MPa to about 150 MPa, about 35 MPa to about 100 MPa, or about 35 MPa to about 50 MPa, or within a range having any two of these values as endpoints, inclusive of the endpoints.

In some embodiments, the protein polyurethane alloy can have a Young's modulus ranging from about 50 MPa to about 450 MPa, including subranges. For example, in some embodiments, the protein polyurethane alloy can have a Young's modulus ranging from about 50 MPa to about 450 MPa, about 75 MPa to about 450 MPa, about 100 MPa to about 450 MPa, about 150 MPa to about 450 MPa, about 200 MPa to about 450 MPa, about 250 MPa to about 450 MPa, about 300 MPa to about 450 MPa, about 350 MPa to about 450 MPa, about 400 MPa to about 450 MPa, about 50 MPa to about 400 MPa, about 50 MPa to about 350 MPa, about 50 MPa to about 300 MPa, about 50 MPa to about 250 MPa, about 50 MPa to about 200 MPa, about 50 MPa to about 150 MPa, about 50 MPa to about 100 MPa, or about 50 MPa to about 75 MPa, or within a range having any two of these values as endpoints, inclusive of the endpoints. In some embodiments, the protein polyurethane alloy can have a Young's modulus ranging from about 75 MPa to about 450 MPa. In some embodiments, the protein polyurethane alloy can have a Young's modulus greater than about 450 MPa. For example, the protein polyurethane alloy can have a Young's modulus ranging from about 450 MPa to about 580 MPa.

In some embodiments, the soy protein polyurethane alloy can have a Young's modulus ranging from about 90 MPa to about 400 MPa, including subranges. For example, in some embodiments, the soy protein polyurethane alloy can have a Young's modulus ranging from about 90 MPa to about 400 MPa, about 100 MPa to about 400 MPa, about 150 MPa to about 400 MPa, about 200 MPa to about 400 MPa, about 250 MPa to about 400 MPa, about 300 MPa to about 400 MPa, about 350 MPa to about 400 MPa, about 90 MPa to about 350 MPa, about 90 MPa to about 300 MPa, about 90 MPa to about 250 MPa, about 90 MPa to about 200 MPa, about 90 MPa to about 150 MPa, or about 90 MPa to about 100 MPa, or within a range having any two of these values as endpoints, inclusive of the endpoints.

In some embodiments, the polyurethane in the absence of protein can have a Young's modulus of about 10 MPa or more. In some embodiments, the polyurethane in the absence of protein can have a Young's modulus ranging from about 10 MPa to about 600 MPa, including subranges. For example, in some embodiments, the polyurethane in the absence of protein can have a Young's modulus ranging from about 10 MPa to about 600 MPa, about 10 MPa to about 500 MPa, about 10 MPa to about 400 MPa, about 10 MPa to about 300 MPa, about 10 MPa to about 200 MPa, about 10 MPa to about 100 MPa, or about 10 MPa to about 50 MPa, or within a range having any two of these values as endpoints, inclusive of the endpoints. In some embodiments, the polyurethane in the absence of protein can have a Young's modulus ranging from about 50 MPa to about 100 MPa.

In some embodiments, the protein polyurethane alloy can comprise a polyurethane having a moisture vapor transmission rate in the absence of the protein. That same protein polyurethane alloy can have a moisture vapor transmission rate about 20% or more greater than the moisture vapor transmission rate in the absence of the protein. In some embodiments, the protein polyurethane alloy can have a moisture vapor transmission rate about 20% to about 600% greater than the moisture vapor transmission rate of the polyurethane in the absence of protein. This relative percent increase in moisture vapor transmission rate can be referred to as “% Delta MVTR.” In some embodiments, % Delta MVTR can be about 20% or more. In some embodiments, % Delta MVTR can range from about 20% to about 600%, about 30% to about 600%, about 40% to about 600%, about 50% to about 600%, about 75% to about 600%, about 100% to about 600%, about 125% to about 600%, about 150% to about 600%, about 200% to about 600%, about 20% to about 500%, about 20% to about 400%, about 20% to about 300%, about 20% to about 200%, about 20% to about 150%, about 20% to about 125%, or about 20% to about 100%, or within a range having any two of these values as endpoints, inclusive of the endpoints.

In some embodiments, the soy protein polyurethane alloy can comprise a % Delta MVTR of about 20% or more. In some embodiments, % Delta MVTR for the soy protein polyurethane alloy can range from about 20% to about 600%, about 30% to about 600%, about 40% to about 600%, about 50% to about 600%, about 75% to about 600%, about 100% to about 600%, about 125% to about 600%, about 150% to about 600%, about 200% to about 600%, about 20% to about 500%, about 20% to about 400%, about 20% to about 300%, about 20% to about 200%, about 20% to about 150%, about 20% to about 125%, or about 20% to about 100%, or within a range having any two of these values as endpoints, inclusive of the endpoints.

In some embodiments, the protein polyurethane alloy can comprise a polyurethane having a moisture vapor transmission rate in the absence of protein. That same protein polyurethane alloy can comprise a moisture vapor transmission rate ranging from about 30 g/m²/24 hr to about 500 g/m²/24 hr greater than the moisture vapor transmission rate of the polyurethane in the absence of protein. This relative increase in moisture vapor transmission rate can be referred to as “Delta MVTR.” In some embodiments, the Delta MVTR can be greater than or equal to 30 g/m²/24 hr. In some embodiments, the Delta MVTR can range from about 30 g/m²/24 hr to about 500 g/m²/24 hr, about 40 g/m²/24 hr to about 500 g/m²/24 hr, about 50 g/m²/24 hr to about 500 g/m²/24 hr, about 75 g/m²/24 hr to about 500 g/m²/24 hr, about 100 g/m²/24 hr to about 500 g/m²/24 hr, about 150 g/m²/24 hr to about 500 g/m²/24 hr, about 200 g/m²/24 hr to about 500 g/m²/24 hr, about 300 g/m²/24 hr to about 500 g/m²/24 hr, about 30 g/m²/24 hr to about 400 g/m²/24 hr, about 30 g/m²/24 hr to about 300 g/m²/24 hr, about 30 g/m²/24 hr to about 200 g/m²/24 hr, about 30 g/m²/24 hr to about 150 g/m²/24 hr, about 30 g/m²/24 hr to about 100 g/m²/24 hr, about 30 MPa to about 75 g/m²/24 hr, or about 30 g/m²/24 hr to about 50 g/m²/24 hr, or within a range having any two of these values as endpoints, inclusive of the endpoints.

In some embodiments, the soy protein polyurethane alloy can comprise a Delta MVTR greater than or equal to 30 g/m²/24 hr. In some embodiments, the Delta MVTR for the soy protein polyurethane alloy can range from about 30 g/m²/24 hr to about 500 g/m²/24 hr, about 40 g/m²/24 hr to about 500 g/m²/24 hr, about 50 g/m²/24 hr to about 500 g/m²/24 hr, about 75 g/m²/24 hr to about 500 g/m²/24 hr, about 100 g/m²/24 hr to about 500 g/m²/24 hr, about 150 g/m²/24 hr to about 500 g/m²/24 hr, about 200 g/m²/24 hr to about 500 g/m²/24 hr, about 300 g/m²/24 hr to about 500 g/m²/24 hr, about 30 g/m²/24 hr to about 400 g/m²/24 hr, about 30 g/m²/24 hr to about 300 g/m²/24 hr, about 30 g/m²/24 hr to about 200 g/m²/24 hr, about 30 g/m²/24 hr to about 150 g/m²/24 hr, about 30 g/m²/24 hr to about 100 g/m²/24 hr, about 30 MPa to about 75 g/m²/24 hr, or about 30 g/m²/24 hr to about 50 g/m²/24 hr, or within a range having any two of these values as endpoints, inclusive of the endpoints.

In some embodiments, the protein polyurethane alloy can comprise a moisture vapor transmission rate ranging from about 30 g/m²/24 hr to about 1000 g/m²/24 hr, including subranges. For example, in some embodiments, the protein polyurethane alloy can comprise a moisture vapor transmission rate ranging from about 30 g/m²/24 hr to about 1000 g/m²/24 hr, about 60 g/m²/24 hr to about 1000 g/m²/24 hr, about 100 g/m²/24 hr to about 1000 g/m²/24 hr, about 200 g/m²/24 hr to about 1000 g/m²/24 hr, about 250 g/m²/24 hr to about 1000 g/m²/24 hr, about 300 g/m²/24 hr to about 1000 g/m²/24 hr, about 400 g/m²/24 hr to about 1000 g/m²/24 hr, about 500 g/m²/24 hr to about 1000 g/m²/24 hr, about 30 g/m²/24 hr to about 900 g/m²/24 hr, about 30 g/m²/24 hr to about 800 g/m²/24 hr, about 30 g/m²/24 hr to about 700 g/m²/24 hr, about 30 g/m²/24 hr to about 600 g/m²/24 hr, about 30 g/m²/24 hr to about 500 g/m²/24 hr, about 30 g/m²/24 hr to about 400 g/m²/24 hr, about 30 g/m²/24 hr to about 300 g/m²/24 hr, about 30 g/m²/24 hr to about 250 g/m²/24 hr, about 30 g/m²/24 hr to about 200 g/m²/24 hr, or about 30 g/m²/24 hr to about 100 g/m²/24 hr, or within a range having any two of these values as endpoints, inclusive of the endpoints. In some embodiments, the protein polyurethane alloy can comprise a moisture vapor transmission rate of greater than or equal to about 250 g/m²/24 hr. For example, in some embodiments, the protein polyurethane alloy can comprise a moisture vapor transmission rate ranging from about 250 g/m²/24 hr to about 1000 g/m²/24 hr, about 250 g/m²/24 hr to about 700 g/m²/24 hr, or about 250 g/m²/24 hr to about 500 g/m²/24 hr.

In some embodiments, the soy protein polyurethane alloy can comprise a moisture vapor transmission rate ranging from about 30 g/m²/24 hr to about 1000 g/m²/24 hr, including subranges. For example, in some embodiments, the soy protein polyurethane alloy can comprise a moisture vapor transmission rate ranging from about 30 g/m²/24 hr to about 1000 g/m²/24 hr, about 60 g/m²/24 hr to about 1000 g/m²/24 hr, about 100 g/m²/24 hr to about 1000 g/m²/24 hr, about 200 g/m²/24 hr to about 1000 g/m²/24 hr, about 250 g/m²/24 hr to about 1000 g/m²/24 hr, about 300 g/m²/24 hr to about 1000 g/m²/24 hr, about 400 g/m²/24 hr to about 1000 g/m²/24 hr, about 500 g/m²/24 hr to about 1000 g/m²/24 hr, about 30 g/m²/24 hr to about 900 g/m²/24 hr, about 30 g/m²/24 hr to about 800 g/m²/24 hr, about 30 g/m²/24 hr to about 700 g/m²/24 hr, about 30 g/m²/24 hr to about 600 g/m²/24 hr, about 30 g/m²/24 hr to about 500 g/m²/24 hr, about 30 g/m²/24 hr to about 400 g/m²/24 hr, about 30 g/m²/24 hr to about 300 g/m²/24 hr, about 30 g/m²/24 hr to about 250 g/m²/24 hr, about 30 g/m²/24 hr to about 200 g/m²/24 hr, or about 30 g/m²/24 hr to about 100 g/m²/24 hr, or within a range having any two of these values as endpoints, inclusive of the endpoints. In some embodiments, the soy protein polyurethane alloy can comprise a moisture vapor transmission rate of greater than or equal to about 250 g/m²/24 hr. For example, in some embodiments, the soy protein polyurethane alloy can comprise a moisture vapor transmission rate ranging from about 250 g/m²/24 hr to about 1000 g/m²/24 hr, about 250 g/m²/24 hr to about 700 g/m²/24 hr, or about 250 g/m²/24 hr to about 500 g/m²/24 hr.

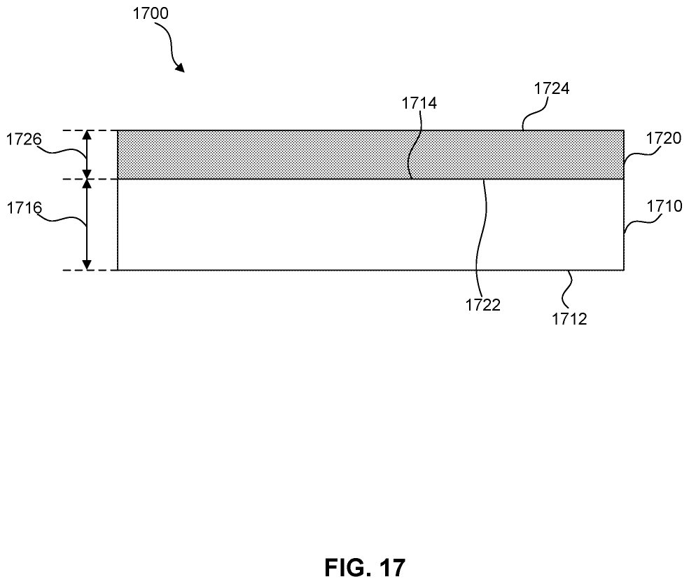

FIG. 17 shows a layered material 1700 according to some embodiments. Layered material 1700 includes a polyurethane protein alloy layer 1720 attached to a substrate layer 1710. Polyurethane protein alloy layer 1720 can be directly attached to a surface of substrate layer 1710 or attached to a surface of substrate layer 1710 via an intermediate layer, for example an adhesive layer. Direct attachment can be achieved using, for example, a thermal bonding process or a stitching. Polyurethane protein alloy layer 1720 can be referred to as a “first polyurethane protein alloy layer.”

Polyurethane protein alloy layer 1720 can include one or more types of protein and one or more polyurethanes. In some embodiments, polyurethane protein alloy layer 1720 can include one or more proteins dissolved within one or more polyurethanes. In some embodiments, polyurethane protein alloy layer 1720 can be transparent. The transparency of a polyurethane protein alloy layer is evaluated before dying or otherwise coloring a polyurethane protein alloy layer.

A transparent protein polyurethane alloy layer can provide unique characteristics for a layered material. For example, compared to a non-transparent layer, a transparent protein polyurethane alloy layer can provide unique depth of color when dyed. Likewise, a transparent protein polyurethane alloy layer can provide its mechanical properties to a layered material without significantly influencing the aesthetic properties of the material.

Protein polyurethane alloy layer 1720 includes a bottom surface 1722, a top surface 1724, and thickness 1726 measured between bottom surface 1722 and top surface 1724. In some embodiments, thickness 1726 can range from about 25 microns to about 400 microns (micrometers, μm), including subranges. For example, thickness 1726 can be about 25 microns, about 50 microns, about 100 microns, about 125 microns, about 150 microns, about 175 microns, about 200 microns, about 250 microns, about 300 microns, about 350 microns, or about 400 microns, or within a range having any two of these values as endpoints, inclusive of the endpoints. In some embodiments, thickness 1726 can range from about 50 microns to about 350 microns, about 75 microns to about 300 microns, about 100 microns to about 250 microns, about 125 microns to about 200 microns, or about 150 microns to about 175 microns.

Protein polyurethane alloy layer 1720 can have a dry weight, measured in grams per square meter (gsm, g/m²), ranging from about 25 g/m² to about 125 g/m², including subranges. For example, protein polyurethane alloy layer 1720 can have a dry weight of about 25 g/m², about 50 g/m², about 75 g/m², about 100 g/m², or about 125 g/m², or within a range having any two of these values as endpoints, inclusive of the endpoints. In some embodiments, protein polyurethane alloy layer 1720 can have a dry weight ranging from about 25 g/m² to about 125 g/m², about 25 g/m² to about 100 g/m², or about 50 g/m² to about 100 g/m².

Unless specified otherwise, the dry weight of a layer is measured during the process of making a material using the following method. First, before applying the layer in question to the material, a first sample (about 10 centimeters in diameter) of the material is cut, and the weight and dimensions are measured to calculate a first dry weight. If a sacrificial layer is present, it is removed before measuring the weight and dimensions. Second, after applying and drying the layer in question, a second sample of the same size is cut from the material, and the weight and dimensions are measured to calculate a second dry weight. If a sacrificial layer is present, it is removed before measuring the weight and dimensions. Third, the first dry weight is subtracted from the second dry weight to obtain the dry weight of the layer in question. All the weight and dimension measurements are performed at the same humidity level, typically the humidity level of the manufacturing environment in which the material is made. For purposes of calculating a dry weight, three separate dry weight tests are performed, and the average dry weight is reported as the dry weight of the layer.

In some embodiments, protein polyurethane alloy layer 1720 can be a non-foamed layer. A “non-foamed” layer means a layer having a density, measured in the percent void space for the layer, of 5% void space or less, for example 0% void space to 5% void space. In some embodiments, protein polyurethane alloy layer 1720 can be a foamed layer. In such embodiments, protein polyurethane alloy layer 1720 can have a density, measured in the percent void space for layer 1720, ranging from about 5% void space to about 70% void space, including subranges. For example, protein polyurethane alloy layer 1720 can have about 5% void space, about 10% void space, about 20% void space, about 30% void space, about 35% void space, about 40% void space, about 45% void space, about 50% void space, about 55% void space, about 60% void space, about 65% void space, or about 70% void space, or within a range having any two of these values as endpoints, inclusive of the endpoints. In some embodiments, protein polyurethane alloy layer 1720 can have a percent void space ranging from about 10% to about 65%, about 20% to about 60%, about 30% to about 55%, about 35% to about 50%, or about 40% to about 45%.

A percent void space (which can also be referred to as a “percent porosity”) can be measured by image analysis of a cross-section of a layer or by measuring the bulk density of sample of a layer using a pycnometer. Unless specified otherwise, a percent void space reported herein is measured by image analysis of a cross-section of a layer. The images are analyzed using ImageJ software (or equivalent software) at 37× magnification. The ImageJ software uses a trainable Weka segmentation classifier to calculate the percent void space in the layer. For purposes of calculating a percent void space, three to five separate images of a cross-section are evaluated, and the average percent void space is reported as the percent void space for the layer. In some embodiments, protein polyurethane alloy layer 1720 can include one or more foaming agents and/or foam stabilizers. Suitable foaming agents and foam stabilizers include those discussed herein for layers 1730 and 1740.

Substrate layer 1710 includes a bottom surface 1712, a top surface 1714, and a thickness 1716 measured between bottom surface 1712 and top surface 1714. In some embodiments, thickness 1716 can range from about 50 microns to about 1000 microns, including subranges. For example, thickness 1716 can be about 50 microns, about 100 microns, about 150 microns, about 200 microns, about 250 microns, about 300 microns, about 350 microns, about 400 microns, about 500 microns, about 600 microns, about 700 microns, about 800 microns, about 900 microns, or about 1000 microns, or within a range having any two of these values as endpoints, inclusive of the endpoints. In some embodiments, thickness 1716 can range from about 100 microns to about 900 microns, about 150 microns to about 800 microns, about 200 microns to about 700 microns, about 250 microns to about 600 microns, about 300 microns to about 500 microns, or about 350 microns to about 400 microns.

Substrate layer 1710 can have a dry weight, measured in grams per square meter (g/m²), ranging from about 50 g/m² to about 600 g/m², including subranges. For example, substrate layer 110 can have a dry weight of about 50 g/m², about 75 g/m², about 100 g/m², about 125 g/m², about 150 g/m², about 175 g/m², about 200 g/m², about 300 g/m², about 400 g/m², about 500 g/m², or about 600 g/m², or within a range having any two of these values as endpoints. In some embodiments, substrate layer 1710 can have a dry weight ranging from about 75 g/m² to about 500 g/m², about 100 g/m² to about 400 g/m², about 125 g/m² to about 300 g/m², about 150 g/m² to about 200 g/m², or about 175 g/m² to about 200 g/m².

Substrate layer 1710 can include one or more textile layers. The one or more textile layers can be, for example, a woven layer, a non-woven layer, a knit layer, a mesh fabric layer, or a leather layer. The one or more textile layer can be comprised of recycled or virgin fibers, filaments or yarns. In some embodiments, substrate layer 1710 can be, or can include, a polyester knit layer, a polyester cotton spandex blend knit layer, or a suede layer. In some embodiments, substrate layer 1710 can be made from one or more natural fibers, for example fibers made from cotton, linen, silk, wool, kenaf, flax, cashmere, angora, bamboo, bast, hemp, soya, seacell, milk or milk proteins, spider silk, chitosan, mycelium, cellulose including bacterial cellulose, or wood. Mycelium is the vegetative part of a fungus or fungus-like bacterial colony, composed of a mass of branching, thread-like hyphae. Fungi are composed primarily of a cell wall that is constantly being extended at the apex of the hyphae. Unlike the cell wall of a plant, which is composed primarily of cellulose, or the structural component of an animal cell, which relies on collagen, the structural oligosaccharides of the cell wall of fungi rely primarily on chitin and beta glucan. Chitin is a strong, hard substance, also found in the exoskeletons of arthropods.

In some embodiments, substrate layer 1710 can be made from one or more synthetic fibers, for example fibers made from polyesters, nylons, aromatic polyamides, polyolefin fibers such as polyethylene, polypropylene, rayon, lyocell, viscose, antimicrobial yarn (A.M.Y.), Sorbtek, nylon, elastomers such as LYCRA®, spandex, or ELASTANE®, polyester-polyurethane copolymers, aramids, carbon including carbon fibers and fullerenes, glass, silicon, minerals, metals or metal alloys including those containing iron, steel, lead, gold, silver, platinum, copper, zinc, and titanium, or mixtures thereof.

In some embodiments, non-woven substrate layer 1710 can be a staple non-woven, melt-blown non-woven, spunlaid non-woven, flashspun non-woven, or a combination thereof. In some embodiments, non-woven substrate layer 1710 can be made by carding, can be air-laid, or can be wet-laid. In some embodiments, the carded, air-laid, or wet-laid substrates can be bonded by, for example, needle-punch, hydroentanglement, lamination, or thermal bonding. In some embodiments, non-woven substrate layer 1710 can include one or more natural fibers, for example fibers made from cotton, linen, silk, wool, kenaf, flax, cashmere, angora, bamboo, bast, hemp, soya, seacell, milk or milk proteins, spider silk, chitosan, mycelium, cellulose including bacterial cellulose, or wood.

In some embodiments, non-woven substrate layer 1710 can include polymeric fibers with functional particles in the polymer. Exemplary functional particles include ceramic particles mixed in a polymeric resin during an extrusion process for making the polymeric fibers. Such ceramic particles can provide the polymeric fibers with desirable heat dissipation and flame resistance properties. In some embodiments, non-woven substrate layer 1710 can include fibers made of fruit pulp (e.g., grape pulp or apple pulp) or pineapple fibers. In some embodiments, non-woven substrate layer 1710 can include fibers made from recycled materials, for example recycled plastics. In some embodiments, non-woven substrate layer 1710 can include algae fibers. In some embodiments, a non-woven substrate layer 1710 can include cork fibers.

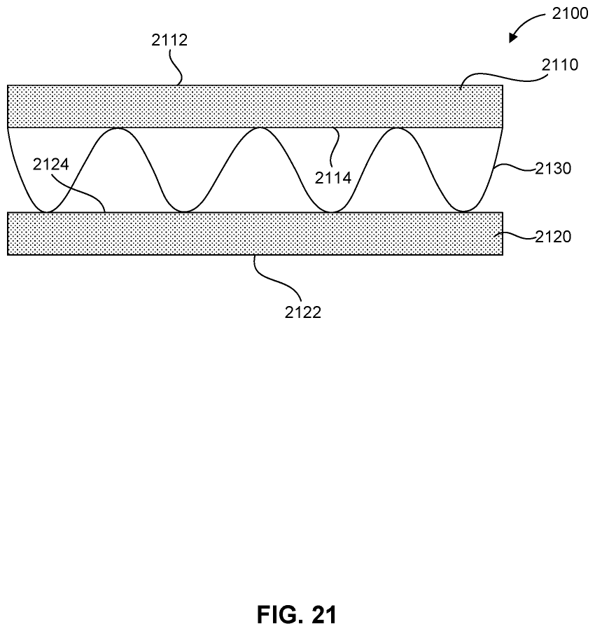

In some embodiments, substrate layer 1710 can be, or can include, a spacer fabric, for example spacer fabric 2100, shown in FIG. 21. Spacer fabric 2100 includes a first fabric layer 2110 and a second fabric layer 2120 connected by one or more spacer yarns 2130. Spacer yarn(s) 2130 are disposed between first fabric layer 2110 and second fabric layer 2120 and define a distance between an interior surface 2114 of first fabric layer 2110 and an interior surface 2124 of second fabric layer 2120. Exterior surface 2112 of first fabric layer 2110 and exterior surface 2122 of second fabric layer 2120 can define top surface 1714 and bottom surface 1712 of substrate layer 1710, respectively.

First fabric layer 2110 and second fabric layer 2120 can include one or more layers of fabric material. In some embodiments, first fabric layer 2110 and second fabric layer 2120 can include one or more textile layers made from staple fibers, filaments, or mixtures thereof. As used herein, “staple fibers” are fibers having a short length, between about 0.2 mm to about 5 centimeters (cm). Staple fibers can be naturally occurring or can be cut filaments. As used herein, “filaments” are long fibers having a length of 5 cm or more. In some embodiments, first fabric layer 2110 and second fabric layer 2120 can include one or more layers of a woven material or a knitted material. In some embodiments, exterior surface 2112 of first fabric layer 2110 can be defined by a woven fabric layer or a knitted fabric layer. In some embodiments, exterior surface 2122 of second fabric layer 2120 can be defined by a woven fabric layer or a knitted fabric layer.

In some embodiments, first fabric layer 2110 and second fabric layer 2120 can be made from one or more natural fibers, for example fibers made from cotton, linen, silk, wool, kenaf, flax, cashmere, angora, bamboo, bast, hemp, soya, seacell, milk or milk proteins, spider silk, chitosan, mycelium, cellulose including bacterial cellulose, or wood. In some embodiments, first fabric layer 2110 and second fabric layer 2120 can be made from one or more synthetic fibers, for example fibers made from polyesters, nylons, aromatic polyamides, polyolefin fibers such as polyethylene, polypropylene, rayon, lyocell, viscose, antimicrobial yarn (A.M.Y.), Sorbtek, nylon, elastomers such as LYCRA®, spandex, or ELASTANE®, polyester-polyurethane copolymers, aramids, carbon including carbon fibers and fullerenes, glass, silicon, minerals, metals or metal alloys including those containing iron, steel, lead, gold, silver, platinum, copper, zinc, and titanium, or mixtures thereof. Spacer yarn(s) 2130 can include mono-filament yarn(s) composed of any of the natural or synthetic materials listed above for first fabric layer 2110 and second fabric layer 2120.

In some embodiments, substrate layer 1710 can be colored with a coloring agent. In some embodiments the coloring agent can be a dye, for example an acid dye, a fiber reactive dye, a direct dye, a sulfur dye, a basic dye, or a reactive dye. In some embodiments, the coloring agent can be pigment, for example a lake pigment. In some embodiments, a first coloring agent can be incorporated into one or more protein polyurethane alloy layers and a second coloring agent can be incorporated into substrate layer 1710, depending on the desired aesthetic of a layered material.

A fiber reactive dye includes one or more chromophores that contain pendant groups capable of forming covalent bonds with nucleophilic sites in fibrous, cellulosic substrates in the presence of an alkaline pH and raised temperature. These dyes can achieve high wash fastness and a wide range of brilliant shades. Exemplary fiber reactive dyes, include but are not limited to, sulphatoethylsulphone (Remazol), triazine, vinylsulphone, and acrylamido dyes. These dyes can dye protein fibers such as silk, wool and nylon by reacting with fiber nucleophiles via a Michael addition. Direct dyes are anionic dyes capable of dying cellulosic or protein fibers. In the presence of an electrolyte such as sodium chloride or sodium sulfate, near boiling point, these dyes can have an affinity to cellulose. Exemplary direct dyes include, but are not limited to, azo, stilbene, phthalocyanine, and dioxazine.

In some embodiments, layered material 1700 can include a protein polyurethane alloy layer 1720 attached to top surface 1714 of substrate layer 1710. In some embodiments, bottom surface 1722 of protein polyurethane alloy layer 1720 can be in direct contact with top surface 1714 of substrate layer 1710. In some embodiments, bottom surface 1722 of protein polyurethane alloy layer 1720 can be attached to top surface 1714 of substrate layer 1710 via an adhesive layer (e.g., adhesive layer 1750). In some embodiments, layered material 1700 can include a protein polyurethane alloy layer 1720 attached to bottom surface 1712 of substrate layer 1710. In some embodiments, top surface 1724 of protein polyurethane alloy layer 1720 can be in direct contact with bottom surface 1712 of substrate layer 1710. In some embodiments, top surface 1724 of protein polyurethane alloy layer 1720 can be attached to bottom surface 1712 of substrate layer 1710 via an adhesive layer (e.g., adhesive layer 1750). In some embodiments, layered material 1700 can include a protein polyurethane alloy layer 1720 attached to top surface 1714 of substrate layer 1710 and a protein polyurethane alloy layer 1720 attached to bottom surface 1712 of substrate layer 1710. In such embodiments, layered material 1700 includes protein polyurethane alloy layers 1720 disposed on opposing surfaces of substrate layer 1710.

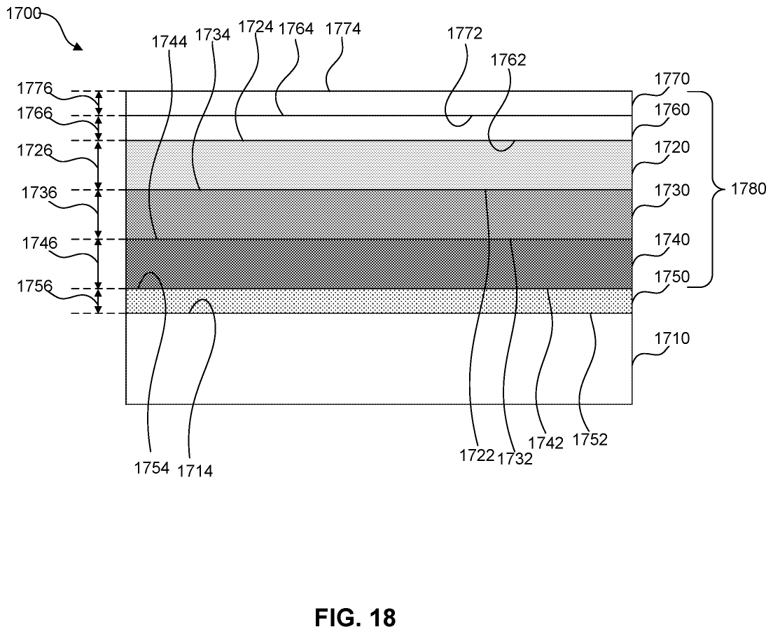

In some embodiments, as shown for example in FIG. 18, layered material 1700 can include a second protein polyurethane alloy layer 1730 disposed between protein polyurethane alloy layer 1720 and substrate layer 1710. In such embodiments, second protein polyurethane alloy layer 1730 is attached to protein polyurethane alloy layer 1720. In some embodiments, bottom surface 1722 of protein polyurethane alloy layer 1720 can be in direct contact with a top surface 1734 of second protein polyurethane alloy layer 1730.

Second protein polyurethane alloy layer 1730 includes a bottom surface 1732, top surface 1734, and a thickness 1736 measured between bottom surface 1732 and top surface 1734. In some embodiments, thickness 1736 can range from about 25 microns to about 600 microns, including subranges. For example, thickness 1736 can be about 25 microns, about 50 microns, about 100 microns, about 125 microns, about 150 microns, about 175 microns, about 200 microns, about 225 microns, about 250 microns, about 275 microns, about 300 microns, about 400 microns, about 500 microns, or about 600 microns, or within a range having any two of these values as endpoints, inclusive of the endpoints. In some embodiments, thickness 1736 can range from about 50 microns to about 500 microns, about 75 microns to about 400 microns, about 100 microns to about 300 microns, about 125 microns to about 275 microns, about 150 microns to about 250 microns, about 175 microns to about 225 microns, or about 200 microns to about 225 microns. In some embodiments, thickness 1736 can be greater than thickness 1726. In some embodiments, thickness 1736 can be less than thickness 1726. In some embodiments, thickness 1736 can be greater than or less than thickness 1726 by 5 microns or more.

Second protein polyurethane alloy layer 1730 can have a dry weight, measured in grams per square meter (g/m²), ranging from about 30 g/m² to about 600 g/m², including subranges. For example, second protein polyurethane alloy layer 1730 can have a dry weight of about 30 g/m², about 40 g/m², about 60 g/m², about 80 g/m², about 100 g/m², about 120 g/m², about 140 g/m², about 150 g/m², about 200 g/m², about 300 g/m², about 400 g/m², about 500 g/m², or about 600 g/m², or within a range having any two of these values as endpoints, inclusive of the endpoints. In some embodiments, second protein polyurethane alloy layer 1730 can have a dry weight ranging from about 40 g/m² to about 500 g/m², about 60 g/m² to about 400 g/m², about 80 g/m² to about 300 g/m², about 100 g/m² to about 200 g/m², about 120 g/m² to about 150 g/m², or about 140 g/m² to about 150 g/m². In some embodiments, protein polyurethane alloy layer 1720 can have a first weight and second protein polyurethane alloy layer 1730 can have a second weight, and the first weight can be less than the second weight. In some embodiments, the first weight can be less than the second weight by 5 g/m² or more.

In some embodiments, second protein polyurethane alloy layer 1730 can include a foaming agent. In some embodiments, second protein polyurethane alloy layer 1730 can include a foam stabilizer. The foaming agent or foam stabilizer can facilitate the formation of voids in second protein polyurethane alloy layer 1730 during blending of second protein polyurethane alloy layer 1730. Suitable foam stabilizers include, but are not limited to, HeiQ Chemtex 2216-T (a stabilized blend of nonionic and anionic surfactants), HeiQ Chemtex 2241-A (a modified HEUR (hydrophobically-modified ethylene oxide urethane) thickener), HeiQ Chemtex 2243 (a non-ionic silicone dispersion), or HeiQ Chemtex 2317 (a stabilized blend of nonionic and anionic surfactants) foam stabilizers available from HeiQ Chemtex. When used, a foam stabilizer serves to stabilize mechanically created foam (air voids). The mechanically created foam may be created by, for example, a rotor and/or compressed air. When used, a foaming agent can create foam (air voids) within a layer by a chemical reaction and/or via heat generation within the layer.

In some embodiments, second protein polyurethane alloy layer 1730 can be referred to as a “foamed protein polyurethane alloy layer” because either (i) layer 1730 includes one or more foaming agents or foam stabilizers and/or (ii) layer 1730 includes a density less than protein polyurethane alloy layer 1720.

Second protein polyurethane alloy layer 1730 can have a density, measured in the percent void space for layer 1730, ranging from about 5% void space to about 70% void space, including subranges. For example, second protein polyurethane alloy layer 1730 can have about 5% void space, about 10% void space, about 20% void space, about 30% void space, about 35% void space, about 40% void space, about 45% void space, about 50% void space, about 55% void space, about 60% void space, about 65% void space, or about 70% void space, or within a range having any two of these values as endpoints, inclusive of the endpoints. In some embodiments, second protein polyurethane alloy layer 1730 can have a percent void space ranging from about 10% to about 65%, about 20% to about 60%, about 30% to about 55%, about 35%, to about 50%, or about 40% to about 45%. In some embodiments, protein polyurethane alloy layer 1720 can have a first density and second protein polyurethane alloy layer 1730 can have a second density, and the first density can be greater than the second density. In some embodiments, the first density can be greater than the second density by 5% void space or more.

Layering a plurality of protein polyurethane alloy layers having different weights and/or densities can be used to tailor the material properties of a layered material. For example, layers having lighter weights and/or densities can be used to increase the softness and/or flexibility of a layered material. On the other hand, layers having high weights and/or densities can increase the strength of the layered material. Additionally, using one or more layers having relatively lighter weight and/or density can increase the ease in which cutting, stitching, and/or shaping process steps (e.g., skyving) can be performed on a layered material. Layering a plurality of protein polyurethane alloy layers gives lot of freedom in designing of a material.

In some embodiments, second protein polyurethane alloy layer 1730 can further include, in addition to any other components that may be present, such as a foaming agent, a foam stabilizer, or one or more coloring agents. The coloring agent type and content for second protein polyurethane alloy layer 1730 can be any of the types and amounts described herein for protein polyurethane alloy layer 1720. In some embodiments, second protein polyurethane alloy layer 1730 can be free or substantially free of a coloring agent.

In some embodiments, as shown for example in FIG. 18, layered material 1700 can include a third protein polyurethane alloy layer 1740 disposed between second protein polyurethane alloy layer 1730 and substrate layer 1710. In such embodiments, third protein polyurethane alloy layer 1740 is attached to second protein polyurethane alloy layer 1730. In some embodiments, bottom surface 1732 of second protein polyurethane alloy layer 1730 can be in direct contact with a top surface 1744 of third protein polyurethane alloy layer 1740.

Third protein polyurethane alloy layer 1740 includes a bottom surface 1742, top surface 1744, and a thickness 1746 measured between bottom surface 1742 and top surface 1744. In some embodiments, thickness 1746 can range from about 25 microns to about 600 microns, including subranges. For example, thickness 1746 can be about 25 microns, about 50 microns, about 100 microns, about 125 microns, about 150 microns, about 175 microns, about 200 microns, about 225 microns, about 250 microns, about 275 microns, about 300 microns, about 400 microns, about 500 microns, or about 600 microns, or within a range having any two of these values as endpoints, inclusive of the endpoints. In some embodiments, thickness 1746 can range from about 50 microns to about 500 microns, about 75 microns to about 400 microns, about 100 microns to about 300 microns, about 125 microns to about 275 microns, about 150 microns to about 250 microns, about 175 microns to about 225 microns, or about 175 microns to about 200 microns. In some embodiments, thickness 1746 can be greater than thickness 1726. In some embodiments, thickness 1746 can be less than thickness 1726. In some embodiments, thickness 1746 can be greater than or less than thickness 1726 by 5 microns or more. In some embodiments, thickness 1746 can be the same as thickness 1736. In some embodiments, thickness 1746 can be greater than or less than thickness 1736. In some embodiments, thickness 1746 can be greater than or less than thickness 1736 by 5 microns or more.

Third protein polyurethane alloy layer 1740 can have a dry weight, measured in grams per square meter (g/m²), ranging from about 30 g/m² to about 600 g/m², including subranges. For example, third protein polyurethane alloy layer 1740 can have a dry weight of about 30 g/m², about 40 g/m², about 60 g/m², about 80 g/m², about 100 g/m², about 120 g/m², about 140 g/m², about 150 g/m², about 200 g/m², about 300 g/m², about 400 g/m², about 500 g/m², or about 600 g/m², or within a range having any two of these values as endpoints, inclusive of the endpoints. In some embodiments, third protein polyurethane alloy layer 1740 can have a dry weight ranging from about 40 g/m² to about 500 g/m², about 60 g/m² to about 400 g/m², about 80 g/m² to about 300 g/m², about 100 g/m² to about 200 g/m², about 120 g/m² to about 150 g/m², or about 120 g/m² to about 140 g/m². In some embodiments, protein polyurethane alloy layer 1720 can have a first weight and third protein polyurethane alloy layer 1740 can have a third weight, and the first weight can be less than the third weight. In some embodiments, protein polyurethane alloy layer 1720 can have a first weight, second protein polyurethane alloy layer 1730 can have a second weight, and third protein polyurethane alloy layer 1740 can have a third weight, and the first weight can be less than the second weight and the third weight. In some embodiments, the first weight can be less than the second weight and/or the third weight by 5 g/m² or more.

In some embodiments, third protein polyurethane alloy layer 1740 can include a foaming agent. In some embodiments, third protein polyurethane alloy layer 1740 can include a foam stabilizer. The foaming agent and/or foam stabilizer can facilitate the formation of voids in third protein polyurethane alloy layer 1740 during blending of third protein polyurethane alloy layer 1740. Suitable foaming agents include, but are not limited to, HeiQ Chemtex 2216-T (a stabilized blend of nonionic and anionic surfactants), HeiQ Chemtex 2241-A (a modified HEUR (hydrophobically-modified ethylene oxide urethane) thickener), HeiQ Chemtex 2243 (a non-ionic silicone dispersion), or HeiQ Chemtex 2317 (a stabilized blend of nonionic and anionic surfactants) foam stabilizers available from HeiQ Chemtex.

In some embodiments, third protein polyurethane alloy layer 1740 can be referred to as a “foamed protein polyurethane alloy layer” because either (i) layer 1740 includes one or more foaming agents or foam stabilizers and/or (ii) layer 1740 includes a density less than protein polyurethane alloy layer 120.

Third protein polyurethane alloy layer 1740 can have a density, measured in the percent void space for layer 1740, ranging from about 5% void space to about 70% void space, including subranges. For example, third protein polyurethane alloy layer 1740 can have about 5% void space, about 10% void space, about 20% void space, about 30% void space, about 35% void space, about 40% void space, about 45% void space, about 50% void space, about 55% void space, about 60% void space, about 65% void space, or about 70% void space, or within a range having any two of these values as endpoints, inclusive of the endpoints. In some embodiments, third protein polyurethane alloy layer 1740 can have a percent void space ranging from about 10% to about 65%, about 20% to about 60%, about 30% to about 55%, about 35% to about 50%, or about 40% to about 45%. In some embodiments, protein polyurethane alloy layer 1720 can have a first density and third protein polyurethane alloy layer 1740 can have a third density, and the first density can be greater than the third density. In some embodiments, protein polyurethane alloy layer 1720 can have a first density, second protein polyurethane alloy layer 1730 can have a second density, and third protein polyurethane alloy layer 1740 can have a third density, and the first density can be greater than the second density and third density. In some embodiments, the first density can be greater than the second density and/or the third density by 5% void space or more.

In some embodiments, layered material 1700 can include a plurality of protein polyurethane alloy layers having the same protein and polyurethane. In some embodiments, layered material 1700 can include a plurality of protein polyurethane alloy layers and the different layers can have a different protein and/or a different polyurethane.

In some embodiments, third protein polyurethane alloy layer 1740 can further include, in addition to any other components that may be present, such as a foaming agent, a foam stabilizer, one or more coloring agents. The coloring agent type and content for third protein polyurethane alloy layer 1740 can be any of the types and amounts described herein for protein polyurethane alloy layer 1720. In some embodiments, third protein polyurethane alloy layer 1740 can be free or substantially free of a coloring agent.

In some embodiments, and as shown for example in FIG. 18, layered material 1700 can include a basecoat layer 1760. Basecoat layer 1760 can be disposed over top surface 1724 of protein polyurethane alloy layer 1720. Basecoat layer 1760 can be directly or indirectly attached to protein polyurethane alloy layer 1720. In some embodiments, basecoat layer 1760 can be disposed on top surface 1724 of protein polyurethane alloy layer 1720. In some embodiments, a bottom surface 1762 of basecoat layer 1760 can be in direct contact with top surface 1724 of protein polyurethane alloy layer 1720.

Basecoat layer 1760 includes bottom surface 1762, a top surface 1764, and a thickness 1766 measured between bottom surface 1762 and top surface 1764. In some embodiments, thickness 1766 can range from about 20 microns to about 200 microns, including subranges. For example, thickness 1766 can be about 20 microns, about 30 microns, about 40 microns, about 50 microns, about 60 microns, about 70 microns, about 80 microns, about 90 microns, about 100 microns, about 150 microns, or about 200 microns, or within a range having any two of these values as endpoints, inclusive of the endpoints. In some embodiments, thickness 1766 can range from about 30 microns to about 150 microns, about 40 microns to about 100 microns, about 50 microns to about 90 microns, about 60 microns to about 80 microns, or about 60 microns to about 70 microns.

In embodiments including basecoat layer 1760, basecoat layer 1760 can provide one or more of the following properties for layered material 1700: (i) abrasion performance, color fastness, or hydrolytic resistance. Basecoat layer 1760 may also serve to adhere to a top-coat layer to layered material 1700 in embodiments including a top-coat layer. In some embodiments, basecoat layer 1760 can include one or more polymeric materials. Suitable materials for basecoat layer 1760 include, but are not limited to, polyether polyurethanes, polycarbonate polyurethanes, polyester polyurethanes, acrylic polymers, and cross-linkers such as isocyanate or carbodiimide. In some embodiments, layered material 1700 can include a plurality of basecoat layers 1760. In some embodiments, basecoat layer 1760 can be absent from layered material 1700.

Basecoat layer 1760 can have a dry weight, measured in grams per square meter (g/m²), ranging from about 20 g/m² to about 100 g/m², including subranges. For example, basecoat layer 1760 can have a dry weight of about 20 g/m², about 30 g/m², about 40 g/m², about 50 g/m², about 60 g/m², about 70 g/m², about 80 g/m², about 90 g/m², or about 100 g/m², or within a range having any two of these values as endpoints, inclusive of the endpoints. In some embodiments, basecoat layer 1760 can have a dry weight ranging from about 30 g/m² to about 90 g/m², about 40 g/m² to about 80 g/m², or about 50 g/m² to about 70 g/m².

In some embodiments, as shown for example in FIG. 18, layered material 1700 can include a top-coat layer 1770. Top-coat layer 1770 can be disposed over top surface 1724 of protein polyurethane alloy layer 1720. Top-coat layer 1770 can be directly or indirectly attached to protein polyurethane alloy layer 1720. In some embodiments, a bottom surface 1772 of top-coat layer 1770 can be in direct contact with top surface 1724 of protein polyurethane alloy layer 1720. In embodiments including basecoat layer 1760, top-coat layer 1770 can be disposed over top surface 1764 of basecoat layer 1760. In some embodiments, top-coat layer 1770 can be disposed on top surface 1764 of basecoat layer 1760. In some embodiments, a bottom surface 1772 of top-coat layer 1770 can be in direct contact with top surface 1764 of basecoat layer 1760.

Top-coat layer 1770 includes bottom surface 1772, a top surface 1774, and a thickness 1776 measured between bottom surface 1772 and top surface 1774. In some embodiments, thickness 1776 can range from about 10 microns to about 80 microns, including subranges. For example, thickness 1776 can be about 10 microns, about 20 microns, about 30 microns, about 40 microns, about 50 microns, about 60 microns, about 70 microns, or about 80 microns, or within a range having any two of these values as endpoints, inclusive of the endpoints. In some embodiments, thickness 1776 can range from about 20 microns to about 70 microns, about 30 microns to about 60 microns, or about 30 microns to about 50 microns.

In embodiments including top-coat layer 1770, top-coat layer 1770 can provide one or more of the following properties for layered material 1700: surface feel, stain resistance, flame resistance, gloss level, or color appearance. In some embodiments, top-coat layer 1770 can include one or more polymeric materials. Suitable materials for top-coat layer 1770 include but are not limited to, polyurethanes, acrylics, silicone-based feel agents, matte agents, and gloss agents. In some embodiments, layered material 1700 can include a plurality of top-coat layers 1770. In some embodiments, top-coat layer 1770 can be absent from layered material 1700. In some embodiments, top-coat layer 1770 can be transparent or translucent. In some embodiments, top-coat layer 1770 can include one or more dyes, one or more pigments and/or one or more reflective agents to affect appearance.

Top-coat layer 1770 can have a dry weight, measured in grams per square meter (g/m²), ranging from about 10 g/m² to about 80 g/m², including subranges. For example, top-coat layer 1770 can have a dry weight of about 10 g/m², about 20 g/m², about 30 g/m², about 40 g/m², about 50 g/m², about 60 g/m², about 70 g/m², or about 80 g/m², or within a range having any two of these values as endpoints, inclusive of the endpoints. In some embodiments, top-coat layer 1770 can have a dry weight ranging from about 20 g/m² to about 70 g/m², about 30 g/m² to about 60 g/m², or about 30 g/m² to about 50 g/m².

Together, protein polyurethane alloy layer(s) 1720, 1730, 1740, basecoat layer(s) 1760, and/or top-coat layer(s) 1770 can define a layered assembly 1780 of a layered material 1700. Layered assembly 1780 can include any number of protein polyurethane alloy layers as described herein. For example, layered assembly 1780 can include 2, 3, 4, 5, 6, 7, 8, 9, 10, 11, 12, 13, 14, 15, 16, 17, 18, 19, or 20 protein polyurethane alloy layers. In some embodiments, layered material 1700 can include a layered assembly 1780 attached to bottom surface 1712 of substrate layer 1710. Layered assembly 1780 attached to bottom surface 1712 of substrate layer 1710 can include any of the layers and materials as described herein for a layered assembly 1780 attached to top surface 1714 of substrate layer 1710. In some embodiments, layered material 1700 can include a layered assembly 1780 attached to top surface 1714 of substrate layer 1710 and a layered assembly 1780 attached to bottom surface 1712 of substrate layer 1710. In such embodiments, layered material 1700 includes layered assemblies 1780 disposed over opposing surfaces 1712 and 1714 of substrate layer 1710.

In some embodiments, a protein polyurethane alloy layer of layered material 1700 is attached to a surface of substrate layer 1710 with an adhesive layer 1750. In such embodiments, adhesive layer 1750 includes a bottom surface 1752, a top surface 1754, and a thickness 1756 measured between bottom surface 1752 and top surface 1754. In some embodiments, thickness 1756 can range from about 10 microns to about 50 microns, including subranges. For example, thickness 1756 can be about 10 microns, about 20 microns, about 30 microns, about 40 microns, or about 50 microns, or within a range having any two of these values as endpoints, inclusive of the endpoints. In some embodiments, thickness 1756 can range from about 20 microns to about 40 microns. Suitable adhesives for adhesive layer 1750 include, but are not limited to, polyurethane adhesives, hot melt adhesives, emulsion polymer adhesives, dry web adhesives, dry laminating adhesives, or wet laminating adhesives. Hauthane HD-2001 available from C. L. Hauthaway & Sons Corporation is an exemplary laminating adhesive suitable for adhesive layer 1750. Exemplary polyurethane adhesives include, but are not limited to, L-2183, L-2245, L-2255 from Hauthaway and IMPRANIL® DAH, DAA from Covestro. Exemplary dry web adhesives include, but are not limited to, 9D8D20 from Protechnic. In some embodiments, layered material 1700 does not include an adhesive layer 1750.

Adhesive layer 1750 can have a dry weight, measured in grams per square meter (g/m²), ranging from about 10 g/m² to about 50 g/m², including subranges. For example, adhesive layer 1750 can have a dry weight of about 10 g/m², about 20 g/m², about 30 g/m², about 40 g/m², or about 50 g/m², or within a range having any two of these values as endpoints, inclusive of the endpoints. In some embodiments, adhesive layer 1750 can have a dry weight ranging from about 20 g/m² to about 40 g/m².

Layered material 1700 can be made by attaching one or more protein polyurethane alloy layers, and one or more basecoat and/or top-coat layers described herein, to substrate layer 1710. In some embodiments, the layer(s) may be subsequently layered over a surface of a substrate layer. Layer(s) can be attached to either top surface 1714 and/or bottom surface 1712 of substrate layer 1710. In some embodiments, the layer(s) can be layered over a sacrificial layer that is removed after layering and before or after attaching the one or more layers to substrate layer 1710. Each protein polyurethane alloy layer of a layered material can be deposited using any suitable coating technique, including, but not limited to, knife over roll coating, gravure coating, slot die coating, multi-layer slot die coating, or curtain coating. Multi-layer slot die coating can allow simultaneous coating of multiple adjacent layers.

In some embodiments, a substrate layer 1710 can be coated with an adhesive layer 1750 and additional layers (e.g., layers 1720, 1730, 1740, 1760, and/or 1770) can be formed over adhesive layer 1750 in any appropriate order. In such embodiments, the layers can be formed over adhesive layer 1750 in the same manner as described below for method 1900 with the layers being formed over the adhesive layer 1750 rather than a sacrificial layer. In some embodiments, a blended mixture as described herein can be applied directly to a surface of a substrate layer 1710, using for example, a coating or pouring process. In such embodiments, the blended mixture can penetrate at least a portion of substrate layer 1710. After application, the blended mixture can be dried to form a protein polyurethane alloy layer (e.g., layer 1720). In some embodiments, after drying, the protein polyurethane alloy layer and the substrate layer 1710 can be heated (e.g., heat pressed) to aid in attaching the layers together. Before or after drying and/or before or after attaching the protein polyurethane alloy layer and substrate layer 1710, other layers (e.g., layers 1730, 1740, 1760, and/or 1770) can be applied over the protein polyurethane alloy layer in any appropriate order. In such embodiments, the other layers can be formed over the protein polyurethane alloy layer in the same manner as described below for method 1900 with the layers being formed over the protein polyurethane alloy layer rather than a sacrificial layer.

In some embodiments, decorative layers can be applied between layers of a layered material during manufacturing. For example, a logo, an artistic pattern, a drawing, or a symbol can be applied to a first layer before disposing another layer over the first layer. Decorative layers can be applied using, for example, screen printing, digital printing, or transfer printing.

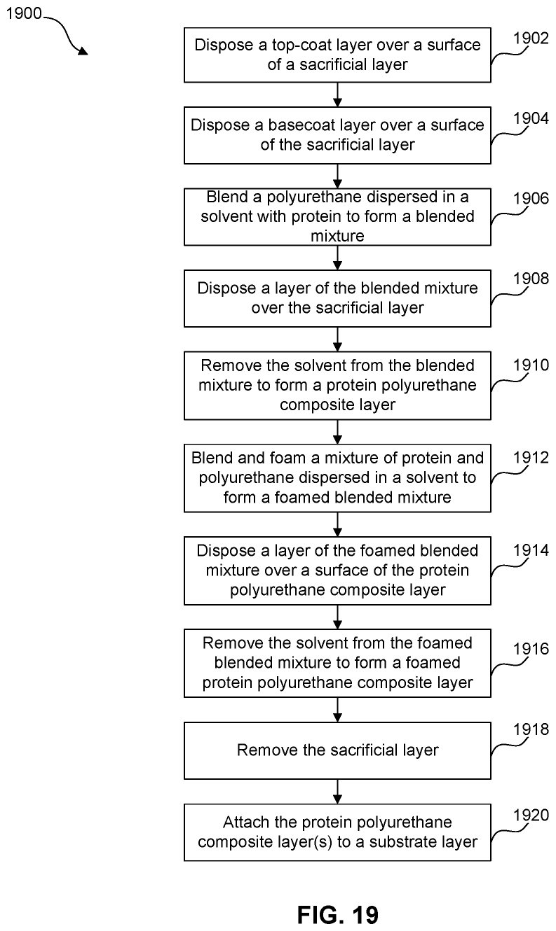

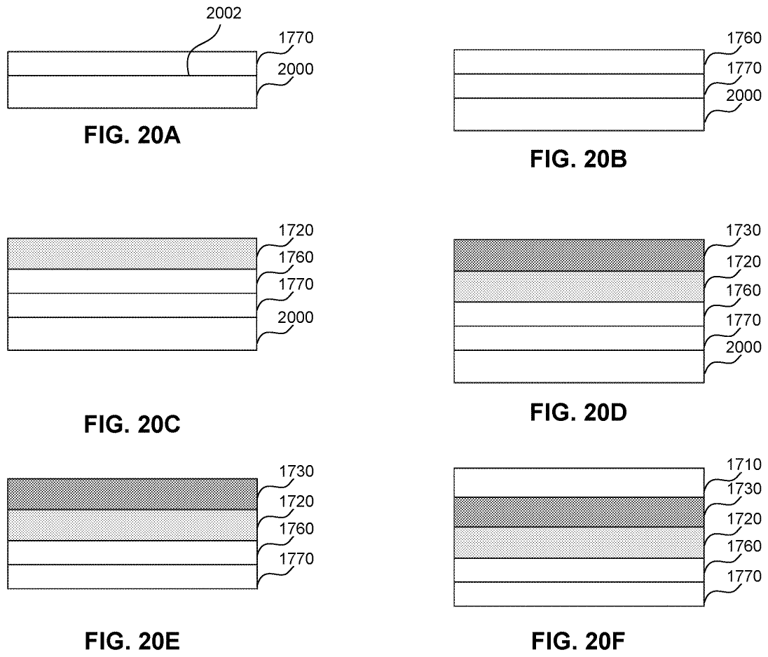

In some embodiments, the layers of a layered material can be formed over a sacrificial layer and attached to a substrate layer after formation. FIG. 19 illustrates a method 1900 for making a layered material 1700 according to some embodiments. FIGS. 20A-20F illustrate steps of method 1900. Unless stated otherwise, the steps of method 1900 need not be performed in the order set forth herein. Additionally, unless specified otherwise, the steps of method 1900 need not be performed sequentially. The steps can be performed simultaneously. As one example, method 1900 need not include a solvent removal step after the deposition of each individual protein polyurethane alloy layer; rather the solvent (for example, water) from a plurality of protein polyurethane alloy layers can be removed in a single step. Method 1900 can be used to attach layers to one or both sides of a substrate layer 1710.

In step 1902, a top-coat layer 1770 can be disposed over a top surface 2002 of a sacrificial layer 2000, as illustrated in for example FIG. 20A. Top-coat layer 1770 can be disposed over sacrificial layer 2000 using any suitable coating technique, for example, knife over roll with reverse transfer paper, spraying, or roller coating. Sacrificial layer 2000 is a layer of material that does not define a layer of layered material 1700. Rather, sacrificial layer 2000 is removed during manufacturing of layered material 1700. Sacrificial layer 2000 can be removed mechanically, such as by peeling away, or chemically, for example, by dissolving sacrificial layer 2000. In some embodiments, sacrificial layer 2000 can be a release liner. Suitable materials for sacrificial layer 2000 include but are not limited to grain texture release papers. Exemplary grain texture release papers include, release papers available from Sappi paper, for example, Matte Freeport 189, Freeport 123, or Expresso 904. In some embodiments, method 1900 does not include step 1902. That is, step 1902 is optional. In some embodiments, top-coat layer 1770 can be applied to a layered material 1700 after removing sacrificial layer 2000 in step 1918. In some embodiments, top-coat layer 1770 can be applied to a layered material 1700 after attaching protein polyurethane alloy layer(s) to a substrate layer 1710 in step 1920.

In step 1904, basecoat layer 1760 can be disposed over sacrificial layer 2000, as illustrated in for example FIG. 20B. In embodiments including top-coat layer 1770, basecoat layer 1760 can be disposed over top-coat layer 1770. Basecoat layer 1760 can disposed over sacrificial layer 2000 using any suitable coating technique, for example, knife over roll with reverse transfer paper, spraying, or roller coating. In some embodiments, method 1900 does not include step 1904. Step 1904 is optional. In some embodiments, basecoat layer 1760 can be applied to a layered material 1700 after removing sacrificial layer 2000 in step 1918. In some embodiments, basecoat layer 1760 can be applied to a layered material 1700 after attaching protein polyurethane alloy layer(s) to a substrate layer 1710 in step 1920.

In step 1906, one or more polyurethanes dispersed or dissolved in an aqueous solution can be blended with one or more proteins to form a blended mixture in the aqueous solution. In some embodiments, the one or more polyurethanes can be dispersed or dissolved in an aqueous solution before blending with protein(s). In some embodiments, the one or more polyurethanes can become dispersed or dissolved in an aqueous solution during blending with protein(s). In some embodiments, the one or more polyurethanes and the one or more proteins can be blended in a suitable vessel until a homogenous blend is formed. Suitable blending equipment includes, but is not limited to, a blender, a stand mixer, an in-line mixer, or a high shear mixer.

In some embodiments, protein(s) can be dispersed or dissolved in an aqueous solution before blending with polyurethane in step 1906. Suitable aqueous solutions include, but are not limited to, water, an aqueous alkali solution, an aqueous acid solution, an aqueous solution including an organic solvent, a urea solution, and mixtures thereof. In some embodiments, the aqueous alkali solution can be a basic solution such as a sodium hydroxide, ammonia or ammonium hydroxide solution. In some embodiments, examples of an acidic aqueous solution can be an acetic acid or hydrochloric acid (HCl) solutions. Suitable organic solvents include, but are not limited to, ethanol, isopropanol, acetone, ethyl acetate, isopropyl acetate, glycerol, and the like. In some embodiments, the protein concentration in the aqueous protein mixture can range from about 10 g/L to about 300 g/L, including subranges. For example, the protein concentration in the aqueous protein mixture can be about 10 g/L, about 20 g/L, about 30 g/L, about 40 g/L, about 50 g/L, about 60 g/L, about 70 g/L, about 80 g/L, about 90 g/L, about 100 g/L, about 150 g/L, about 200 g/L, about 250 g/L, or about 300 g/L, or within a range having any two of these values as endpoints, inclusive of the endpoints. In some embodiments, the protein concentration in the aqueous protein mixture can range from about 10 g/L to about 300 g/L, about 20 g/L to about 250 g/L, about 30 g/L to about 200 g/L, about 40 g/L to about 150 g/L, about 50 g/L to about 100 g/L, about 60 g/L to about 90 g/L, or about 70 g/L to about 80 g/L.

The amount of protein in a protein/polyurethane blend can range from about 5 wt % to about 60%, based on the weight of protein and polyurethane, including subranges. For example, the amount of protein in a blend can be about 5 wt %, about 10 wt %, about 15 wt %, about 20 wt %, about 25 wt %, about 30 wt %, about 35 wt %, about 40 wt %, about 45 wt %, about 50 wt %, about 55 wt %, or about 60 wt %, or within a range having any two of these values as endpoints. In some embodiments, the amount of protein in a blend can be about 10 wt % to about 55 wt %, about 15 wt % to about 50 wt %, about 20 wt % to about 45 wt %, about 25 wt % to about 40 wt %, or about 30 wt % to about 35 wt %. In some embodiments, the amount of protein in the protein/polyurethane blend can range from 20 wt % to 40 wt %.

The amount of polyurethane(s) in a protein/polyurethane blend can range from about 10 wt % to about 85 wt %, based on the weight of protein and polyurethane, including subranges. For example, the amount of polyurethane(s) in blend can be about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, or about 85 wt %, or within a range having any two of these values as endpoints, inclusive of the endpoints. In some embodiments, the amount of the polyurethane(s) in a blend can range from about 20 wt % to about 75 wt %, about 30 wt % to about 65 wt %, or about 40 wt % to about 55 wt %.

In some embodiments, the blending temperature can range from about room temperature (18° C.) to about 100° C., including subranges. For example, the blend temperature can be about 18° C., about 30° C., about 40° C., about 50° C., about 60° C., about 70° C., about 80° C., about 90° C., or about 100° C., or within a range having any two of these values as endpoints, inclusive of the endpoints. In some embodiments, the blend temperature can range from about 18° C. to about 90° C., about 18° C. to about 80° C., about 18° C. to about 70° C., about 18° C. to about 60° C., about 18° C. to about 50° C., about 18° C. to about 40° C., or about 18° C. to about 30° C.

In some embodiments, the blending time for step 1906 can range from about 15 minutes to about 3 hours, including subranges. For example, the blending time can be about 30 minutes, about 1 hour, about 90 minutes, about 2 hours, about 150 minutes, or about 3 hours, or within a range having any two of these values as endpoints, inclusive of the endpoints. In some embodiments, the blending time can range from about 15 minutes to about 150 minutes, about 15 minutes to about 2 hours, about 15 minutes to about 90 minutes, or about 15 minutes to about 1 hour. In some embodiments, the blending speed for step 1906 can range from about 150 rpm to about 250 rpm, including subranges. For example, the blending speed can be about 150 rpm, about 175 rpm, about 200 rpm, about 225 rpm, or about 250 rpm. In some embodiments, the blending speed can range from about 150 rpm to about 225 rpm, about 150 rpm to about 200 rpm, or about 150 rpm to about 225 rpm. The blending speed can depend on the size of a blending device (e.g., size of an impeller) and/or the size of the vessel in which the components are blended.

In some embodiments, one or more additives can be added to the blend in step 1906. The additive(s) can influence the final properties of a protein polyurethane alloy layer, and therefore the final properties of a layered material 1700. For example, the additive(s) added can impact one or more of the following material properties: stiffness, elasticity, cohesive strength, tear strength, fire retardancy, chemical stability, or wet stability. Suitable additives include, but are not limited to, cross-linkers, fillers, dyes, pigments, plasticizers, waxes, rheological modifiers, flame retardants, antimicrobial agents, antifungal agents, antioxidants, UV stabilizers, mechanical foaming agents, chemical foaming agents, foam stabilizers, and the like. Suitable dyes include, but are not limited to fiber reactive dyes or natural dyes. Suitable cross-linkers include, but are not limited to, epoxy-based cross-linkers, (for example, poly(ethylene glycol) diglycidyl ether (PEGDE) available from Sigma Aldridge), isocyanate-based cross-linkers (for example, X-TAN® available from Lanxess), and carbodiimide-based cross-linkers. Suitable foaming agents include, HeiQ Chemtex 2216-T (a stabilized blend of nonionic and anionic surfactants), HeiQ Chemtex 2241-A (a modified HEUR (hydrophobically-modified ethylene oxide urethane) thickener), HeiQ Chemtex 2243 (a non-ionic silicone dispersion), or HeiQ Chemtex 2317 (a stabilized blend of nonionic and anionic surfactants) foam stabilizers available from HeiQ Chemtex. Suitable antimicrobial/antifungal agents include Ultra-Fresh DW-56, or other antimicrobial/antifungal agents used in the leather industry. Suitable flame retardants include CETAFLAM® DB9 (organophosphorous compounds containing C—PO(OH)₂ or C—PO(OR)₂ groups with the carbon chain containing polymers), CETAFLAM® PD3300 (organophosphorous compounds containing C—PO(OH)₂ or C—PO(OR)₂ groups with the carbon chain containing polymers), or other flame retardants used for coated textiles. Suitable fillers include, but are not limited to, thermoplastic microspheres, for example, EXPANCEL® Microspheres. Suitable rheological modifiers include, but are not limited to, alkali swellable rheological modifiers, hydrophobically-modified ethylene oxide-based urethane (HEUR) rheological modifiers, and volume exclusion thickeners. Exemplary alkali swellable rheological modifiers include but are not limited to, ACRYSOL™ DR-106, ACRYSOL™ ASE-60 from Dow Chemicals, TEXICRYL® 13-3131, and TEXICRYL® 13-308 from Scott-Bader. Exemplary HEUR modifiers include, but are not limited to, RM-4410 from Stahl and Chemtex 2241-A from HeiQ. Exemplary volume exclusion thickeners include, but are not limited to, WALOCEL™ XM 20000 PV from Dow Chemicals and Methyl-Hydroxyethyl Cellulose from Sigma-Aldrich.

In some embodiments, a blend can include one or more coloring agents. In some embodiments, the coloring agent can be a dye, for example a fiber reactive dye, a direct dye, or a natural dye. Exemplary dyes, include but are not limited to, Azo structure acid dyes, metal complex structure acid dyes, anthraquinone structure acid dyes, and azo/diazo direct dyes. In some embodiments, the coloring agent can be pigment, for example a lake pigment. In some embodiments, a blend can include a coloring agent content of about 2 wt % or less. For example, a blend can include about 0.1 wt %, about 0.5 wt %, about 1 wt %, about 1.5 wt %, or about 2 wt % coloring agent. In some embodiments, a blend can include about 0.1 wt % to about 2 wt %, about 0.5 wt % to about 1.5 wt %, or about 0.1 wt % to about 1 wt % coloring agent. In some embodiments, a blend can be free or substantially free of a coloring agent. In such embodiments, a protein polyurethane alloy layer created from the blend can be free or substantially free of a coloring agent.

In step 1908, a layer of the blended mixture is disposed over top surface 2002 of sacrificial layer 2000. The blended mixture can be coated over top surface 2002 of sacrificial layer 2000. In embodiments not including steps 1902 and 1904, the blended mixture can be coated directly on top surface 2002 of sacrificial layer 2000. In embodiments including step 1904, the blended mixture can be coated directly on a surface of basecoat layer 1760. In embodiments including step 1902 but not step 1904, the blended mixture can be coated directly on a surface of top-coat layer 1770. In some embodiments, the blended mixture can be formed into a sheet by coating it on a surface to a desired thickness. Coating can include pouring, extruding, casting, and the like. In some embodiments, the sheet can be spread to a desired thickness using, for example, a blade, a knife, a roller, a knife over roll, curtain coating, and slot die coating.

In some embodiments, the temperature of the blended mixture during coating can be about 40° C. or higher. For example, the temperature of the blended mixture can range from about 40° C. to about 100° C., including subranges. For example, the temperature can be about 40° C., about 50° C., about 60° C., about 70° C., about 80° C., about 90° C., or about 100° C., or within a range having any two of these values as endpoints, inclusive of the endpoints. In some embodiments, the temperature of the blended mixture during coating can range from about 40° C. to about 90° C., about 40° C. to about 80° C., about 40° C. to about 70° C., about 40° C. to about 60° C., or about 40° C. to about 50° C. Coating at a temperature below about 40° C. can result in the blended mixture being too viscous and can make it difficult to form a layer of uniform thickness.

In step 1910, solvent (for example, water) can be removed from the coated blended mixture to form protein polyurethane alloy layer 1720, as illustrated in for example, FIG. 20C. Suitable solvent removal methods include, but are not limited to tunnel drying, vacuum drying, oven drying with hot air, humidity chamber drying, flotation drying with hot air, and ovens with a combination of medium range IR (infrared) for preheating and then hot air for subsequent drying.

Suitable solvent removal temperatures for step 1910 can range from about room temperature (18° C.) to about 100° C., including subranges. For example, solvent may be removed at a temperature of about 18° C., about 35° C., about 50° C., about 60° C., about 70° C., about 80° C., about 90° C., or about 100° C., or within a range having any two of these values as endpoints, inclusive of the endpoints. In some embodiments, solvent may be removed at a temperature ranging from about 18° C. to about 35° C., about 18° C. to about 50° C., about 18° C. to about 60° C., about 18° C. to about 70° C., about 18° C. to about 80° C., about 18° C. to about 90° C., or about 18° C. to about 100° C. Suitable humidity values for solvent removal in step 1910 include a humidity in a range from 0% RH (relative humidity) to about 65% RH, including subranges. For example, the humidity can be about 10% RH, about 20% RH, about 40% RH, about 50% RH, or about 65% RH, or within a range having any two of these values as endpoints, inclusive of the endpoints. In some embodiments, the humidity can be 0% RH to about 50% RH, 0% RH to about 40% RH, 0% RH to about 20% RH, or 0% RH to about 10% RH. The solvent removal temperature and/or humidity can affect the final properties of a protein polyurethane alloy layer, and therefore a layered material. The solvent removal temperature and/or humidity in step 1910 can impact one or more of the following material properties: stiffness, elasticity, cohesive strength, tear strength, fire retardancy, chemical stability, and wet stability. For example, relatively high humidity and relatively low temperature can result in a material that is softer and more elastic. Conversely, relatively low humidity and relatively high temperature can result in a material that is harder and less elastic.

In some embodiments, steps 1906-1910 can be repeated a plurality of times to form a plurality of protein polyurethane alloy layers 1720 over sacrificial layer 2000. In some embodiments, steps 1906-1910 can be repeated sequentially to form a plurality of protein polyurethane alloy layers 1720 over sacrificial layer 2000. In some embodiments, steps 1906-1910 can be repeated after steps 1912-1916 to form one or more protein polyurethane alloy layers 1720 over one or more foamed protein polyurethane alloy layers 1730/1740. In some embodiments, method 1900 may not include steps 1906-1910.

In step 1912, one or more polyurethanes dispersed or dissolved in an aqueous solution can be blended with protein(s) and foamed to form a foamed blended mixture in the aqueous solution. In some embodiments, the one or more polyurethanes can be dispersed or dissolved in an aqueous solution before blending with protein(s) and foaming. In some embodiments, the one or more polyurethanes can become dispersed or dissolved in an aqueous solution during blending with protein(s) and foaming. In some embodiments, the one or more polyurethanes and the one or more proteins can be blended in a suitable vessel until a homogenous blend is formed. Suitable blending equipment includes, but is not limited to, a blender, a stand mixer, an in-line mixer, or a high shear mixer. The blend may be foamed using, for example, a mechanical foaming process or a chemical foaming process. Exemplary mechanical foaming equipment includes a Hansa Mixer or a GEMATA® foamer. Blending and foaming can be performed separately or concurrently.

Suitable polyurethane(s) for blending and foaming in step 1912 are those discussed herein for protein polyurethane alloy layers. In some embodiments, one or more foaming agents and/or foam stabilizers may be added to the blend in step 1912. Suitable foaming agents and foam stabilizers include those discussed herein for protein polyurethane alloy layers 1730/1740.

In some embodiments, a blend can include a foaming agent or a foam stabilizer content of about 10 wt % or less. For example, a blend can include about 0.1 wt %, about 1 wt %, about 2.5 wt %, about 5 wt %, about 7.5 wt %, or about 10 wt % foaming agent or foam stabilizer. In some embodiments, a blend can include about 0.1 wt % to about 10 wt %, about 1 wt % to about 7.5 wt %, about 2.5 wt % to about 5 wt %, about 0.1 wt % to about 5 wt %, or about 0.1 wt % to about 2.5 wt % foaming agent or foam stabilizer. In some embodiments, a blend can be substantially free or free of a foaming agent and/or a foam stabilizer. In such embodiments, a protein polyurethane alloy layer created from the blend can be substantially free or free of a foaming agent and/or a foam stabilizer.

Foaming in step 1912 can be used to impart a desired density for a foamed protein polyurethane alloy layer. In some embodiments, a foamed blended mixture can have a liquid density, before solvent is removed in step 1916, ranging from about 300 g/L to about 900 g/L, including subranges. For example, a foamed blended mixture formed in step 1912 can have a liquid density of about 300 g/L, about 400 g/L, about 500 g/L, about 600 g/L, about 700 g/L, about 800 g/L, or about 900 g/L, or within a range having any two of these values as endpoints. In some embodiments, the foamed blended mixture can have a liquid density ranging from about 300 g/L to about 800 g/L, about 300 g/L to about 700 g/L, about 400 g/L to about 600 g/L, about 300 g/L to about 500 g/L, or about 300 g/L to about 600 g/L. In some embodiments, a blended mixture formed in step 1906 can have a liquid density, before the solvent is removed from the blended mixture in step 1910 that is greater than the liquid density of the foamed blended mixture formed in step 1912 before solvent is removed in step 1916.

In some embodiments, protein(s) can be dispersed or dissolved in an aqueous solution before blending with polyurethane and foaming in step 1912. Suitable aqueous solutions include those discussed above for step 1906. The protein concentration in the aqueous solution can be any value or range discussed above for step 1906. The amount of protein in a protein/polyurethane blend for step 1912 can be any value or range discussed above for step 1906. The blending temperature for step 1912 can be any temperature or temperature range discussed above for step 1906. The blending time for step 1912 can be any time or time range discussed above for step 1906. The blending speed for step 1912 can be any speed or speed range discussed above for step 1906. In some embodiments, one or more additives can be added to the blend in step 1912. The additive(s) added in step 1912 can be any of the additives discussed above for step 1906.

In step 1914, a layer of the foamed blended mixture is disposed over sacrificial layer 2000. In some embodiments, a layer of the foamed blended mixture is disposed over a surface of a protein polyurethane alloy layer 1720. In some embodiments, the blended and foamed mixture can be coated directly on a surface of a protein polyurethane alloy layer 1720. In some embodiments, the foamed blended mixture can be formed into a sheet by coating it on a surface to a desired thickness. Coating can include pouring, extruding, casting, and the like. In some embodiments, the sheet can be spread to a desired thickness using, for example, a blade, a knife, a roller, a knife over roll, curtain coating, and slot die coating.

In step 1916, solvent (for example, water) can be removed from the coated, foamed blended mixture to form a foamed protein polyurethane alloy layer 1730, as illustrated in for example, FIG. 20D. Suitable solvent removal methods include, but are not limited to tunnel drying, vacuum drying, oven drying with hot air, humidity chamber drying, flotation drying with hot air, and ovens with a combination of medium range IR for preheating and then hot air for subsequent drying. Suitable solvent removal temperatures for step 1916 can any of the temperature or temperature ranges discussed above for step 1910. Humidity values for step 1916 can be any of the humidity values or humidity ranges discussed above for step 1910

In some embodiments, steps 1912-1916 can be repeated a plurality of times to form a plurality of foamed protein polyurethane alloy layers over sacrificial layer 2000, for example, foamed protein polyurethane alloy layers 1730 and 1740. In such embodiments, the foamed blended mixtures formed in separate steps 1912 can have different liquid densities. For example, the liquid density for one foamed blended mixture can be 10 g/L to 300 g/L more or less than the liquid density for another foamed blended mixture. For example, in some embodiments, a first blended mixture can have a liquid density ranging from about 300 g/L to about 500 g/L and a second blended mixture can have a liquid density ranging from about 600 g/L to about 700 g/L. As another example, a first blended mixture can have a liquid density ranging from about 300 g/L to about 400 g/L and a second blended mixture can have a liquid density ranging from about 500 g/L to about 700 g/L.

In some embodiments, steps 1912-1916 can be repeated sequentially to form a plurality of foamed protein polyurethane alloy layers over sacrificial layer 2000. In some embodiments, a foamed and blended mixture formed in step 1912 can be used to form multiple foamed protein polyurethane alloy layers in steps 1914-1916. In some embodiments, steps 1912-1916 can be performed before performing a set of steps 1906-1910 to form one or more foamed protein polyurethane alloy layers between a protein polyurethane alloy layer 1720 and sacrificial layer 2000. In some embodiments, method 1900 may not include steps 1912-1916.

In step 1918, sacrificial layer 2000 is removed from the layer(s) formed in steps 1902-1916, as illustrated in for example FIG. 20E. Sacrificial layer 2000 can be removed by a mechanical process or a chemical process. For example, sacrificial layer 2000 can be removed by peeling sacrificial layer 2000 away from the other layers. As another example, sacrificial layer 2000 can be removed by dissolving sacrificial layer 2000. In some embodiments, sacrificial layer 2000 can be removed in step 1918 before attaching the layer(s) formed in steps 1902-1916 to a substrate layer 1710 in step 1920. In some embodiments, sacrificial layer 2000 can be removed after step 1920.

In step 1920, the layer(s) formed in steps 1902-1916 are attached to a substrate layer 1710, as illustrated in for example FIG. 20F. In step 1920, protein polyurethane alloy layer 1720, and any other protein polyurethane alloy layers formed in steps 1906-1916 are attached to substrate layer 1710. In some embodiments, attaching one or more protein polyurethane alloy layers (e.g., protein polyurethane alloy layer 1720) to substrate layer 1710 in step 1920 includes a heat pressing process. In such embodiments, protein polyurethane alloy layer (e.g., protein polyurethane alloy layer 1720) can be in direct contact with substrate layer 1710. Also, in such embodiments, a protein polyurethane alloy layer can partially melt into substrate layer 1710, and upon cooling the two layers are firmly attached. In some embodiments, attaching one or more protein polyurethane alloy layers (e.g., protein polyurethane alloy layer 1720) to substrate layer 1710 in step 1920 includes a lamination process. In such embodiments, lamination can be accomplished with an adhesive layer 1750. In such embodiments, substrate layer 1710 and/or a protein polyurethane alloy layer can be coated with an adhesive by known techniques such as slot die casting, kiss coating, a drawdown technique, or reverse transfer coating. In some embodiments, the lamination process can include passing substrate layer 1710 and the other layer(s) through rollers under heat.

In some embodiments, step 1920 can be omitted from method 1900. In such embodiments, the layer(s) formed in steps 1902-1916 define a protein polyurethane alloy layer or a layered material without a substrate layer 1710.

In some embodiments, layered materials described herein can have a tear strength that is at least about 1% greater than that of a natural leather of the same thickness. For example, the layered material can have a tear strength that is about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 100%, about 150%, or about 200% greater than that of natural leather of the same thickness. In some embodiments, the layered material can have a tear strength in the range of about 20 N to about 300 N, including subranges. For example, the tear strength of the layered material can be about 20 N, about 30 N, about 40 N, about 50 N, about 60 N, about 70 N, about 80 N, about 90 N, about 100 N, about 125 N, about 150 N, about 175 N, about 200 N, about 225 N, about 250 N, about 275 N, or about 300 N, or within a range having any two of these values as endpoints, inclusive of the endpoints. In some embodiments, the tear strength can range from about 30 N to about 275 N, about 40 N to about 250 N, about 50 N to about 225 N, about 60 N to about 200 N, or about 75 N to about 175 N, about 80 N to about 150 N, about 90 N to about 125 N, or about 100 N to about 125 N.

In some embodiments, a protein polyurethane alloy layer described herein can have a tear strength in the range of about 2 N to about 30 N, including subranges. For example, the tear strength of the protein polyurethane alloy layer can be about 2 N, about 4 N, about 5 N, about 10 N, about 15 N, about 20 N, about 25 N, or about 30 N, or within a range having any two of these values as endpoints, inclusive of the endpoints. In some embodiments, the tear strength can range from about 4 N to about 25 N, about 5 N to about 20 N, or about 10 N to about 15 N.

Tear strength, or tear resistance, is a measure of how well a material can withstand the effects of tearing. Tear resistance can be measured by a variety of methods, for example the method provided by ASTM D 412 or the method provided by ISO 3377 (also called the “Bauman tear”). The method provided by ASTM D 624 can also be used to measure the resistance to the formation of a tear and the resistance to the expansion of a tear. Regardless of the method used, first, a cut is made in the material sample tested to induce a tear. Then, the sample is held between two grips and a uniform pulling force is applied until sample tears in two. Tear resistance is then calculated by dividing the force applied by the thickness of the material. Unless specified otherwise, a tear strength value reported herein is measured by ISO 3377.

In some embodiments, the layered materials described herein can have a tensile strength in the range of about 1 kPa (kilopascal) to about 100 MPa (megapascals), including subranges. For example, the layered material can have a tensile strength of about 1 kPa, about 50 kPa, about 100 kPa, about 200 kPa, about 300 kPa, about 400 kPa, about 500 kPa, about 600 kPa, about 700 kPa, about 800 kPa, about 900 kPa, about 1 MPa, about 5 MPa, about 10 MPa, about 20 MPa, about 30 MPa, about 40 MPa, about 50 MPa, about 60 MPa, about 70 MPa, about 80 MPa, about 90 MPa, or about 100 MPa, or within a range having any two of these values as endpoints, inclusive of the endpoints. In some embodiments, the tensile strength can range from about 50 kPa to about 90 MPa, about 100 kPa to about 80 MPa, about 200 kPa to about 70 MPa, about 300 kPa to about 60 MPa, about 400 kPa to about 50 MPa, about 500 kPa to about 40 MPa, about 600 kPa to about 30 MPa, about 700 kPa to about 20 MPa, about 800 kPa to about 10 MPa, or about 1 MPa to about 5 MPa.

Softness, also referred to as “hand feel” of a material can be determined by ISO 17235. In some embodiments, an exterior surface of a layered material described herein can have a softness ranging from about 2 mm to about 12 mm, including subranges. For example, an exterior surface of a layered material can have a softness of about 2 mm, about 3 mm, about 4 mm, about 5 mm, about 6 mm, about 7 mm, about 8 mm, about 9 mm, about 10 mm, about 11 mm, or about 12 mm, or within a range having any two of these values as endpoints, inclusive of the endpoints. In some embodiments, the softness can be about 3 mm to about 11 mm, about 4 mm to about 10 mm, about 5 mm to about 9 mm, about 6 mm to about 8 mm, or about 6 mm to about 7 mm. Unless specified otherwise, a softness value disclosed herein is determined by ISO 17235.

Flexibility, or strain, of a material can be determined by measuring its elongation at failure when a tensile force is applied, for example using the equation: ΔL/L, where ΔL is the change in length of the material after the tensile force is applied, and L is the original length of the material. Flexibility can also be measured according to the method provided by ASTM D 412. In some embodiments, the layered materials described herein can have a flexibility in the range of about 100% to about 400%, including subranges. For example, the layered materials can have a flexibility of about 100%, about 200%, about 300%, or about 400%, or within a range having any two of these values as endpoints, inclusive of the endpoints. In some embodiments, the flexibility can be about 100% to about 200%, about 100% to about 300%, about 200% to about 300%, or about 200% to about 400%. Unless specified otherwise, a flexibility value disclosed herein is measured by ASTM D 412. In some embodiments, a protein polyurethane alloy layer described herein can have flexibility value or range as described above for a layered material.

In some embodiments, a layered material as described herein can have a permanent set in a hysteresis experiment of about 8% or less. In some embodiments, a layered material can have a permanent set of about 1%, about 2%, about 3%, about 4%, about 5%, about 6%, about 7%, or about 8%, or within a range having any two of these values as endpoints. In some embodiments, a layered material can have a permanent set of about 1% to about 8%, about 2% to about 7%, about 3% to about 6%, or about 4% to about 5%.

Unless specified otherwise, a permanent set value is measured by the following method. A dog-bone-shaped tensile specimen of a material is cut and the original length of the sample is measured. The samples are cut to have a dog-bone shape with about 110 mm length and 10 mm width (75-100 mm gauge length). Then, the sample is stretched along its length using an INSTRON® machine to 15% strain and returned to 0% strain, both at a constant rate of three millimeters per second. This is repeated five times. Then, the distance between the original sample length and the length of the sample at which the load goes to zero on the last return cycle is measured. The percent difference between the length measured after repeatedly straining the material and the original length is the permanent set %. For purposes of calculating a permanent set value, three separate samples of a material are evaluated, and the average permanent set value is reported as the permanent set value for the material.

In some embodiments, layered materials described herein can have a moisture vapor transmission rate (MVTR) of about 75 g/m²/hr or more. In some embodiments, layered materials described herein can have a MVTR ranging from about 75 g/m²/hr to about 200 g/m²/hr, including subranges. For example, the layered material can have a MVTR of about 80 g/m²/hr to about 190 g/m²/hr, about 90 g/m²/hr to about 180 g/m²/hr, about 100 g/m²/hr to about 170 g/m²/hr, about 110 g/m²/hr to about 160 g/m²/hr, about 120 g/m²/hr to about 150 g/m²/hr, or about 130 g/m²/hr to about 140 g/m²/hr. Unless specified otherwise, a MVTR value disclosed herein is measured using ASTM E96 (“Standard Test Methods for Water Vapor Transmission of Materials”)—Procedure B, Water Method, at about 74.3° F., at about 50% relative humidity, and with a ¾ inch air gap.

Layered materials having a moisture vapor transmission rate as reported herein can be suitable for use in a variety of applications where breathability of the material is a desirable property. Exemplary applications where breathability can be desirable include, but are not limited to, footwear, apparel, and upholstery. Layered materials as described herein can have a significantly higher water vapor transmission rate compared to a layered polymeric material having the same number of layers with the same thicknesses and made of the same polymeric material(s), but without protein blended in the polymeric material(s).

In some embodiments, layered materials described herein can have a color fastness of class 4 or higher when measured according to ISO 11640 (“Leather-Tests for color fastness—fastness to cycles of to-and-fro rubbing”) wet-rub fastness test. In some embodiments, layered materials described herein can have a color fastness of class 4, class 4.5, or class 5 when measured according to ISO 11640's wet-rub fastness test. A color fastness of class 4 or higher can provide layered materials described herein with desirable wear resistance for a variety of applications.

Layered materials described herein can achieve a color fastness of class 4 or higher without the inclusion of a pigment in the materials. This is a unique characteristic compared to a layered polyurethane material made of the same polyurethane(s) without protein(s) blended in the polyurethane(s). Protein within layered materials described herein can adhere well to a dye used to color the material. To achieve a high color fastness, polyurethane materials are usually colored using a pigment because dyes do not generally adhere to a polyurethane well. Poor adherence between a dye and a polyurethane leads to a relatively low color fastness. Dyed layered materials described herein can have improved depth of color and other aesthetic features not achievable with a polyurethane colored using a pigment.

In some embodiments, a layered material described herein, or an individual layer of a layered material described herein, can be subjected to the same, or similar finishing treatments as those used to treat natural leather. In some embodiments, a layered material described herein can be tumbled or staked to tailor properties of the material, such as the feel of the material. In such embodiments, traditional textile tumbling and staking methods can be used.

In some embodiments, a layered material, or an individual layer of a layered material, can have a rough exterior surface. For example, top surface 1724 of protein polyurethane alloy layer 1720 can have a rough surface, top surface 1774 of top-coat layer 1770 can have a rough surface, top surface 1764 of basecoat layer 1760 can have a rough surface, top surface 1734 of protein polyurethane alloy layer 1730 can have a rough surface, or top surface 1744 of protein polyurethane alloy layer 1740 can have a rough surface. A rough exterior surface can create a surface texture similar in appearance and feel to that of a naturel leather (e.g., the grain of pebbled natural leather). In some embodiments, top surface 2002 of sacrificial layer 2000 can have a rough surface that is transferred onto the surface of a layer disposed directly on top surface 2002 during method 1900.

A rough surface has a surface area per square inch of at least about 1% greater than 1 in². In other words, in some embodiments, a one square inch sample of layered material 1700, including a layer having rough exterior surface, can have a surface area that is at least about 1% greater than a one square inch sample of a material having a perfectly smooth surface. In some embodiments, a rough exterior surface can have a surface area per square inch of at least about 1% greater than 1 in², about 10% greater than 1 in², about 20% greater than 1 in², about 30% greater than 1 in², about 40% greater than 1 in², about 50% greater than 1 in², about 60% greater than 1 in², about 70% greater than 1 in², about 80% greater than 1 in², about 90% greater than 1 in², about 100% greater than 1 in², about 150% greater than 1 in², about 200% greater than 1 in², about 250% greater than 1 in², about 300% greater than 1 in², about 350% greater than 1 in², about 400% greater than 1 in², about 450% greater than 1 in², or about 500% greater than 1 in², or within a range having any two of these values as endpoints, inclusive of the endpoints. In some embodiments, a rough surface can have a surface area per square inch of about 1% greater than 1 in² to about 500% greater than 1 in², about 10% greater than 1 in² to about 450% greater than 1 in², about 20% greater than 1 in² to about 400% greater than 1 in², about 30% greater than 1 in² to about 350% greater than 1 in², about 40% greater than 1 in² to about 300% greater than 1 in², about 50% greater than 1 in² to about 250% greater than 1 in², about 60% greater than 1 in² to about 200% greater than 1 in², about 70% greater than 1 in² to about 150% greater than 1 in², or about 80% greater than 1 in² to about 100% greater than 1 in². Unless specified otherwise, a surface area of material disclosed herein is measured using profilometry. For non-transparent materials, optical profilometry is used. In some embodiments, a layered material, or an individual layer of a layered material, can have a smooth exterior surface. A smooth surface has a surface area per square inch of less than 1% greater than 1 in². For example, a smooth surface can have a surface area per square inch of 1 in² to less than 1.01 in². In some embodiments, top surface 2002 of sacrificial layer 2000 can have a smooth surface that is transferred onto the surface of a layer disposed directly on top surface 2002 during method 1900.

In some embodiments, a layered material, or an individual layer of a layered material, can have a textured exterior surface. In some embodiments, top surface 2002 of sacrificial layer 2000 can have a textured surface that is transferred onto the surface of a layer disposed directly on top surface 2002 during method 1900. In some embodiments, a textured exterior surface can a surface area per square inch, or surface area per square inch range, as discussed above for a rough surface.

In some embodiments, the texture can be a macro-scale texture, for example, any of the many textures used on Sappi/Warren Release Papers that are commercially available under the trademark ULTRACAST® or tradename Classic, manufactured by S. D. Warren Company d/b/a Sappi North America. An example of a macro-scale texture is a replicate of a natural leather grain with feature depths of about 50 to about 300 microns. Any other desired macro-scale texture may also be used. In some embodiments, a macro-scale texture can be a “leather grain texture.” As used herein, the term “leather grain texture” is a texture that mimics the look and feel of natural leather. Exemplary “leather grain textures” include but are not limited to, Sappi Matte Freeport 189, Sappi Freeport 123, or Sappi Expresso 904.

In some embodiments, the texture can be a micro-scale texture. In some embodiments, the texture can be a micro-scale texture with surface features having a feature size of less than 50 microns, for example 1000 nanometers to less than 50 microns. An example of a micro-scale texture is referred to in the art as “Sharklet.” Sharklet textures can be applied to provide the products with a surface that is structured to impede bacterial growth. The micro-scale texture of the surface replicates sharkskin denticles, which are arranged in a diamond pattern with millions of tiny ribs. Sharklet materials are discussed, for example, in U.S. Pat. Nos. 7,650,848 and 8,997,672, the disclosures of which are incorporated herein by reference.

In some embodiments, the texture can be a nanoscale texture with surface features having a feature size of less than 1000 nanometers, for example 10 nanometers to less than 1000 nanometers. One example of a nanoscale texture is a diffraction grating that has a series of raised ridges about 400 nanometers wide, spaced approximately 800 nanometers apart, with a depth of approximately 100 nanometers.

The embodiments discussed herein will be further clarified in the following examples. It should be understood that these examples are not limiting to the embodiments described above.

### Example 1

A sample was prepared by mixing 5.5 g of a waterborne polyurethane dispersion L3360 from Hauthaway, with 10 mL of de-ionized water and stirring at 1000 rpm (rotations per minute) for 30 minutes at 50° C. The solution was then pipetted into a Teflon evaporating dish with a diameter of 10 cm. The dish was dried in an oven at 45° C. overnight. After drying, the dried sample was conditioned at standard reference atmosphere (23° C., 50% humidity) for 24 hours, resulting in a polyurethane film.

The film was tested using a DMA-850 from TA Instruments. A 1 cm×2.5 cm strip was cut from each film using a metal die. The cut film samples were loaded into the film and fiber tension clamp for testing. During testing, a pre-load of 0.01N was applied to the cut film samples. The instrument was cooled to −80° C., held for 1 minute, then the temperature was ramped at 4° C./minute to 200° C., or until the sample was too weak to be held in tension. During the temperature ramp, the sample was oscillated 0.1% strain at a frequency of 1 Hz. The storage modulus, loss modulus, and tan (δ) were plotted with temperature for both films. The resulting second storage modulus transition (taken as the onset point of the last decrease in the storage modulus measured, i.e. second DMA modulus transition onset temperature) was 114.9° C. for the control sample.

Additionally, 5 tensile specimens (according to ASTM D638) were each cut from the dried and conditioned sample film using a metal die. The cut film samples were loaded into an INSTRON® 5960 series machine and pulled in tension at 100 millimeters/minute until break. The average Young's modulus, average tensile strength (maximum tensile stress), and average elongation at break were recorded. The Young's modulus was 59 MPa, the maximum tensile stress was 12.9 MPa, and the elongation at break was 402%.

### Examples 2-8

Examples 2-8 were performed using the same method as Example 1 to show a range of polyurethane dispersions. The polyurethanes used and the resulting properties are listed in Tables 3-6.

### Example 9

A sample was prepared by dissolving 0.825 g (grams) of gelatin from porcine skin into 10 mL (milliliters) of de-ionized water and stirring with a magnetic stir bar at 1000 rpm (rotations per minute) for 1 hour at 50° C. After the gelatin was fully dissolved, the pH of the solution was adjusted to 7.0 with 0.1N sodium hydroxide. Then 5.5 g of L3360 was added to the solution and stirred at 1000 rpm for 30 minutes. The polyurethane and gelatin solution was then pipetted into a Teflon evaporating dish with a diameter of 10 cm. The dish was dried in an oven at 45° C. overnight. After drying, the dried sample was conditioned at standard reference atmosphere (23° C., 50% humidity) for 24 hours to create a gelatin polyurethane alloy film.

At the time of pipetting, the gelatin polyurethane solution was milky in appearance, with no particulates visible. After drying, the gelatin polyurethane solution produced a transparent film with uniform look with no optically visible granules. This result, combined with the Examples of 33 and 34, show that when the protein is miscible with the hard phase, the protein polyurethane alloy can be transparent and have enhanced properties.

DMA testing was performed as outlined in Example 1. The resulting second storage modulus transition (taken as the onset point of the last decrease in the storage modulus measured, i.e. second DMA modulus transition onset temperature) for the gelatin polyurethane alloy was 180.6° C., a 65.7° C. increase over the control sample described in Example 1.

Tensile testing was performed as outlined in Example 1. The average Young's modulus was 344 MPa, the average tensile stress measured was 19.8 MPa, and the average elongation at break was 197% for the gelatin polyurethane alloy.

The increase in the second DMA modulus transition onset temperature of this example, along with increased modulus and strength, and decreased elongation, compared to the polyurethane alone in Example 1, indicate that the dissolved gelatin in the gelatin polyurethane alloy is miscible with the hard phase of the polyurethane.

### Examples 10-19

Examples 10-19 were performed using the same method as used for Example 9 to show a range of polyurethane dispersions from different manufacturers and different proteins. The resulting properties of these alloys are listed in Tables 3-6.

### Example 20

A sample was prepared by dissolving 0.825 g (grams) of Bovine Serum Albumin from Sigma (BSA) into 10 mL (milliliters) of de-ionized water and stirring with a magnetic stir bar at 1000 rpm (rotations per minute) for 1 hour at 20° C. Then 5.5 g of L3360 was added to the solution and stirred at 1000 rpm for 30 minutes. The polyurethane and BSA solution was then pipetted into a Teflon evaporating dish with a diameter of 10 cm. The dish was dried on the benchtop at 25° C. overnight. After drying, the dried sample was conditioned at standard reference atmosphere (23° C., 50% humidity) for 24 hours to create a BSA polyurethane alloy film.

DMA testing was performed as outlined in Example 1. The resulting second storage modulus transition (taken as the onset point of the last decrease in the storage modulus measured, i.e. second DMA modulus transition onset temperature) for the BSA polyurethane alloy was 184.9° C., a 70° C. increase over the control sample described in Example 1.

Tensile testing was performed as outlined in Example 1. The average Young's modulus was 174 MPa, the average tensile stress measured was 11.7 MPa, and the average elongation at break was 123% for the BSA polyurethane alloy.

### Example 21

Soy protein isolate (SPI) was dispersed by adding 0.75 g SPI into 15 mL of a sodium hydroxide solution at a 0.05 mol/L concentration. The dispersion was stirred with a magnetic stir bar at 600 rpm for 3 hours at 80° C. Then 5 g of L3360 was added to the solution and stirred at 600 rpm for 30 minutes. The SPI polyurethane solution was then pipetted into a Teflon evaporating dish with a diameter of 10 cm. The dish was dried in an oven at 45° C. overnight. After drying, the dried sample was conditioned at standard reference atmosphere (23° C., 50% humidity) for 24 hours to create a SPI polyurethane alloy film.

DMA testing was performed as outlined in Example 1. The resulting second storage modulus transition (taken as the onset point of the last decrease in the storage modulus measured, i.e. second DMA modulus transition onset temperature) for the SPI polyurethane alloy was 186.6° C., a 72° C. increase over the control in Example 1.

Tensile testing was performed as outlined in Example 1. The average Young's modulus was 396 MPa, the average tensile stress measured was 18 MPa, and the average elongation at break was 151% for the SPI polyurethane alloy.

The increase in the second DMA modulus transition onset temperature, along with increased modulus and strength, and decreased elongation, indicate that the dissolved SPI in the SPI polyurethane alloy is miscible with the hard phase of the polyurethane.

### Examples 22-23

Examples 22-23 were preformed using the same method as Example 21. The proteins used and the resulting properties of these protein polymer alloys are listed in Tables 3-6.

### Examples 24-29

Samples were prepared by the same method as Example 9. The gelatin and L3360 amounts were varied to achieve various mass ratios of the two components in the alloy samples. The masses of gelatin and PU dispersion, as well as the resulting mass fractions, are summarized below in Table 2.

TABLE 2

| | Gelatin | L3360 | Gelatin | L3360 |
|---|---|---|---|---|
| Ex. | Added | Dispersion | Mass | Mass |
| No. | (g) | Added (g) | Fraction | Fraction |
| 24 | 1.25 | 3.6 | 50% | 50% |
| 25 | 0.5 | 5.7 | 20% | 80% |
| 26 | 0.375 | 6.1 | 15% | 85% |
| 27 | 0.25 | 6.4 | 10% | 90% |
| 28 | 0.125 | 6.8 | 5% | 95% |
| 29 | 0.025 | 7.1 | 1% | 99% |

Tensile and DMA testing were performed as outlined in Example 1. The resulting properties of the alloys are listed in Tables 3-6.

### Example 30

Soy protein isolate (SPI) was dispersed by adding 0.25 g SPI into 15 mL of DI Water. The dispersion was stirred with a magnetic stir bar at 600 rpm for 3 hours at 80° C. Then 6.42 g of L3360 was added to the solution and stirred at 600 rpm for 30 minutes. The SPI polyurethane solution was then pipetted into a Teflon evaporating dish with a diameter of 10 cm. The dish was dried in an oven at 45° C. overnight. After drying, the dried sample was conditioned at standard reference atmosphere (23° C., 50% humidity) for 24 hours to create a SPI polyurethane alloy film.

Tensile and DMA testing were performed as outlined in Example 1. The resulting properties of the alloy are listed in Tables 3-6.

### Example 31

Soy protein isolate (SPI) was dispersed by adding 0.5 g SPI into 15 mL of a sodium hydroxide solution at a 0.05 mol/L concentration. The dispersion was stirred with a magnetic stir bar at 600 rpm for 3 hours at 80° C. Then 6.42 g of L3360 was added to the solution and stirred at 600 rpm for 30 minutes. The SPI polyurethane solution was then pipetted into a Teflon evaporating dish with a diameter of 10 cm. The dish was dried in an oven at 45° C. overnight. After drying, the dried sample was conditioned at standard reference atmosphere (23° C., 50% humidity) for 24 hours to create a SPI polyurethane alloy film.

Tensile and DMA testing were performed as outlined in Example 1. The resulting properties of the alloy are listed in Tables 3-6.

### Example 32

Whey protein (bovine milk whey W1500 from Sigma) was dispersed by adding 0.75 g Whey into 15 mL of a sodium hydroxide solution at a 0.05 mol/L concentration. The dispersion was stirred with a magnetic stir bar at 600 rpm for 3 hours at 80° C. Then 5 g of L3360 was added to the solution and stirred at 600 rpm for 30 minutes. The whey polyurethane solution was then pipetted into a Teflon evaporating dish with a diameter of 10 cm. The dish was dried in an oven at 45° C. overnight. After drying, the dried sample was conditioned at standard reference atmosphere (23° C., 50% humidity) for 24 hours to create a whey polyurethane alloy film.

DMA testing was performed as outlined in Example 1. The resulting second storage modulus transition (taken as the onset point of the last decrease in the storage modulus measured, i.e. second DMA modulus transition onset temperature) for the whey polyurethane alloy was 100.9° C., a 14° C. decrease compared to the control in Example 1.

Tensile testing was performed as outlined in Example 1. The average Young's modulus was 105 MPa, the average tensile stress measured was 7.6 MPa, and the average elongation at break was 224% for the whey polyurethane alloy.

While the whey appears to be miscible with the hard phase of the polyurethane, it is believed that the second DMA modulus transition temperature did not increase because of the poor thermal stability of the protein itself. As discussed above, the whey had a denaturation temperature at 158° C., and was therefore considered non-thermo-stable.

### Example 33

0.75 g of casein (from bovine milk, Sigma, C7078) was added into 15 mL of DI water (pH=7) in a 20 mL glass vial without any other additives, stirred at 600 rpm, heated to 90° C., and maintained for 3 hours.

Then 5 g of L3360 was added into the 20 mL glass vial. The glass vial was capped and vortexed for 1 min at max speed. The mixed casein polyurethane liquid was then transferred into a 10 cm Teflon dish. The dish was dried in an oven at 45° C. overnight (16 to 24 hours).

After drying, the casein polyurethane alloy film had an opaque look with numerous optically visible granules in the film. The tensile properties of this film were measured by measuring five tensile specimens using an INSTRON® 5960 series machine. The samples were pulled in tension at 100 millimeters/minute until break. The average tensile strength for the film was 4.96 MPa. The average elongation at break for the film was 12.03%. The average Young's modulus of the film was 158 MPa. These results, along with the results of Example 39, indicate that casein is insoluble and not dispersible in water at pH 7, and thus does not dissolve in L3360 when mixed.

### Example 34

0.75 g of casein (from bovine milk, Sigma, C7078) was dispersed into a 15 mL 0.05 mol/L NaOH DI water solution in a 20 mL glass vial, stirred at 600 rpm, heated to 90° C., and maintained for 3 hours. A uniform dispersion was obtained.

Then 5 g of L3360 was added into the 20 mL glass vial. The glass vial was then capped and vortexed for 1 min at max speed. The mixed casein polyurethane liquid was then transferred into a 10 cm Teflon dish. The dish was dried in an oven at 45° C. overnight (16 to 24 hours).

After drying, the casein polyurethane alloy film had a transparent and uniform look with no optically visible granules in the film. The tensile properties of this film were measured by measuring five tensile specimens using an INSTRON® 5960 series machine. The samples were pulled in tension at 100 millimeters/minute until break. The average tensile strength for the film was 15.5 MPa. The average elongation at break for the film was 160%. The average Young's modulus of the film was 160 MPa. The increase modulus, strength, and elongation compared to Example 33 indicate that the modified casein dissolved within the polyurethane and is miscible with the hard phase of the polyurethane.

### Example 35

0.375 g of soy protein isolate (SPI) and 0.375 g r-Collagen were added into 15 mL of a sodium hydroxide solution at a 0.05 mol/L concentration in a 20 mL glass vial. The soy protein isolate was soy protein isolate purchased from MP Medicals (IC90545625). The r-Collagen was recombinant collagen from Modern Meadow. The solution in the vial was mixed with a magnetic stir bar at 600 rpm for 2 hours at 80° C.

Then 5 g of L3360 was added into the 20 mL glass vial. The glass vial was capped and vortexed for 1 min at max speed. The mixed SPI/r-col polyurethane liquid was then transferred into a 10 cm Teflon dish. The dish was dried in an oven at 45° C. overnight. After drying, the dried sample was conditioned at standard reference atmosphere (23° C., 50% humidity) for 24 hours to create a SPI/r-col polyurethane alloy film.

The tensile properties of this film were measured by measuring five tensile specimens using an INSTRON® 5960 series machine. The samples were pulled in tension at 100 millimeters/minute until break. The average tensile strength for the film was 15.71 MPa. The average elongation at break for the film was 175.9%. The average Young's modulus of the film was 247.1 MPa. The film was also tested using a DMA-850 from TA Instruments follow the method described in Example 1. The resulting second storage modulus transition (taken as the onset point of the last decrease in the storage modulus measured, i.e. second DMA modulus transition onset temperature) for the SPI/r-col polyurethane alloy was 184.9° C.

Compared with Example No. 1 and Example No. 9, these results show the increase in the second DMA modulus transition onset temperature, along with increased modulus and strength, and decreased elongation, indicate that the blend of SPI and r-col in the polyurethane alloy was miscible with the hard phase of the polyurethane and showed the corresponding enhancement in properties.

### Example 37

Using the same method as Example 36, a film was made with 0.375 g pea protein MTX5232 from Bobs Red Mills, 0.375 g r-Collagen (recombinant collagen from Modern Meadow) and 5 g of L3360 polyurethane dispersion.

The resulting protein polyurethane alloy film was tested using the same tensile and DMA testing methods as described for Example 36. The average tensile strength for the film was 15.36 MPa. The average elongation at break for the film was 183.17%. The average Young's modulus of the film was 231.13 MPa. The second DMA modulus transition onset temperature for the pea protein/r-col polyurethane alloy was 189.65° C.

Compared with Example No. 1 and Example No. 9, these results show the increase in the second DMA modulus transition onset temperature, along with increased modulus and strength indicate that the blend of pea protein and r-col in the protein polyurethane alloy was miscible with the hard phase of the polyurethane and showed the corresponding enhancement in properties.

### Example 38

A gelatin solution was prepared by dissolving 0.825 g (grams) of gelatin from porcine skin (Sigma Aldrich G2500) into 10 mL (milliliters) of de-ionized water and stirring with a magnetic stir bar at 1000 rpm (rotations per minute) for 1 hour at 50° C. After the gelatin was fully dissolved, the pH of the solution was adjusted to 7.0 with 0.1N sodium hydroxide. Navy Black #1684 fiber reactive dye was added to the gelatin solution at 4.05 parts per hundred parts of gelatin and mixed for 15 minutes at 45° C. Then 5.5 g of L3360 was added to the solution and stirred at 1000 rpm for 30 minutes. The polyurethane and gelatin solution was then pipetted into a Teflon evaporating dish with a diameter of 10 cm. The dish was dried in an oven at 45° C. overnight. The resulting film was evenly dyed, with no phase separation or difference in color across the sample. A comparable film of the same polyurethane dispersion without protein could not be evenly dyed.

### Example 39A

Chemically modified soy protein solutions (chemically modified SUPRO® XT 55 soy protein isolate and chemically modified SUPRO® XT 221D soy protein isolate) were prepared by preparing two 5 mL of 0.1 mol/L sodium hydroxide solutions. Once prepared, 40 milligrams (mg) of DABCO (1,4-diazabicyclo [2.2.2]octane) was added to each solution and allowed to dissolve. Upon dissolution of the DABCO, 300 mg of poly(ethylene glycol) monoglycidyl ether-550 Mn was added to each solution followed by the addition of 0.75 g of SUPRO® XT 55 soy protein isolate to one solution and 0.75 g of SUPRO® XT 221D soy protein isolate to the other solution. The solutions were allowed to stir at 600 rpm for 45 minutes at 65° C. to create chemically modified soy proteins with much higher solubility in an aqueous solution compared to the individual soy proteins in 0.1 mol/L sodium hydroxide alone without modification. The poly(ethylene glycol) monoglycidyl ether modified protein solutions were significantly more transparent compared to identical protein solutions without poly(ethylene glycol) monoglycidyl ether, indicating an increase in solubility. Additionally, size-exclusion chromatography (SEC) data indicated that the soluble modified protein solutions showed minimal hydrolysis, indicating that the protein solubility was due to the protein modification and not due to hydrolysis by the basic conditions that were used

### Example 39B

Chemically modified soy protein solutions (chemically modified SUPRO® XT 55 soy protein isolate and chemically modified SUPRO® XT 221D soy protein isolate) were prepared by preparing two 5 mL of 0.1 mol/L sodium hydroxide solution. Once prepared, 40 mg of DABCO (1,4-diazabicyclo [2.2.2]octane) was added to each solution and allowed to dissolve. Upon dissolution of the DABCO, 300 mg of poly(ethylene glycol) diglycidyl ether-550 Mn was added to the solution followed by the addition of 0.75 g SUPRO® XT 55 soy protein isolate to one solution and 0.75 g of SUPRO® XT 221D soy protein isolate to the other solution. The solutions were allowed to stir at 600 rpm for 45 minutes at 65° C. to create soy proteins with much higher solubility in an aqueous solution compared to the individual soy proteins in 0.1 mol/L sodium hydroxide alone without modification. The poly(ethylene glycol) diglycidyl ether modified protein solutions were significantly more transparent compared to identical protein solutions without poly(ethylene glycol) diglycidyl ether indicating an increase in solubility. Additionally, SEC data indicated that the soluble modified soy protein solutions showed minimal hydrolysis, indicating that the protein solubility was due to the protein modification and not due to hydrolysis by the basic conditions that were used.

### Example 40

SUPRO® XT55 soy protein isolate (SPI) was dispersed by adding 0.75 g SPI into 5 mL of a sodium hydroxide solution at a 0.1 mol/L concentration. The dispersion was stirred with a magnetic stir bar at 600 rpm for 2 hours at 65° C. HeiQ Chemtex 2317 (an anionic surfactant) was added in an amount of 5 parts per 100 parts protein by mass. Then 5 g of L3360 was added to the solution and stirred at 600 rpm for 30 minutes. The SPI polyurethane solution was then pipetted into a Teflon evaporating dish with a diameter of 10 cm. The dish was dried in an oven at 45° C. overnight. After drying, the dried sample was conditioned at standard reference atmosphere (23° C., 50% humidity) for 24 hours to create a SPI polyurethane alloy film.

### Example 41

A gelatin solution was prepared by dissolving 3.885 g of gelatin from porcine skin (Sigma Aldrich G2500) into 22 mL de-ionized water and stirring at 450 rpm using an overhead impeller mixer for 1 hour at 50° C. After the gelatin was fully dissolved, the pH of the solution was adjusted to 7.0 with 1 N sodium hydroxide. After the pH adjustment, antimicrobial Ultra-Fresh DW-56 was added at 1.2 parts per hundred parts of gelatin solution by weight. The solution was then mixed for 10 minutes at 50° C. to assure good dispersion of all the components. After 10 minutes, 15 mL of the solution was aliquoted and Antifoam 204 (a mixture of organic polyether dispersions from Sigma Aldrich) was added at 0.5 parts per hundred parts of the estimated final solution weight. The aliquoted solution was mixed for 10 minutes at 50° C. to assure good dispersion of all the components. Then, 25.885 g L3360 was added to the solution. After the addition of L3360, the solution was mixed until a temperature of 43° C. to 45° C. was reached.

To the other aliquot of the solution, HeiQ Chemtex 2216-T (a stabilized blend of nonionic and anionic surfactants) at 5.5 parts per hundreds parts and HeiQ Chemtex 2317 (a stabilized blend of nonionic and anionic surfactants) at 2.2 parts per hundreds parts of the solution weight were added along with 0.1 parts per hundreds parts of HeiQ Chemtex 2243 (a non-ionic silicone dispersion). The solution was then mechanically frothed cold until wet densities between 650 g/L to 850 g/L at a temperature of 43° C. to 45° C. were reached, thereby forming a foamed blended mixture.

A surface finish comprising a top-coat and basecoat was prepared to create the pre-skin of the protein polyurethane alloy. A top-coat blend was created by blending 9.74 parts of Stahl Melio WF-5227.A LIQ, 100 parts of Stahl WT-42-511, 30 parts of Stahl DI-17-701, 30 parts of Stahl XR-13-820, and 25 parts of water. A basecoat blend was created by blending 450 parts of Stahl RC-43-023, 50 parts of Stahl RU-3901, 150 parts of Stahl RA-30, 50 parts of Stahl FI-1208, 30 parts of Stahl XR-13-820, and 100 parts of Stahl RA-22-063.

The blended non-foamed solution was deposited on the dried pre-skin using a drawdown device at a target wet thickness of 200 gsm and dried for 15 minutes in a Mathis LTE-S Labcoater at 75° C., 2000 rpm air speed, and 70% of the air blowing from underneath the sample to form a protein polyurethane alloy layer. After this first layer was dried, a second layer of the blended foamed solution was deposited on top of the first layer at the target wet thickness of 350 gsm and dried for 15 minutes in a Mathis LTE-S Labcoater with a ramp-like drying procedure starting at 75° C. for 5 minutes, then 100° C. for 5 minutes and lastly, 120° C. for 5 minutes at 700 rpm air speed, and 70% of the air blowing from underneath to form a first foamed protein polyurethane alloy layer. After the foam layer was dried, a third layer of the blended foamed solution was deposited on top of the first foamed layer at the target wet thickness of 350 gsm and dried for 15 minutes in a Mathis LTE-S Labcoater with a ramp-like drying procedure starting at 75° C. for 5 minutes, then 100° C. for 5 minutes and lastly, 120° C., 700 rpm air speed, and 70% of the air blowing from underneath to form a second foamed protein polyurethane alloy layer.

After the sample was fully dried and conditioned for 24 hours in a conditioning chamber at 23° C. and 50% humidity for 24 hours, the sample was cut and tested according to the DMA and tensile mechanical property tests described herein. The resulting second storage modulus transition (taken as the onset point of the last decrease in the storage modulus measured, i.e. second DMA modulus transition onset temperature) was 190° C., the Young's modulus was 88.9 MPa, the tensile stress was 5.4 MPa, and the elongation at break was 110%.

### Example 42

A sample was prepared by dissolving 1 g of 50 KDa rCol into 5 mL of de-ionized water and stirring with a magnetic stir bar at 1000 rpm for 1 hour at 20° C. The 50 KDa rCol protein was a collagen fragment prepared by Modern Meadow comprising the amino acid sequence listed as SEQ ID NO: 1. After stirring for 1 hour, 6.7 g of L3360 was added to the solution and stirred at 1000 rpm for 30 minutes. The polyurethane and 50 KDa rCol solution was then pipetted into a Teflon evaporating dish with a diameter of 10 cm. The dish was dried in an oven at 45° C. overnight. After drying, the dried sample was conditioned at standard reference atmosphere (23° C., 50% humidity) for 24 hours to create a 50 KDa rCol polyurethane alloy film.

DMA testing was performed as outlined in Example 1. The resulting second storage modulus transition (taken as the onset point of the last decrease in the storage modulus measured, i.e. second DMA modulus transition onset temperature) for the 50 KDa rCol polyurethane alloy was 177.8° C., a 62.9° C. increase over the control sample described in Example 1.

Tensile testing was performed as outlined in Example 1. The average Young's modulus was 161 MPa, the average tensile stress measured was 17 MPa, and the average elongation at break was 173% for the 50 KDa rCol polyurethane alloy.

### Example 43

A sample was prepared by dissolving 1 g of Native Trichoderma sp. Cellulase available from CREATIVE ENZYMES® (Cellulase-RG) into 5 mL of de-ionized water and stirring with a magnetic stir bar at 1000 rpm for 1 hour at 20° C. After stirring for 1 hour, 11.4 g of L3360 was added to the solution and stirred at 1000 rpm for 30 minutes. The polyurethane and cellulase solution was then pipetted into a Teflon evaporating dish with a diameter of 10 cm. The dish was dried in an oven at 45° C. overnight. After drying, the dried sample was conditioned at standard reference atmosphere (23° C., 50% humidity) for 24 hours to create a cellulase polyurethane alloy film.

DMA testing was performed as outlined in Example 1. The resulting second storage modulus transition (taken as the onset point of the last decrease in the storage modulus measured, i.e. second DMA modulus transition onset temperature) for the Celluase-RG polyurethane alloy was 153.1° C., a 38.2° C. increase over the control sample described in Example 1.

Tensile testing was performed as outlined in Example 1. The average Young's modulus was 184 MPa, the average tensile stress measured was 14.7 MPa, and the average elongation at break was 252% for the cellulase polyurethane alloy.

### Example 44

A sample was prepared by dissolving 1 g of laboratory grade cellulase available from Carolina Biological Supply Company (Cellulase-IG) into 5 mL of de-ionized water and stirring with a magnetic stir bar at 1000 rpm for 1 hour at 20° C. After stirring for 1 hour, 11.4 g of L3360 was added to the solution and stirred at 1000 rpm for 30 minutes. The polyurethane and cellulase solution was then pipetted into a Teflon evaporating dish with a diameter of 10 cm. The dish was dried in an oven at 45° C. overnight. After drying, the dried sample was conditioned at standard reference atmosphere (23° C., 50% humidity) for 24 hours to create a cellulase polyurethane alloy film.

DMA testing was performed as outlined in Example 1. The resulting second storage modulus transition (taken as the onset point of the last decrease in the storage modulus measured, i.e. second DMA modulus transition onset temperature) for the Cellulase-IG polyurethane alloy was 122.1° C., a 7.2° C. increase over the control sample described in Example 1.

Tensile testing was performed as outlined in Example 1. The average Young's modulus was 84 MPa, the average tensile stress measured was 15.1 MPa, and the average elongation at break was 286% for the cellulase polyurethane alloy.

### Example 45

Two control samples (Example No. 45a and Example No. 45b) were each prepared according to the following process. 0.4 g of AF-715 (an antifoaming agent available from Quaker Color) was mixed into 38 g of waterborne polyurethane dispersion Hauthane HD-2001 from C. L. Hauthaway & Sons Corporation. The mixture was mixed using an impeller at a rate of 500 rpm and allowed to stir for 5 minutes at room temperature. After the mixture was properly mixed, 0.6 g BORCHI® Gel L 75 N was added to increase the viscosity of the mixture and the mixture was allowed to mix for 5 minutes. The mixture was then coated using a Mathis LTE-S Labcoater coater onto a release paper and was dried at 75° C. for 10 minutes and at 100° C. for 10 minutes. The coating was then removed from the release paper to create a polyurethane film containing no protein.

After drying, the sample for Example 45a had a thickness of 0.4 mm and the sample for Example 45b had a thickness of 0.4 mm. As reported in Table 7, the polyurethane film of Example 45a had a moisture vapor transmission rate of 30 g/m²/24 hr and polyurethane film of Example 45b had a moisture vapor transmission rate of 38 g/m²/24 hr.

### Example 46

Two samples (Example No. 46a and Example No. 46b) were each prepared according to the following process. 13.25 g of gelatin from porcine skin was dissolved in a solution of 2 g of antimicrobial Ultra-Fresh DW-56, 0.8 g of AF-715 (an antifoaming agent available from Quaker Color), and 75 mL of water at 50° C. The solution was stirred using an impeller at 500 rpm until the gelatin was fully dissolved. The pH of the solution was then increased using 1 M NaOH until a pH of 8-9 was achieved. After adjusting the pH, 77 g of waterborne polyurethane dispersion Hauthane HD-2001 from C. L. Hauthaway & Sons Corporation was added to the gelatin solution and stirred for 15 minutes. After the gelatin and polyurethane solution was properly mixed, 1 g of RM-4410 from Stahl was added to increase the viscosity of the solution and the solution was mixed for 5 minutes. The solution was then coated on a 0.35 mm thick microsuede textile having a surface coated with a thin IMPRANIL® DLS coating layer (thickness of 0.03 mm). The gelatin polyurethane solution was coated on top of the thin IMPRANIL® DLS coating layer using a handheld draw down apparatus and was allowed to dry at standard reference atmosphere (23° C. and 50% humidity) to create a gelatin-polyurethane film with a textile backing. The thin IMPRANIL® DLS coating was used to prevent the gelatin polyurethane coating from deeply penetrating into the microsuede textile.

After drying, the sample for Example No. 46a had a thickness of 0.77 mm (which was the sum of the thicknesses for the gelatin-polyurethane film, the thin IMPRANIL® DLS coating, and the microsuede textile) and the sample for Example 46b had a thickness of 0.82 mm (which was the sum of the thicknesses for the gelatin-polyurethane film, the thin Impranil® DLS coating, and the microsuede textile).

As reported in Table 7, the sample for Example No. 46a had a moisture vapor transmission rate of 180 g/m²/24 hr, which was a 150 g/m²/24 hr increase compared to the sample of Example No. 45a and a 142 g/m²/24 hr increase compared to the sample of Example No. 45b. As also reported in Table 7, the sample for Example No. 46b had a moisture vapor transmission rate of 138 g/m²/24 hr, which was a 108 g/m²/24 hr increase compared to the sample of Example No. 45a and a 100 g/m²/24 hr increase compared to the sample of Example No. 45b.

Neither the thin IMPRANIL® DLS coating nor the microsuede textile had a significant influence on the moisture vapor transmission rates for the samples of Example Nos. 46a or 46b. In other words, the moisture vapor transmission rates reported in Table 7 reflect the moisture vapor transmission rates for only the gelatin-polyurethane films.

### Example 47

Two control samples (Example No. 47a and Example No. 47b) were each prepared according to the following process. 0.4 g of AF-715 (an antifoaming agent available from Quaker Color) was mixed into 38 g of waterborne polyurethane dispersion L3360 from Hauthaway. The mixture was mixed using an impeller at a rate of 500 rpm and allowed to stir for 5 minutes at room temperature. After the mixture was properly mixed, 0.6 g BORCHI® Gel L 75 N was added to increase the viscosity of the mixture and the mixture was allowed to mix for 5 minutes. The mixture was then coated using a Mathis LTE-S Labcoater coater onto a release paper and was dried at 75° C. for 10 minutes and at 100° C. for 10 minutes. The coating was then removed from the release paper to create a polyurethane film containing no protein.

After drying, the sample for Example No. 47a had a thickness of 0.32 mm and the sample for Example No. 47b had a thickness of 0.36 mm. As reported in Table 7, the polyurethane film of Example No. 47a had a moisture vapor transmission rate of 23 g/m²/24 hr and polyurethane film of Example No. 47b had a moisture vapor transmission rate of 27 g/m²/24 hr.

### Example 48

Two samples (Example No. 48a and Example No. 48b) were each prepared according to the following process. 13.25 g of gelatin from porcine skin was dissolved in a solution of 2 g of antimicrobial Ultra-Fresh DW-56, 0.8 g of AF-715 (an antifoaming agent available from Quaker Color), and 75 mL of water at 50° C. The solution was stirred using an impeller at 500 rpm until the gelatin was fully dissolved. The pH of the solution was then increased using 1 M NaOH until a pH of 8-9 was achieved. After adjusting the pH, 77 g of waterborne polyurethane dispersion L3360 from Hauthaway was added to the gelatin solution and stirred for 15 minutes. After the gelatin and polyurethane solution was properly mixed, 1 g of RM-4410 from Stahl was added to increase the viscosity of the solution and the solution was mixed for 5 minutes. The solution was then coated on a 0.35 mm thick microsuede textile having a surface coated with a thin IMPRANIL® DLS coating layer (thickness of 0.03 mm). The gelatin and polyurethane solution was coated on top of the thin IMPRANIL® DLS coating layer using a handheld draw down apparatus and was allowed to dry at standard reference atmosphere (23° C. and 50% humidity) to create a gelatin-polyurethane film with a textile backing. The thin IMPRANIL® DLS coating was used to prevent the gelatin polyurethane coating from deeply penetrating into the microsuede textile.

After drying, the sample for Example No. 48a had a thickness of 0.77 mm (which was the sum of the thicknesses for the gelatin-polyurethane film, the thin IMPRANIL® DLS coating, and the microsuede textile) and the sample for Example No. 48b had a thickness of 0.84 mm (which was the sum of the thicknesses for the gelatin-polyurethane film, the thin Impranil® DLS coating, and the microsuede textile).

As reported in Table 7, the sample for Example No. 48a had a moisture vapor transmission rate of 117 g/m²/24 hr, which was a 94 g/m²/24 hr increase compared to the sample of Example No. 47a and a 90 g/m²/24 hr increase compared to the sample of Example No. 47b. As also reported in Table 7, the sample for Example 48b had a moisture vapor transmission rate of 74 g/m²/24 hr, which was a 51 g/m²/24 hr increase compared to the sample of Example No. 47a and a 47 g/m²/24 hr increase compared to the sample of Example No. 47b.

Neither the thin IMPRANIL® DLS coating nor the microsuede textile had a significant influence on the moisture vapor transmission rates for the samples of Example Nos. 46a or 46b. In other words, the moisture vapor transmission rates reported in Table 7 reflect the moisture vapor transmission rates for only the gelatin-polyurethane films.

### Example 49

Two control samples (Example No. 49a and Example No. 49b) were each prepared according to the following process. 0.2 g of AF-715 (an antifoaming agent available from Quaker Color) was mixed into 38 g of waterborne polyurethane dispersion L3360 from Hauthaway. The mixture was mixed using an impeller at a rate of 500 rpm for 5 minutes. After the mixture was properly mixed, 0.6 g BORCHI® Gel L 75 N was added to increase the viscosity of the mixture and the mixture was mixed again for 5 minutes. This polyurethane mixture was then coated onto a release paper using a Mathis LTE-S Labcoater and allowed to dry at 75° C. for 10 minutes and at 100° C. for 10 minutes.

Then a foam solution was then prepared by mixing waterborne polyurethane dispersion L3360 from Hauthaway with HeiQ Chemtex 2216-T (3% based on solution weight), HeiQ Chemtex 2317 (3% based on solution weight), HeiQ Chemtex 2241-A (1% based on solution weight), and HeiQ Chemtex 2243 (0.1% based on solution weight). This mixture was stirred for 5 minutes at room temperature using an impeller at 500 rpm. The mixture was then frothed to create a foamed mixture having a wet density between 700 g/L and 900 g/L. The foamed mixture was coated on the previously coated polyurethane layer using the Mathis LTE-S Labcoater and allowed to dry at 75° C. for 10 minutes and at 100° C. for 10 minutes. After this first foamed coating was dried, a second foamed coating layer made of the same foamed mixture was coated on the first foamed coating using identical conditions. After drying of the second foamed layer, the three-layer sample was removed from the release paper.

The three-layer sample for Example No. 49a had a thickness of 0.23 mm and the three-layer sample for Example No. 49b had a thickness of 0.24 mm. As reported in Table 7, the three-layer sample of Example No. 49a had a moisture vapor transmission rate of 83 g/m²/24 hr and the three-layer sample of Example No. 49b had a moisture vapor transmission rate of 87 g/m²/24 hr.

### Example 50

Two samples (Example No. 50a and Example No. 50b) were each prepared according to the following process. 5.3 g of SUPRO® XT 221D soy protein isolate was mixed with 30 g of water. The pH of the mixture was then increased using 1 M NaOH until a pH of 8-9 was achieved. After adjusting the pH, Ultra-Fresh DW-56 (15 wt % based on the soy protein isolate mass) and AF-715 antifoaming agent (1 wt % based on solution weight) were added and to the mixture, and the mixture was stirred using an impeller at 500 rpm until the soy protein isolate was fully dissolved. Once the soy protein isolate was fully dissolved, 32 g of waterborne polyurethane dispersion L3360 from Hauthaway was added to the protein solution and the solution was stirred using an impeller at a rate of 500 rpm for 10 minutes at room temperature. The protein solution was then coated onto a release paper using a Mathis LTE-S Labcoater and allowed to dry at 75° C. for 10 minutes and at 100° C. for 10 minutes.

Then a foam solution was prepared by mixing 5.3 g SUPRO® XT 221D soy protein isolate with 30 g of water. The pH of the mixture was increased using 1 M NaOH until a pH of 8-9 was achieved. After adjusting the pH and once the soy protein isolate was fully dissolved, Ultra-Fresh DW-56 (15 wt % based on the soy protein mass), HeiQ Chemtex 2216-T (3 wt % based on solution weight), HeiQ Chemtex 2317 (3% based on solution weight), HeiQ Chemtex 2241-A (1% based on solution weight), HeiQ Chemtex 2243 (0.1% based on solution weight), 32 g of waterborne polyurethane dispersion L3360 from Hauthaway were added to the solution, and the solution was stirred for 5 minutes at room temperature using an impeller at 500 rpm. This solution was then frothed to create a foam solution with a wet density between 700 g/L and 900 g/L. The foam solution was coated on the previously coated protein solution layer using the Mathis LTE-S Labcoater and allowed to dry at 75° C. for 10 minutes and at 100° C. for 10 minutes. After this first foamed solution coating was dried, a second foam layer was coated on the first foamed coating using identical conditions After drying of the second foam solution layer, the three-layer sample was removed from the release paper.

The three-layer sample for Example No. 50a had a thickness of 0.24 mm and the three-layer sample for Example No. 50b had a thickness of 0.25 mm. As reported in Table 7, the sample for Example No. 50a had a moisture vapor transmission rate of 268 g/m²/24 hr, which was a 185 g/m²/24 hr increase compared to the sample of Example No. 49a and a 181 g/m²/24 hr increase compared to the sample of Example No. 49b. As also reported in Table 7, the sample for Example No. 50b had a moisture vapor transmission rate of 277 g/m²/24 hr, which was a 194 g/m²/24 hr increase compared to the sample of Example No. 49a and a 190 g/m²/24 hr increase compared to the sample of Example No. 49b.

### Example 51

A control sample was prepared by mixing 0.4 g of AF-715 (an antifoaming agent available from Quaker Color) into 38 g of waterborne polyurethane dispersion IMPRAPERM® DL 5249 from Covestro. The mixture was mixed using an impeller at a rate of 500 rpm and allowed to stir for 5 minutes at room temperature. After the mixture was properly mixed, 0.6 g BORCHI® Gel L 75 N was added to increase the viscosity of the mixture and the mixture was allowed to mix for 5 minutes. The mixture was then coated using a Mathis LTE-S Labcoater coater onto a release paper and was dried at 75° C. for 10 minutes and at 100° C. for 10 minutes. The coating was then removed from the release paper to create a polyurethane film containing no protein.

After drying, the sample had a thickness of 0.08 mm. As reported in Table 7, the polyurethane film had a moisture vapor transmission rate of 338 g/m²/24 hr.

### Example 52

Two samples (Example No. 52a and Example No. 52b) were each prepared according to the following process. 5.3 g of SUPRO® XT 221D soy protein isolate was mixed with 30 g of water. The pH of the mixture was then increased using 1 M NaOH until a pH of 8-9 was achieved. After adjusting the pH, Ultra-Fresh DW-56 (15 wt % based on the soy protein isolate mass) and AF-715 antifoaming agent (1 wt % based on solution weight) were added and to the mixture, and the mixture was stirred using an impeller at 500 rpm until the soy protein isolate was fully dissolved. Once the soy protein isolate was fully dissolved, 32 g of waterborne polyurethane dispersion IMPRAPERM® DL 5249 from Covestro was added to the protein solution and the solution was stirred using an impeller at a rate of 500 rpm for 10 minutes at room temperature. The protein solution was then coated onto a release paper using a Mathis LTE-S Labcoater and allowed to dry at 75° C. for 10 minutes and at 100° C. for 10 minutes.

Then a foam solution was prepared by mixing 5.3 g SUPRO® XT 221D soy protein isolate with 30 g of water. The pH of the mixture was increased using 1 M NaOH until a pH of 8-9 was achieved. After adjusting the pH and once the soy protein isolate was fully dissolved, Ultra-Fresh DW-56 (15 wt % based on the soy protein mass), HeiQ Chemtex 2216-T (3 wt % based on solution weight), HeiQ Chemtex 2317 (3% based on solution weight), HeiQ Chemtex 2241-A (1% based on solution weight), HeiQ Chemtex 2243 (0.1% based on solution weight), 32 g of waterborne polyurethane dispersion IMPRAPERM® DL 5249 from Covestro were added to the solution, and the solution was stirred for 5 minutes at room temperature using an impeller at 500 rpm. This solution was then frothed to create a foamed solution with a wet density between 700 g/L and 900 g/L. The foamed solution was coated on the previously coated protein solution layer using the Mathis LTE-S Labcoater and allowed to dry at 75° C. for 10 minutes and at 100° C. for 10 minutes. After this first foamed coating was dried, a second foamed layer was coated on the first foamed coating using identical conditions After drying of the second foamed solution layer, the three-layer sample was removed from the release paper.

The three-layer sample for Example No. 52a had a thickness of 0.22 mm and the three-layer sample for Example No. 52b had a thickness of 0.23 mm. As reported in Table 7, the sample for Example 52a had a moisture vapor transmission rate of 626 g/m²/24 hr and the sample for Example 52b had a moisture vapor transmission rate of 644 g/m²/24 hr. For purposes of evaluating a change in moisture vapor transmission rate, these moisture vapor transmission rates for Example Nos. 52a and 52b can be compared to the moisture vapor transmission rate of Example No. 51 because all three samples included a non-foamed layer made using IMPRAPERM® DL 5249 and having substantially the same thickness. The foamed layers of Example Nos. 52a and 52b did not have a significant influence on the moisture vapor transmission rates for these samples because of their high degree of porosity. Compared to the sample of Example No. 51, the sample of Example No. 52a showed a 288 g/m²/24 hr increase in moisture vapor transmission and the sample of Example No. 52b showed a 306 g/m²/24 hr increase in moisture vapor transmission.

### Example 53

A control sample was prepared by mixing 0.2 g of AF-715 (an antifoaming agent available from Quaker Color) into 38 g of waterborne polyurethane dispersion IMPRAPERM® DL 5249 from Covestro. The mixture was mixed using an impeller at a rate of 500 rpm for 5 minutes. After the mixture was properly mixed, 0.6 g BORCHI® Gel L 75 N was added to increase the viscosity of the mixture and the mixture was mixed again for 5 minutes. This polyurethane mixture was then coated onto a release paper using a Mathis LTE-S Labcoater and allowed to dry at 75° C. for 10 minutes and at 100° C. for 10 minutes.

Then a foam solution was then prepared by mixing waterborne polyurethane dispersion L3360 from Hauthaway with HeiQ Chemtex 2216-T (3% based on solution weight), HeiQ Chemtex 2317 (3% based on solution weight), HeiQ Chemtex 2241-A (1% based on solution weight), and HeiQ Chemtex 2243 (0.1% based on solution weight). This mixture was stirred for 5 minutes at room temperature using an impeller at 500 rpm. The mixture was then frothed to create a foamed mixture having a wet density between 700 g/L and 900 g/L. The foamed mixture was coated on the previously coated polyurethane layer using the Mathis LTE-S Labcoater and allowed to dry at 75° C. for 10 minutes and at 100° C. for 10 minutes. After this first foamed coating was dried, a second foamed coating layer made of the same L3360 foamed mixture was coated on the first foamed coating using identical conditions. After drying of the second foamed layer, the three-layer sample was removed from the release paper.

The three-layer sample for Example No. 53 had a thickness of 0.32 mm. As reported in Table 7, the three-layer sample of Example No. 53 had a moisture vapor transmission rate of 84 g/m²/24 hr.

### Example 54

A sample was prepared by mixing 5.3 g of SUPRO® XT 221D soy protein isolate with 30 g of water. The pH of the mixture was increased using 1 M NaOH until a pH of 8-9 was achieved. After adjusting the pH, Ultra-Fresh DW-56 (15 wt % based on the soy protein isolate mass) and AF-715 antifoaming agent (1 wt % based on solution weight) were added and to the mixture, and the mixture was stirred using an impeller at 500 rpm until the soy protein isolate was fully dissolved. Once the soy protein isolate was fully dissolved, 53.7 g of waterborne polyurethane dispersion IMPRAPERM® DL 5249 from Covestro was added to the protein solution and the solution was stirred using an impeller at a rate of 500 rpm for 10 minutes at room temperature. The protein solution was then coated onto a release paper using a Mathis LTE-S Labcoater and allowed to dry at 75° C. for 10 minutes and at 100° C. for 10 minutes.

Then a foam solution was prepared by mixing 5.3 g SUPRO® XT 221D soy protein isolate with 30 g of water. The pH of the mixture was increased using 1 M NaOH until a pH of 8-9 was achieved. After adjusting the pH and once the soy protein isolate was fully dissolved, Ultra-Fresh DW-56 (15 wt % based on the soy protein mass), HeiQ Chemtex 2216-T (3 wt % based on solution weight), HeiQ Chemtex 2317 (3% based on solution weight), HeiQ Chemtex 2241-A (1% based on solution weight), HeiQ Chemtex 2243 (0.1% based on solution weight), 53.7 g of waterborne polyurethane dispersion L3360 from Hauthaway were added to the solution, and the solution was stirred for 5 minutes at room temperature using an impeller at 500 rpm. This solution was then frothed to create a foamed solution with a wet density between 700 g/L and 900 g/L. The foamed solution was coated on the previously coated protein solution layer using the Mathis LTE-S Labcoater and allowed to dry at 75° C. for 10 minutes and at 100° C. for 10 minutes. After this first foamed solution coating was dried, a second foam L3360 layer was coated on the first foamed coating using identical conditions After drying of the second foam solution layer, the three-layer sample was removed from the release paper.

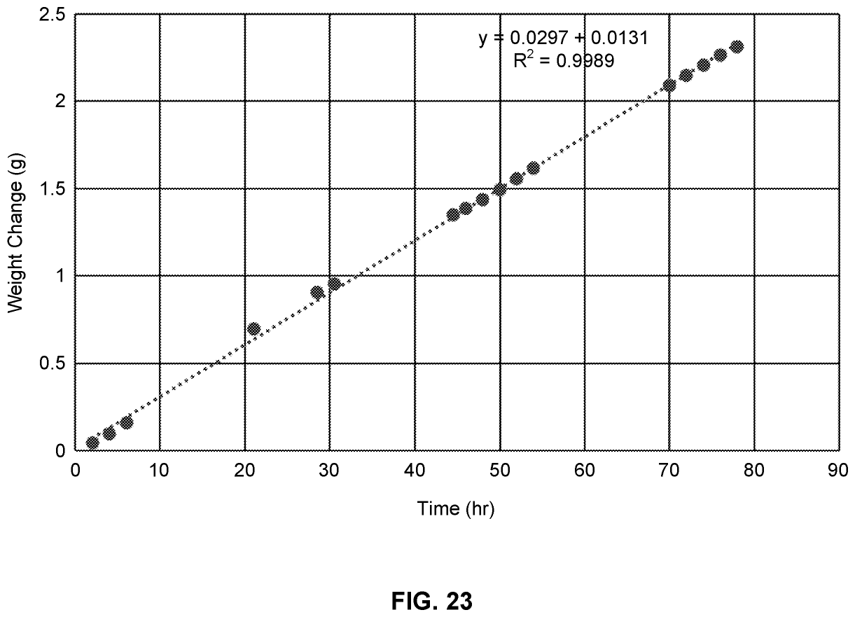

The three-layer sample for Example No. 54 had a thickness of 0.32 mm. As reported in Table 7, the sample for Example No. 54 had a moisture vapor transmission rate of 166 g/m²/24 hr, which was a 82 g/m²/24 hr increase compared to the sample of Example No. 53. The graph of FIG. 23 shows that the breathability for the sample of Example No. 54 is consistent over time. The amount of water transported through the sample increased linearly with time during the breathability test. The graph of FIG. 23 shows that the protein in the protein polyurethane alloy does not cause any significant fluctuations in the alloy's breathability over time.

### Example 55

A control sample was prepared by mixing 0.4 g of AF-715 (an antifoaming agent from Quaker Color) into 38 g of waterborne polyurethane dispersion composed of 25 wt % IMPRAPERM® DL 5249 from Covestro and 75 wt % L3360 from Hauthaway. The mixture was mixed using an impeller at a rate of 500 rpm and allowed to stir for 5 minutes at room temperature. After the mixture was properly mixed, 0.6 g BORCHI® Gel L 75 N was added to increase the viscosity of the mixture and the mixture was allowed to mix for 5 minutes. The mixture was then coated using a Mathis LTE-S Labcoater coater onto a release paper and was dried at 75° C. for 10 minutes and at 100° C. for 10 minutes. The coating was then removed from the release paper to create a polyurethane film containing no protein.

After drying, the sample had a thickness of 0.07 mm. As reported in Table 7, the polyurethane film had a moisture vapor transmission rate of 168 g/m²/24 hr.

### Example 56

A sample was prepared by mixing 5.3 g of SUPRO® XT 221D soy protein isolate with 30 g of water. The pH of the mixture was increased using 1 M NaOH until a pH of 8-9 was achieved. After adjusting the pH, Ultra-Fresh DW-56 (15 wt % based on the soy protein isolate mass) and AF-715 antifoaming agent (1 wt % based on solution weight) were added and to the mixture, and the mixture was stirred using an impeller at 500 rpm until the soy protein isolate was fully dissolved. Once the soy protein isolate was fully dissolved, 53.7 g of waterborne polyurethane dispersion composed of 25 wt % IMPRAPERM® DL 5249 from Covestro and 75 wt % L3360 from Hauthaway was added to the protein solution and the solution was stirred using an impeller at a rate of 500 rpm for 10 minutes at room temperature. The protein solution was then coated onto a release paper using a Mathis LTE-S Labcoater and allowed to dry at 75° C. for 10 minutes and at 100° C. for 10 minutes.

After drying, the sample had a thickness of 0.05 mm. As reported in Table 7, the sample had a moisture vapor transmission rate of 266 g/m²/24 hr, which was a 98 g/m²/24 hr increase compared to the sample of Example No. 55.

### Example Tables

The following Tables 3-6 report the DMA and mechanical property test results for Example Nos. 1-31. The “Sancure” polyurethane in the tables is SANCURE™ 20025F, an aliphatic polyester polyurethane dispersion at 47% solids in water from Lubrizol. The “Impranil DLS” polyurethane is IMPRANIL® DLS, an aliphatic polyester polyurethane with 50% solids content in water from Covestro. The “L2996” polyurethane is an aliphatic polycarbonate polyurethane dispersion with 35% solids content in water from Hauthaway. The “Gelatin” protein is type A porcine skin gelatin G2500 from Sigma. The “SPI” protein is soy protein isolate IC90545625 from MP Medicals. The “Collagen” protein is bovine collagen from Wuxi BIOT biology technology in China. The “BSA” protein is bovine serum albumin 5470 from Sigma. The “rCol” protein recombinant bovine collagen prepared in yeast from Modern Meadow. The “Albumin” protein is chicken egg white albumin A5253 from Sigma. The “Pea” protein is pea protein powder MTX5232 from Bobs Red Mills. The “Peanut” protein is peanut protein powder from Tru-Nut. Table 7 reports the moisture vapor transmission rate test results for Example Nos. 45-56.

TABLE 3
Second DMA Modulus Transition Onset Temperatures

| | | | | | 2nd | |
|---|---|---|---|---|---|---|
| | | | | | Modulus | Delta 2nd |
| | | | | | Transition | Modulus |
| | | | Protein | PU | Onset | Transition |
| Ex. No. | PU | Protein | (wt %) | (wt %) | (° C.) | Onset |
| 1 | L3360 | None | 0% | 100% | 114.9 | — |
| 2 | UD-108 | None | 0% | 100% | 127.4 | — |
| 3 | UD-250 | None | 0% | 100% | 160.8 | — |
| 4 | UD-303 | None | 0% | 100% | 158.1 | — |
| 5 | Impranil DLS | None | 0% | 100% | 146.4 | — |
| 6 | Sancure | None | 0% | 100% | 49.6 | — |
| 7 | HD-2001 | None | 0% | 100% | 128 | — |
| 8 | L2996 | None | 0% | 100% | 186.2 | — |
| 9 | L3360 | Gelatin | 30% | 70% | 180.6 | 65.7 |
| 10 | UD-108 | Gelatin | 30% | 70% | 184.9 | 57.5 |
| 11 | UD-250 | Gelatin | 30% | 70% | 186.1 | 25.3 |
| 12 | Impranil DLS | Gelatin | 30% | 70% | 190.4 | 44 |
| 13 | UD-303 | Gelatin | 30% | 70% | 179.5 | 21.4 |
| 14 | Sancure | Gelatin | 30% | 70% | 188 | 138.4 |
| 15 | HD2001 | Gelatin | 30% | 70% | 184.9 | 56.9 |
| 16 | L2996 | Gelatin | 30% | 70% | 187.1 | — |
| 17 | L3360 | Collagen | 30% | 70% | 180.3 | 65.4 |
| 18 | L3360 | rCol | 30% | 70% | 175.4 | 60.5 |
| 19 | L3360 | Albumen | 30% | 70% | 168.4 | 53.5 |
| 20 | L3360 | BSA | 30% | 70% | 184.9 | 70 |
| 21 | L3360 | SPI (pH 10) | 30% | 70% | 186.6 | 71.7 |
| 22 | L3360 | Pea | 30% | 70% | 186.2 | 71.3 |
| 23 | L3360 | Peanut | 30% | 70% | 151.92 | 37 |
| 24 | L3360 | Gelatin | 50% | 50% | — | — |
| 35 | L3360 | Gelatin | 20% | 80% | 184 | 69.1 |
| 26 | L3360 | Gelatin | 15% | 85% | 138.3 | 23.4 |
| 27 | L3360 | Gelatin | 10% | 90% | 122.9 | 8 |
| 28 | L3360 | Gelatin | 5% | 95% | 134.2 | 19.3 |
| 29 | L3360 | Gelatin | 1% | 99% | — | — |
| 30 | L3360 | SPI raw | 10% | 90% | 133.9 | 19 |
| 31 | L3360 | SPI (pH 8) | 20% | 80% | 187.1 | 72.2 |
| 42 | L3360 | 50 KDa rCol | 30% | 70% | 177.8 | 62.9 |
| 43 | L3360 | Cellulase-RG | 20% | 80% | 153.1 | 38.2 |
| 44 | L3360 | Cellulase-IG | 20% | 80% | 122.1 | 7.2 |

TABLE 4
First DMA Modulus Transition Onset Temperatures & Soft Phase tan(δ) Peak Temperatures

| | | | | | | 1st | Delta | Delta 1st |
|---|---|---|---|---|---|---|---|---|
| | | | | | Tan(δ) | Modulus | Tan(δ) | Modulus |
| | | | | | peak | Transition | Peak | Transition |
| | | | Protein | PU | Temp. | Onset | Temp. | Onset |
| Ex. No. | PU | Protein | (wt %) | (wt %) | (° C.) | (° C.) | (° C.) | (° C.) |
| 1 | L3360 | None | 0% | 100% | −33 | −50 | — | — |
| 2 | UD-108 | None | 0% | 100% | −46 | −58 | — | — |
| 3 | UD-250 | None | 0% | 100% | −30 | — | — | — |
| 4 | UD-303 | None | 0% | 100% | −45 | −59 | — | — |
| 5 | Impranil DLS | None | 0% | 100% | −29 | −44 | — | — |
| 6 | Sancure | None | 0% | 100% | −39 | −50 | — | — |
| 7 | HD-2001 | None | 0% | 100% | −20 | −35 | — | — |
| 8 | L2996 | None | 0% | 100% | −20 | — | — | — |
| 9 | L3360 | Gelatin | 30% | 70% | −39 | −53 | −6 | −3 |
| 10 | UD-108 | Gelatin | 30% | 70% | −47 | −57 | −1 | 1 |
| 11 | UD-250 | Gelatin | 30% | 70% | −30 | — | 0 | — |
| 12 | Impranil DLS | Gelatin | 30% | 70% | −36 | −47 | −7 | −3 |
| 13 | UD-303 | Gelatin | 30% | 70% | −52 | −63 | −7 | −4 |
| 14 | Sancure | Gelatin | 30% | 70% | −46 | −55 | −7 | −5 |
| 15 | HD2001 | Gelatin | 30% | 70% | −20 | −36 | 0 | −1 |
| 16 | L2996 | Gelatin | 30% | 70% | | | | |
| 17 | L3360 | Collagen | 30% | 70% | −35 | −49 | −2 | 1 |
| 18 | L3360 | rCol | 30% | 70% | −33 | −49 | 0 | 1 |
| 19 | L3360 | Albumen | 30% | 70% | −36 | −52 | −3 | −2 |
| 20 | L3360 | BSA | 30% | 70% | −35 | −49 | −2 | 1 |
| 21 | L3360 | SPI (pH 10) | 30% | 70% | −38 | −53 | −5 | −3 |
| 22 | L3360 | Pea | 30% | 70% | −33 | −52 | 0 | −2 |
| 23 | L3360 | Peanut | 30% | 70% | −41 | −53 | −8 | −3 |
| 24 | L3360 | Gelatin | 50% | 50% | −38 | −52 | −5 | −2 |
| 25 | L3360 | Gelatin | 20% | 80% | −32 | −49 | 1 | 1 |
| 26 | L3360 | Gelatin | 15% | 85% | −34 | −51 | −1 | −1 |
| 27 | L3360 | Gelatin | 10% | 90% | −33 | −47 | 0 | 3 |
| 28 | L3360 | Gelatin | 5% | 95% | −34 | −49 | −1 | 1 |
| 29 | L3360 | Gelatin | 1% | 99% | — | — | — | — |
| 30 | L3360 | SPI raw | 10% | 90% | −36 | −49 | −3 | 1 |
| 31 | L3360 | SPI (pH 8) | 20% | 80% | −36 | −51 | −3 | −1 |
| 42 | L3360 | 50 KDa rCol | 30% | 70% | −31 | −47 | 2 | 3 |
| 43 | L3360 | Cellulase-RG | 20% | 80% | −34 | −48 | −1 | 2 |
| 44 | L3360 | Cellulase-IG | 20% | 80% | −33 | −48 | 0 | 2 |

TABLE 5
Tensile Strength

| | | | | | Tensile | Delta | % Delta |
|---|---|---|---|---|---|---|---|
| | | | Protein | PU | Strength | Tensile | Tensile |
| Ex. No. | PU | Protein | (wt %) | (wt %) | (MPa) | Strength | Strength |
| 1 | L3360 | None | 0% | 100% | 12.9 | — | — |
| 2 | UD-108 | None | 0% | 100% | 19.4 | — | — |
| 3 | UD-250 | None | 0% | 100% | 26.4 | — | — |
| 4 | UD-303 | None | 0% | 100% | 16.7 | — | — |
| 5 | Impranil DLS | None | 0% | 100% | 15.1 | — | — |
| 6 | Sancure | None | 0% | 100% | 1.4 | — | — |
| 7 | HD-2001 | None | 0% | 100% | 33 | — | — |
| 8 | L2996 | None | 0% | 100% | — | — | — |
| 9 | L3360 | Gelatin | 30% | 70% | 19.8 | 6.9 | 53.8 |
| 10 | UD-108 | Gelatin | 30% | 70% | 23.1 | 3.7 | 19.1 |
| 11 | UD-250 | Gelatin | 30% | 70% | — | — | — |
| 12 | Impranil DLS | Gelatin | 30% | 70% | 17.9 | 2.8 | 18.5 |
| 13 | UD-303 | Gelatin | 30% | 70% | 23.2 | 6.5 | 38.9 |
| 14 | Sancure | Gelatin | 30% | 70% | 15.3 | 13.9 | 993 |
| 15 | HD2001 | Gelatin | 30% | 70% | 17.9 | −15.1 | −45.8 |
| 16 | L2996 | Gelatin | 30% | 70% | — | — | — |
| 17 | L3360 | Collagen | 30% | 70% | 17.3 | 4.4 | 34.4 |
| 18 | L3360 | rCol | 30% | 70% | 16.8 | 3.9 | 29.9 |
| 19 | L3360 | Albumen | 30% | 70% | 14.8 | 1.9 | 14.9 |
| 20 | L3360 | BSA | 30% | 70% | 11.7 | −1.2 | −9.1 |
| 21 | L3360 | SPI (pH 10) | 30% | 70% | 18.2 | 5.3 | 41.1 |
| 22 | L3360 | Pea | 30% | 70% | 15.3 | 2.4 | 18.4 |
| 23 | L3360 | Peanut | 30% | 70% | 11 | −1.9 | −14.5 |
| 24 | L3360 | Gelatin | 50% | 50% | — | — | — |
| 25 | L3360 | Gelatin | 20% | 80% | 17.2 | 4.3 | 33.5 |
| 26 | L3360 | Gelatin | 15% | 85% | 16 | 3.1 | 24.3 |
| 27 | L3360 | Gelatin | 10% | 90% | 16.8 | 3.9 | 29.9 |
| 28 | L3360 | Gelatin | 5% | 95% | 11.2 | −1.7 | −13 |
| 29 | L3360 | Gelatin | 1% | 99% | 11.8 | −1.1 | −8.7 |
| 30 | L3360 | SPI raw | 10% | 90% | 14.6 | 1.7 | 13.4 |
| 31 | L3360 | SPI (pH 8) | 20% | 80% | 18 | 5.1 | 39.3 |
| 42 | L3360 | 50 KDa rCol | 30% | 70% | 17 | 4.1 | 31.8 |
| 43 | L3360 | Cellulase-RG | 20% | 80% | 14.7 | 1.8 | 14 |
| 44 | L3360 | Cellulase-IG | 20% | 80% | 15.1 | 2.2 | 17 |

TABLE 6
Young's Modulus

| | | | | | Young's | Delta | % Delta |
|---|---|---|---|---|---|---|---|
| | | | Protein | PU | Modulus | Young's | Young's |
| Ex. No. | PU | Protein | (wt %) | (wt %) | (MPa) | Modulus | Modulus |
| 1 | L3360 | None | 0% | 100% | 59 | — | — |
| 2 | UD-108 | None | 0% | 100% | 23 | — | — |
| 3 | UD-250 | None | 0% | 100% | 557 | — | — |
| 4 | UD-303 | None | 0% | 100% | 27 | — | — |
| 5 | Impranil DLS | None | 0% | 100% | 13 | — | — |
| 6 | Sancure | None | 0% | 100% | 337 | — | — |
| 7 | HD-2001 | None | 0% | 100% | 20 | — | — |
| 8 | L2996 | None | 0% | 100% | — | — | — |
| 9 | L3360 | Gelatin | 30% | 70% | 344 | 285 | 478 |
| 10 | UD-108 | Gelatin | 30% | 70% | 324 | 301 | 1308 |
| 11 | UD-250 | Gelatin | 30% | 70% | — | — | — |
| 12 | Impranil DLS | Gelatin | 30% | 70% | 326 | 313 | 2407 |
| 13 | UD-303 | Gelatin | 30% | 70% | 379 | 352 | 1304 |
| 14 | Sancure | Gelatin | 30% | 70% | 579 | 242 | 71.8 |
| 15 | HD2001 | Gelatin | 30% | 70% | 115 | 95 | 475 |
| 16 | L2996 | Gelatin | 30% | 70% | — | — | — |
| 17 | L3360 | Collagen | 30% | 70% | 226 | 167 | 280 |
| 18 | L3360 | rCol | 30% | 70% | 169 | 110 | 184 |
| 19 | L3360 | Albumen | 30% | 70% | 204 | 145 | 243 |
| 20 | L3360 | BSA | 30% | 70% | 174 | 114 | 192 |
| 21 | L3360 | SPI (pH 10) | 30% | 70% | 396 | 337 | 566 |
| 22 | L3360 | Pea | 30% | 70% | 163 | 104 | 175 |
| 23 | L3360 | Peanut | 30% | 70% | 87 | 28 | 47 |
| 24 | L3360 | Gelatin | 50% | 50% | — | — | — |
| 25 | L3360 | Gelatin | 20% | 80% | 129 | 70 | 117 |
| 26 | L3360 | Gelatin | 15% | 85% | 93 | 33 | 56 |
| 27 | L3360 | Gelatin | 10% | 90% | 71 | 11 | 19 |
| 28 | L3360 | Gelatin | 5% | 95% | 51 | −9 | −14 |
| 29 | L3360 | Gelatin | 1% | 99% | 54 | −5 | −9 |
| 30 | L3360 | SPI raw | 10% | 90% | 95 | 36 | 60 |
| 31 | L3360 | SPI (pH 8) | 20% | 80% | 223 | 164 | 275 |
| 42 | L3360 | 50 KDa rCol | 30% | 70% | 161 | 102 | 173 |
| 43 | L3360 | Cellulase-RG | 20% | 80% | 184 | 125 | 212 |
| 44 | L3360 | Cellulase-IG | 20% | 80% | 84 | 25 | 42 |

TABLE 7
Moisture Vapor Transmission Rate (MVTR)

| | | | Protein | PU | MVTR | Delta | % Delta |
|---|---|---|---|---|---|---|---|
| Ex. No. | PU | Protein | (wt %) | (wt %) | (g/m²/24 hr) | MVTR | MVTR |
| 45a | HD-2001 | None | 0% | 100% | 30 | — | — |
| 45b | HD-2001 | None | 0% | 100% | 38 | — | — |
| 46a | HD-2001 | Gelatin | 30% | 70% | 180 | 142-150 | 374-500 |
| 46b | HD-2001 | Gelatin | 30% | 70% | 138 | 100-108 | 263-360 |
| 47a | L3360 | None | 0% | 100% | 23 | — | — |
| 47b | L3360 | None | 0% | 100% | 27 | — | — |
| 48a | L3360 | SPI | 30% | 70% | 117 | 90-94 | 333-409 |
| 48b | L3360 | SPI | 30% | 70% | 74 | 47-51 | 174-222 |
| 49a | L3360 | None | 0% | 100% | 83 | — | — |
| 49b | L3360 | None | 0% | 100% | 87 | — | — |
| 50a | L3360 | SPI | 30% | 70% | 268 | 181-185 | 208-223 |
| 50b | L3360 | SPI | 30% | 70% | 277 | 190-194 | 218-233 |
| 51 | Impraperm | None | 0% | 100% | 338 | — | — |
| | 5249 | | | | | | |
| 52a | Impraperm | SPI | 30% | 70% | 626 | 288 | 85 |
| | 5249 | | | | | | |
| 52b | Impraperm | SPI | 30% | 70% | 644 | 306 | 91 |
| | 5249 | | | | | | |
| 53 | Impraperm | None | 0% | 100% | 84 | — | — |
| | 5249 & L- | | | | | | |
| | 3360 | | | | | | |
| 54 | Impraperm | SPI | 20% | 80% | 166 | 82 | 98 |
| | 5249 & L- | | | | | | |
| | 3360 | | | | | | |
| 55 | Impraperm | None | 0% | 100% | 168 | — | — |
| | 5249 & L- | | | | | | |
| | 3360 | | | | | | |
| 56 | Impraperm | SPI | 20% | 80% | 266 | 98 | 58 |
| | 5249 & L- | | | | | | |
| | 3360 | | | | | | |

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but can be interchanged to meet various situations as would be appreciated by one of skill in the art.

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

SEQUENCES

SEQ ID NO: 1: Human Collagen alpha-1 (III) chain
DVKSGVAVGGLAGYPGPAGPPGPPGPPGTSGHPGSPGSPGYQGPPGEP
GQAGPSGPPGPPGAIGPSGPAGKDGESGRPGRPGERGLPGPPGIKGPA
GIPGFPGMKGHRGFDGRNGEKGETGAPGLKGENGLPGENGAPGPMGPR
GAPGERGRPGLPGAAGARGNDGARGSDGQPGPPGPPGTAGFPGSPGAK
GEVGPAGSPGSNGAPGQRGEPGPQGHAGAQGPPGPPGINGSPGGKGEM
GPAGIPGAPGLMGARGPPGPAGANGAPGLRGGAGEPGKNGAKGEPGPR
GERGEAGIPGVPGAKGEDGKDGSPGEPGANGLPGAAGERGAPGFRGPA
GPNGIPGEKGPAGERGAPGPAGPRGAAGEPGRDGVPGGPGMRGMPGSP
GGPGSDGKPGPPGSQGESGRPGPPGPSGPRGQPGVMGFPGPKGNDGAP
GKNGERGGPGGPGPQGPPGKNGETGPQGPPGPTGPGGDKGDTGPPGPQ
GLQGLPGTGGPPGENGKPGEPGPKGDAGAPGAPGGKGDAGAPGERGPP

What is claimed is:

1. A material, comprising:
a textile; and
a protein polyurethane alloy disposed over the textile, the protein polyurethane alloy comprising a protein dissolved within a polyurethane.

2. The material of claim 1, wherein the protein polyurethane alloy is disposed on the textile.

3. The material of claim 1, wherein the protein polyurethane alloy is integrated into the textile.

4. The material of claim 1, wherein the protein is selected from the group consisting of: collagen, a recombinant collagen fragment, gelatin, bovine serum albumin, soy protein, pea protein, egg white albumin, casein, peanut protein, edestin protein, whey protein, karanja protein, and cellulase.

5. The material of claim 1, wherein the protein is a soy protein.

6. The material of claim 5, wherein the soy protein is soy protein isolate.

7. The material of claim 1, wherein the protein polyurethane alloy comprises about 10 wt % to about 50 wt % of the protein.

8. The material of claim 1, wherein the protein polyurethane alloy comprises about 10 wt % to about 20 wt % of the protein.

9. The material of claim 1, wherein the protein polyurethane alloy comprises about 30 wt % to about 50 wt % of the protein.

10. The material of claim 1, wherein the protein polyurethane alloy comprises one or more colored dyes.

11. The material of claim 10, wherein the material has a color fastness of class 4 or higher when measured according to ISO 11640 wet-rub fastness test.

12. The material of claim 10, wherein the one or more colored dyes comprises a fiber reactive dye, and wherein the textile comprises cotton fibers and polyester fibers.

13. The material of claim 10, wherein the one or more colored dyes are selected from the group consisting of: a fiber reactive dye and an acid dye.

14. The material of claim 1, wherein the protein polyurethane alloy has a dry weight ranging from about 25 g/m² to about 125 g/m².

15. The material of claim 1, wherein:
the textile comprises a top surface and a bottom surface,
the protein polyurethane alloy defines a first protein polyurethane alloy layer disposed over the top surface of the textile, and
the material further comprises a second protein polyurethane alloy layer disposed over the bottom surface of the textile.

16. The material of claim 15, wherein the first protein polyurethane alloy layer comprises about 30 wt % to about 50 wt % of the protein, and wherein the second protein polyurethane alloy layer comprises about 10 wt % to about 25 wt % of the protein.

17. The material of claim 15, wherein the textile comprises a first textile layer defining the top surface and a second textile layer defining the bottom surface.

18. The material of claim 15, wherein the first protein polyurethane alloy layer has a first dry weight, wherein the second protein polyurethane alloy layer has a second dry weight, and wherein the first dry weight is at least 5 g/m² more or less than the second dry weight.

19. The material of claim 1, wherein the protein polyurethane alloy comprises a textured exterior surface comprising a leather grain texture.


SEQUENCE LISTING (1 sequence)

SEQ ID NO: 1 - protein, 528 aa, synthetic construct
  REGION 1..528: note = Human Collagen alpha-1(III) chain
DVKSGVAVGGLAGYPGPAGPPGPPGPPGTSGHPGSPGSPGYQGPPGEPGQAGPSGPPGPPGAIGPSGPAGKDGESGRPGRPGERGLPGPPGIKGPAGIPGFPGMKGHRGFDGRNGEKGETGAPGLKGENGLPGENGAPGPMGPRGAPGERGRPGLPGAAGARGNDGARGSDGQPGPPGPPGTAGFPGSPGAKGEVGPAGSPGSNGAPGQRGEPGPQGHAGAQGPPGPPGINGSPGGKGEMGPAGIPGAPGLMGARGPPGPAGANGAPGLRGGAGEPGKNGAKGEPGPRGERGEAGIPGVPGAKGEDGKDGSPGEPGANGLPGAAGERGAPGFRGPAGPNGIPGEKGPAGERGAPGPAGPRGAAGEPGRDGVPGGPGMRGMPGSPGGPGSDGKPGPPGSQGESGRPGPPGPSGPRGQPGVMGFPGPKGNDGAPGKNGERGGPGGPGPQGPPGKNGETGPQGPPGPTGPGGDKGDTGPPGPQGLQGLPGTGGPPGENGKPGEPGPKGDAGAPGAPGGKGDAGAPGERGPP